(19) United States
(12) Patent Application Publication
(10) Pub. No.: US 2007/0166675 A1
(43) Pub. Date: Jul. 19, 2007

(54) COGNITIVE TRAINING USING VISUAL STIMULI

(75) Inventors: Sharona M. Atkins, Oakland, CA (US); Dylan Bird, San Francisco, CA (US); Samuel C. Chan, Alameda, CA (US); Peter B. Delahunt, San Mateo, CA (US); Shruti Gangadhar, San Francisco, CA (US); Joseph L. Hardy, Richmond, CA (US); Stephen G. Lisberger, San Francisco, CA (US); Henry W. Mahncke, San Francisco, CA (US); Michael M. Merzenich, San Francisco, CA (US); Donald Richards, Lagunitas, CA (US)

Correspondence Address: HUFFMAN LAW GROUP, P.C., 1900 MESA AVE., COLORADO SPRINGS, CO, 80906, US

(73) Assignee: POSIT SCIENCE CORPORATION, San Francisco, CA (US)

(21) Appl. No.: 11/611,291

(22) Filed: Dec. 15, 2006

Related U.S. Application Data
(60) Provisional application No. 60/750,509, filed on Dec. 15, 2005.
(60) Provisional application No. 60/762,434, filed on Jan. 26, 2006.
(60) Provisional application No. 60/762,433, filed on Jan. 26, 2006.
(60) Provisional application No. 60/762,432, filed on Jan. 26, 2006.
(60) Provisional application No. 60/746,406, filed on May 4, 2006.
(60) Provisional application No. 60/806,063, filed on Jun. 28, 2006.
(60) Provisional application No. 60/821,935, filed on Aug. 9, 2006.
(60) Provisional application No. 60/821,939, filed on Aug. 9, 2006.
(60) Provisional application No. 60/822,536, filed on Aug. 16, 2006.
(60) Provisional application No. 60/822,537, filed on Aug. 16, 2006.
(60) Provisional application No. 60/827,819, filed on Oct. 2, 2006.
(60) Provisional application No. 60/828,316, filed on Oct. 5, 2006.

(51) Int. Cl. G09B 19/00

(52) U.S. Cl. 434/236

(57) ABSTRACT

A computer-implemented method for enhancing cognition, e.g., for improving cognitive ability of a participant using visual stimuli. A set (or sets) of visual stimuli is provided for visual presentation to the participant. A visual stimulus from the set is visually presented to the participant. The participant is required to respond to the visual stimulus. A determination is made regarding whether the participant responded correctly. The stimulus intensity of the visual stimuli presented may be adjusted based on the correctness/incorrectness of the participant's response according to a single-stair maximum likelihood (e.g., ZEST) or N-up/M-down procedure. The visually presenting, requiring, and determining are repeated one or more times in an iterative manner to improve the participant's cognition, e.g., ability to process visual information, memory, etc. Assessments may be performed during the repeating according to a dual-stair maximum likelihood (e.g., ZEST) or N-up/M-down procedure. The repeating may include performing multiple exercises using visual stimuli.

### CROSS REFERENCE TO RELATED APPLICATION(S)

This application claims the benefit of the following U.S. Provisional Patent Applications, which are incorporated herein in their entirety for all purposes:

| Docket No. | Ser. No. | Filing Date: | Title: |
|---|---|---|---|
| PS.0119 | 60/750509 | Dec. 15, 2005 | HAWKEYE ASSESSMENTS |
| | | | SPECIFICATION |
| PS.0121 | 60/762434 | Jan. 26, 2006 | COMPUTER BASED FACE-NAME |
| | | | ASSOCIATION TRAINING PROGRAM |
| PS.0122 | 60/762433 | Jan. 26, 2006 | COMPUTER BASED TRAINING |
| | | | PROGRAM TO REVERSE AGE |
| | | | RELATED DECLINES IN VISUAL SEARCH |
| PS.0123 | 60/762432 | Jan. 26, 2006 | COMPUTER BASED TRAINING |
| | | | PROGRAM TO REVERSE AGE |
| | | | RELATED DECLINES IN SPATIAL |
| | | | AND TEMPORAL PROCESSING OF |
| | | | VISUAL STIMULI |
| PS.0127 | 60/746406 | May 4, 2006 | COMPUTER BASED TRAINING |
| | | | PROGRAM TO REVERSE AGE |
| | | | RELATED DECLINES IN VISUAL SEARCH |
| PS.0129 | 60/806063 | Jun. 28, 2006 | COMPUTER BASED TRAINING |
| | | | PROGRAM TO REVERSE AGE |
| | | | RELATED DECLINES IN |
| | | | MULTIPLE OBJECT TRACKING |
| PS.0221 | 60/821935 | Aug. 9, 2006 | COMPUTER BASED TRAINING |
| | | | PROGRAM TO REVERSE AGE |
| | | | RELATED DECLINES IN EYE- |
| | | | MOVEMENT EFFICIENCY |
| PS.0222 | 60/821939 | Aug. 9, 2006 | COMPUTER BASED TRAINING |
| | | | PROGRAM TO REVERSE AGE |
| | | | RELATED DECLINES IN |
| | | | WAYFINDING ABILITY |
| PS.0223 | 60/821939 | Aug. 9, 2006 | COMPUTER BASED TRAINING |
| | | | PROGRAM TO REVERSE AGE |
| | | | RELATED DECLINES IN |
| | | | WAYFINDING ABILITY |
| PS.0224 | 60/822536 | Aug. 16, 2006 | COMPUTER BASED TRAINING |
| | | | PROGRAM TO REVERSE AGE |
| | | | RELATED DECLINES IN EYE- |
| | | | MOVEMENT EFFICIENCY |
| PS.0225 | 60/827819 | Oct. 2, 2006 | EYE MOVEMENT |
| PS.0230 | 60/828316 | Oct. 5, 2006 | VISUAL EMPHASIS |

The following applications are related to the present application, and are hereby incorporated by reference in their entirety for all purposes:

| | | | |
|---|---|---|---|
| PS.0217 | ******* | ******* | COGNITIVE TRAINING USING |
| | | | VISUAL SWEEPS |
| PS.0218 | ******* | ******* | COGNITIVE TRAINING USING |
| | | | VISUAL SEARCHES |
| PS.0219 | ******* | ******* | COGNITIVE TRAINING USING |
| | | | MULTIPLE OBJECT TRACKING |
| PS.0220 | ******* | ******* | COGNITIVE TRAINING USING |
| | | | FACE-NAME ASSOCIATIONS |
| PS.0225 | ******* | ******* | COGNITIVE TRAINING USING |
| | | | EYE MOVEMENT |
| PS.0230 | ******* | ******* | VISUAL EMPHASIS FOR |
| | | | COGNITIVE TRAINING |

### FIELD OF THE INVENTION

This invention relates in general to the use of brain health programs utilizing brain plasticity to enhance human performance and correct neurological disorders, and more specifically, to a method for improving cognition using visual stimuli.

### BACKGROUND OF THE INVENTION

Almost every individual has a measurable deterioration of cognitive abilities as he or she ages. The experience of this decline may begin with occasional lapses in memory in one's thirties, such as increasing difficulty in remembering names and faces, and often progresses to more frequent lapses as one ages in which there is passing difficulty recalling the names of objects, or remembering a sequence of instructions to follow directions from one place to another. Typically, such decline accelerates in one's fifties and over subsequent decades, such that these lapses become noticeably more frequent. This is commonly dismissed as simply “a senior moment” or “getting older.” In reality, this decline is to be expected and is predictable. It is often clinically referred to as “age-related cognitive decline,” or “age-associated memory impairment.” While often viewed (especially against more serious illnesses) as benign, such predictable age-related cognitive decline can severely alter quality of life by making daily tasks (e.g., driving a car, remembering the names of old friends) difficult.

In many older adults, age-related cognitive decline leads to a more severe condition now known as Mild Cognitive Impairment (MCI), in which sufferers show specific sharp declines in cognitive function relative to their historical lifetime abilities while not meeting the formal clinical criteria for dementia. MCI is now recognized to be a likely prodromal condition to Alzheimer's Disease (AD) which represents the final collapse of cognitive abilities in an older adult. The development of novel therapies to prevent the onset of this devastating neurological disorder is a key goal for modern medical science.

The majority of the experimental efforts directed toward developing new strategies for ameliorating the cognitive and memory impacts of aging have focused on blocking and possibly reversing the pathological processes associated with the physical deterioration of the brain. However, the positive benefits provided by available therapeutic approaches (most notably, the cholinesterase inhibitors) have been modest to date in AD, and are not approved for earlier stages of memory and cognitive loss such as age-related cognitive decline and MCI.

Cognitive training is another potentially potent therapeutic approach to the problems of age-related cognitive decline, MCI, and AD. This approach typically employs computer- or clinician-guided training to teach subjects cognitive strategies to mitigate their memory loss. Although moderate gains in memory and cognitive abilities have been recorded with cognitive training, the general applicability of this approach has been significantly limited by two factors: 1) Lack of Generalization; and 2) Lack of enduring effect.

Lack of Generalization: Training benefits typically do not generalize beyond the trained skills to other types of cognitive tasks or to other “real-world” behavioral abilities. As a result, effecting significant changes in overall cognitive status would require exhaustive training of all relevant abilities, which is typically infeasible given time constraints on training.

Lack of Enduring Effect: Training benefits generally do not endure for significant periods of time following the end of training. As a result, cognitive training has appeared infeasible given the time available for training sessions, particularly from people who suffer only early cognitive impairments and may still be quite busy with daily activities.

As a result of overall moderate efficacy, lack of generalization, and lack of enduring effect, no cognitive training strategies are broadly applied to the problems of age-related cognitive decline, and to date they have had negligible commercial impacts. The applicants believe that a significantly innovative type of training can be developed that will surmount these challenges and lead to fundamental improvements in the treatment of age-related cognitive decline. This innovation is based on a deep understanding of the science of “brain plasticity” that has emerged from basic research in neuroscience over the past twenty years, which only now through the application of computer technology can be brought out of the laboratory and into the everyday therapeutic treatment.

While some cognitive exercises have been developed that are directed to general cognition and/or auditory portions of the brain, e.g., using auditory stimuli, currently there are no cognitive training exercises directed to improving visual cortex and vision-related cognitive functions.

Thus, improved systems and methods for improving cognition, visual processing, and visual memory are desired.

### SUMMARY

Various embodiments of a system and method for enhancing cognition in a participant via cognitive training exercises using visual stimuli are presented. Embodiments of the computer-based exercises or tasks described herein may operate to renormalize and improve the ability of the visual nervous system to perceive, process, and remember, visual information. This may be achieved by having participants perform any of various tasks using visual stimuli under conditions of high engagement/stimulation and under high reward for correct performance in order to encourage renormalization of cognition, visual processing, and memory.

A set (or sets) of visual stimuli may be provided for presentation to the participant, where the set includes a plurality of visual stimuli of varying difficulty. For example, the visual stimuli may be stored on a memory medium of the computing device, on a memory medium coupled to the computing device, e.g., over a network, etc. Note that as used herein, a “more difficult stimulus” means that in the context of a cognitive training task, the presentation of the stimulus would result in a lower probability of correct response by the participant. The visual stimuli may include any of various types of visual stimuli, including, for example, images, animations, text, scenes, sequences, patterns, and visual waveforms, among others. Note that a stimulus may itself include multiple stimuli, e.g., a stimulus may include a sequence or collection of images or patterns, etc.

A visual stimulus from the set of visual stimuli may be visually presented to the participant, e.g., on a computer monitor or other form of display. In various embodiments, the presented visual stimulus may be a single visual object or image, or may include a plurality of visual objects or images, e.g., a sequence, scene, animation, etc., as indicated above. In preferred embodiments, the exercises described herein are performed via a graphical user interface (GUI), and thus, the visual stimulus may be presented in or by the GUI, e.g., in a visual field.

The participant may be required to respond to the visual stimulus. For example, in various embodiments, the participant may be required to respond based on information gleaned from the visual stimulus, e.g., characterizing, identifying, completing, recognizing, etc., the visual stimulus, depending on the particular cognitive exercise being performed. In various embodiments, the participant may respond to the visual stimuli in any of a variety of ways, including, for example, clicking on objects or images with a mouse, clicking on icons or buttons in the GUI, clicking on specified regions in a visual field, pressing keys on a keyboard coupled to the computing device, using voice recognition to enter responses, responding via a touch screen, etc., among others. Of course, the particular response required of the participant may depend upon the specific cognitive training being performed, e.g., may depend on the specific cognitive training exercise being performed. Note that in various embodiments, any means for responding to the visual stimulus may be used as desired, the above being exemplary only.

A determination may be made as to whether the participant responded correctly. The response, and/or the correctness/incorrectness of the response, may be recorded. In some embodiments, an indication, e.g., a graphical and/or audible indication, may be provided to the participant indicating the correctness or incorrectness of the participant's response, e.g., a “ding” or a “thunk” may be played to indicate correctness or incorrectness, respectively, and/or points may be awarded (in the case of a correct response). Of course, any other type of indication may be used as desired, e.g., graphical images, animation, etc.

The above visually presenting, requiring, determining, may compose a trial in the exercise or task.

The visually presenting, requiring, and determining may be repeated one or more times in an iterative manner to improve the participant's cognition, e.g., visual processing skills. In other words, a plurality of trials may be performed as described above, preferably using a plurality of different visual stimuli, although multiple trials may certainly be directed to a single stimulus as desired. In some embodiments, multiple trials may be performed under each of a plurality of conditions, e.g., using different stimuli, for different durations, and so forth.

In preferred embodiments, another visual stimulus may be selected based on the determining, e.g., depending on whether the participant responded correctly or incorrectly a specified number of times in a row, where the specified number may be different or the same for correct and incorrect responses, e.g., 1/1 (one correct/one incorrect), 1/3, 3/1, etc., i.e., a first specified number of correct responses in a row, or a second specified number of incorrect responses in a row (where the first and second numbers may be the same or different). Selecting the other visual stimulus may include selecting another stimulus from the set, and/or may include modifying or adjusting the current visual stimulus (or another from the set) to form the other visual stimulus. For example, in some embodiments, if the participant responded incorrectly (the second specified number of times in a row), then the visual stimulus may be selected to decrease the difficulty of the (next) trial. Conversely, if the participant responded correctly (the first specified number of times in a row), then the visual stimulus may be selected to increase the difficulty of the (next) trial. Of course, in some embodiments, the particular visual stimuli presented to the participant in the trials may be sequenced according to a specified scheme or schedule, or may be selected for presentation randomly, as desired.

Thus, the repeating may include selecting the visual stimulus for the next trial based on the determining, e.g., decreasing the difficulty of visual stimulus if the participant responds incorrectly the second specified number of times in a row, and increasing the difficulty of the visual stimulus if the participant responds correctly the first specified number of times in a row (where the first and second specified numbers may be different or the same). In other embodiments, the visual stimulus may be selected (which may include modifying the visual stimulus) based on the participant's success rate, e.g., based on how many trials the participant has performed correctly.

In some embodiments, visually presenting the visual stimulus may include presenting the visual stimulus at a specified stimulus intensity. As used herein, the term “stimulus intensity” refers to an adaptable or adjustable attribute of the visual stimulus or its presentation that may be modified or adjusted to make trials more or less difficult. Examples of stimulus intensity include, but are not limited to: image attributes, such as color, contrast, size, etc., presentation time, e.g., duration, presentation speed, complexity, movement, and so forth. The above-described selecting, modifying or adjusting of the visual stimulus (which in some embodiments may include selecting another visual stimulus with the desired or specified stimulus intensity) may compose (or include, or result in) adjusting the stimulus intensity. In other words, by modifying the visual stimulus, the stimulus intensity of the visual stimulus may be adjusted or modified, thereby making the visual stimulus easier or more difficult to perceive or understand. In preferred embodiments, adjusting the stimulus intensity may be performed using a maximum likelihood procedure, such as, for example, a QUEST (quick estimation by sequential testing) threshold procedure, and/or a ZEST (zippy estimation by sequential testing) threshold procedure, whereby threshold values for the stimulus intensity may be determined based on the participant's performance.

In some embodiments, adjusting the stimulus intensity may include adjusting the stimulus intensity to approach and substantially maintain a specified success rate for the participant, e.g., using a single stair maximum likelihood procedure. Moreover, the repeating may include assessing the participant's performance a plurality of times during the repeating. In other words, not only may the stimulus intensity (e.g., the amount of modification) be adjusted on a per trial basis based on the participant's performance, but the participant's performance may be assessed periodically during the exercise, e.g., before, one or more times during, and after the exercise. In some embodiments, assessing the participant's performance a plurality of times may be performed according to the maximum likelihood procedure (e.g., QUEST or ZEST). Additionally, in some embodiments, the assessing the participant's performance a plurality of times may be performed using a 2-stair maximum likelihood procedure. Thus, the repeating may include performing threshold assessments in conjunction with, or as part of, the exercise.

In some embodiments, other schemes may be employed to adjust the stimulus intensity and perform assessments. For example, in some embodiments, a single-stair N-up/M-down procedure may be used to adjust the stimulus intensity of the eye movement exercise stimuli during training, and a 2-stair N-up/M-down procedure may be employed for the assessments. It should be noted that other features described above may also apply in these embodiments, e.g., adjusting the stimulus intensity to approach and substantially maintain a specified success rate for the participant, and so forth. In other words, the use of N-up/M-down procedures does not exclude other aspects of the methods disclosed herein that are not particularly dependent on the use of maximum likelihood procedures.

In some embodiments, the method may also include performing a plurality of practice trials, i.e., prior to performing the method elements described above. For example, in some embodiments, one or more practice sessions may be performed prior to the beginning of training to familiarize the participant with the nature and mechanisms of the task. In each practice session, a specified number of trials (e.g., 5) for each of one or more practice conditions may be performed. In some embodiments, the participant may be able to invoke such practice sessions at will during the exercise, e.g., to re-familiarize the participant with the task at hand.

In some embodiments, additional trials, referred to as “eureka” trials, may be performed periodically, e.g., every 20 trials or so, comprising non-ZEST trials that are easier than the current threshold estimate—e.g. using values of stimulus intensity that are twice the threshold value. These easier trials may serve to encourage the participant to continue the exercise, and improve or maintain the participant's morale.

Embodiments of Cognitive Training Exercises Using Visual Stimuli

As noted above, embodiments of the methods described above may be used in the context of any of a variety of cognitive training exercises using visual stimuli. Moreover, in some embodiments, various of the exercises may be used in combination, e.g., sequentially, and/or in an interleaved manner. It should be noted, however, that the exercises described herein are intended to be exemplary, and that any other cognitive training exercises using visual stimulus may be used as desired.

Examples of cognitive training exercises contemplated for use, either singly or in combination, include, but are not limited to:

A visual sweep exercise: first and second visual sweeps (e.g., frequency sweeps or orientation sweeps) may be provided for visual presentation to the participant. At least two visual sweeps may be visually presented to the participant utilizing either the first visual sweep, the second visual sweep, or a combination of the first and second visual sweeps. The participant may be required to indicate an order in which the at least two visual sweeps were presented, and a determination may be made as to whether the participant indicated the order of the at least two visual sweeps correctly. The above visually presenting, requiring, and determining may be repeated in an iterative manner to improve the participant's cognition.

A visual search exercise: a target image and one or more distracter images may be provided, where the target image and the one or more distracter images differ in appearance, and where the target image and the one or more distracter images are available for visual presentation to the participant. A plurality of images may be visually presented at respective locations in a visual field to the participant for a specified presentation time, including the target image and a plurality of distracter images based on the one or more distracter images, where at the end of the specified presentation time the visually presenting is ceased. The participant may be required to select a location of the target image from among a plurality of locations in the visual field, and a determination may be made as to whether the participant selected the location of the target image (or sequence of target image locations) correctly. The visually presenting, requiring, and determining may be repeated one or more times in an iterative manner, to improve the participant's cognition, e.g., efficiency, capacity and effective spatial extent of visual attentional processing, e.g., visual processing skills.

A multiple object tracking exercise: one or more images may be provided for visual presentation to the participant. A plurality of images based on the one or more images may be visually presented in a visual field to the participant, including a plurality of target images (also referred to as target objects) and a plurality of distracter images (or distracter objects). The visual presentation of the plurality of images preferably includes graphically indicating each of the plurality of target images for a first time period, and moving each of the plurality of images in the visual field for a second time period, where during the second time period the graphically indicating is not performed. The participant may then be required to select or indicate the target images from among the plurality of distracter images, and a determination may be made as to whether the participant selected the target images correctly. The visually presenting, requiring, and determining may be repeated one or more times in an iterative manner, to improve the participant's cognition, e.g., to improve divided attention (attending to multiple events simultaneously), sustained attention (attending for a prolonged period), motion processing and visual memory, by training the participant's visual spatiotemporal tracking ability.

An Eye Movement Exercise: multiple graphical elements may be provided, where each graphical element has a value, and where the multiple graphical elements are available for visual presentation to the participant. A temporal sequence of at least two of the graphical elements may be visually presented at a specified stimulus intensity, including displaying the value of each of the at least two graphical elements at a respective position in a visual field for a specified duration, then ceasing to display the value. The participant may be required to respond to the displayed values, e.g., indicating the presented sequence. A determination may be made as to whether the participant responded correctly. The stimulus intensity, e.g., duration, may then be modified based on the above determining. The visually presenting, requiring, determining, and modifying may be repeated one or more times in an iterative manner to improve the participant's cognition.

Face-Name Association Exercise: a plurality of facial images of people may be provided, where each person has a name, and where the plurality of facial images may each be available for visual presentation to the participant. A learning phase of the exercise may be performed in which the participant is given a chance to learn a face/name association, and then, in a subsequent testing phase, the participant is tested with respect to this association, and possibly others. In the learning phase, a first facial image of a person from the plurality of facial images may be presented. The name of the person may be presented concurrently with the presenting of the first facial image. In the testing phase, a second facial image of the person from the plurality of facial images may be presented. A plurality of names, including the name of the person and one or more distracter names, may be presented. The participant may be required to select the name of the person from the plurality of names. A determination may be made as to whether the participant selected the name correctly. The learning phase and testing phase may be performed one or more times in an iterative manner to improve the participant's cognition, e.g., face-name association skills.

Visual Emphasis Exercise: one or more scenes, each having a background and at least one foreground object, may be provided, where the one or more scenes are available for visual presentation to the participant. A scene from the one or more scenes may be visually presented to the participant with a specified visual emphasis that visually distinguishes the at least one foreground object with respect to the background. The participant may be required to respond to the scene, and a determination may be made as to whether the participant responded correctly. The visually presenting, requiring, and determining may be repeated one or more times in an iterative manner to improve the participant's cognition and visual processing skills. The specified visual emphasis may be modified based on the determining, e.g., based on whether or not the participant responded correctly a specified number of times (e.g., 1, 10, 40, etc.).

Other features and advantages of the present invention will become apparent upon study of the remaining portions of the specification and drawings.

### BRIEF DESCRIPTION OF THE DRAWINGS

FIG. 1 is a block diagram of a computer system for executing a program according to some embodiments of the present invention;

FIG. 2 is a block diagram of a computer network for executing a program according to some embodiments of the present invention;

FIG. 3 is a high-level flowchart of one embodiment of a method for cognitive training using visual stimuli, according to one embodiment;

FIG. 4 illustrates convergence to a threshold value over a series of trials in an exemplary two-stair ZEST threshold procedure;

FIG. 5 illustrates examples of Gabor gratings at different spatial frequencies, according to one embodiment;

FIGS. 6A and 6B illustrate cross sectional profiles of various Gabor stimuli;

FIG. 7 illustrates aliasing in a spatial frequency pattern;

FIG. 8 illustrates exemplary Gabor patterns at various orientations, according to one embodiment;

FIG. 9 is a high-level flowchart of one embodiment of a method for cognitive training using visual sweeps, according to one embodiment;

FIG. 10 illustrates an exemplary simple GUI suitable for implementing various embodiments of a spatial frequency sweep exercise, according to one embodiment;

FIG. 11 illustrates an exemplary simple GUI suitable for implementing various embodiments of an orientation sweep exercise, according to one embodiment;

FIG. 12 illustrates an exemplary GUI in which an introductory screen of a block game is displayed, according to one embodiment;

FIG. 13 illustrates an exemplary block grid for the block game, according to one embodiment;

FIG. 14 illustrates an exemplary response box displayed in the GUI for receiving responses from the participant, according to one embodiment;

FIG. 15 illustrates an exemplary screenshot of the GUI of FIGS. 12 and 13, but where a number of blocks have been cleared from the grid;

FIG. 16 illustrates an exemplary GUI for a tile matching game, including a tile grid, according to one embodiment;

FIG. 17 illustrates an exemplary screenshot of the GUI of FIG. 15, including a visual sweep stimulus, according to one embodiment;

FIG. 18 illustrates an exemplary response box displayed in the GUI of FIG. 15 for receiving responses from the participant, according to one embodiment;

FIG. 19 illustrates various ways in which tiles may adjust to a new space to fill, according to one embodiment;

FIG. 20 illustrates inaccessible slots in a grid layout and possible solutions, according to one embodiment;

FIG. 21 illustrates an invalid configuration of locked tiles, according to one embodiment; and

FIG. 22 illustrates a power-up tile with adjacent locked tiles, according to one embodiment.

FIG. 23 is a high-level flowchart of one embodiment of a method for cognitive training using visual emphasis, according to one embodiment;

FIGS. 24A and 24B respectively illustrate a standard scene, and an scene with enhanced luminance contrast, according to one embodiment;

FIGS. 25A and 25B respectively illustrate a standard scene, and an scene with enhanced color contrast, according to one embodiment;

FIGS. 26A and 26B respectively illustrate a standard scene, and an scene with enhanced spatial frequency contrast, according to one embodiment;

FIGS. 27A and 27B respectively illustrate a standard scene, and an scene with enhanced size contrast, according to one embodiment;

FIGS. 28A and 28B respectively illustrate a standard scene, and an scene with a flashing target, according to one embodiment;

FIGS. 29A and 29B respectively illustrate a standard scene, and an scene with a target in motion, according to one embodiment;

FIGS. 30-34 illustrate exemplary scenes at various visual emphasis levels;

FIG. 35 is a high-level flowchart of one embodiment of a method for cognitive training using visual searches, according to one embodiment;

FIG. 36 illustrates an exemplary screenshot for a single attention visual search task, according to one embodiment;

FIG. 37 illustrates an exemplary screenshot for a dual attention visual search task, according to one embodiment;

FIG. 38 illustrates an exemplary partitioning of the visual field into selectable regions, according to one embodiment;

FIGS. 39 and 40 illustrate screenshots of an exemplary GUI for a single attention visual search task, according to one embodiment;

FIG. 41 is a high-level flowchart of one embodiment of a method for cognitive training using multiple object tracking, according to one embodiment;

FIG. 42 illustrates an exemplary screenshot of a graphical user interface (GUI) for multiple object tracking, where target images are indicated by highlighting, according to one embodiment;

FIG. 43 illustrates an exemplary screenshot of a GUI for multiple object tracking, where target images are indicated by revealing their contents, according to one embodiment;

FIG. 44 illustrates an exemplary screenshot of a GUI for multiple object tracking, where images are allowed to overlap, according to one embodiment;

FIG. 45 illustrates an exemplary screenshot of a GUI for multiple object tracking, where images are allowed to move behind occluders, according to one embodiment;

FIG. 46 illustrates an exemplary screenshot of a GUI for multiple object tracking, indicating correctness/incorrectness of participant selections, according to one embodiment;

FIG. 47 illustrates an exemplary screenshot of a GUI for multiple object tracking, indicating target images by high-lighting and correctness/incorrectness of participant selections, according to one embodiment;

FIG. 48 is a high-level flowchart of one embodiment of a method for cognitive training using eye movement, according to one embodiment;

FIG. 49 illustrates an exemplary screenshot of a simple GUI with a fixation point, according to one embodiment;

FIGS. 50-53 illustrate exemplary successive screenshots of a presented numeric sequence in an Eye Movement exercise, according to one embodiment;

FIG. 54 illustrates an exemplary screenshot of the participant's response to the numeric sequence of FIGS. 50-53, according to one embodiment;

FIGS. 55 and 56 illustrate exemplary screenshots of a GUI for an Eye Movement exercise using playing cards in close and wider spatial arrangements, respectively, according to one embodiment;

FIGS. 57 and 58 illustrate exemplary screenshots of the GUI of FIGS. 55 and 56, displaying sequenced playing cards and cards with which to match them, according to one embodiment;

FIG. 59 illustrates an exemplary score and bonus indicator, according to one embodiment;

FIG. 60 illustrates an exemplary screenshot of a GUI instructing the participant to proceed to the next level in the Eye Movement exercise, according to one embodiment;

FIG. 61 illustrates an exemplary screenshot of a trial initiating screen in a GUI for an Eye Movement exercise using a grid of letter tiles, according to one embodiment;

FIG. 62 illustrates an exemplary screenshot of the Eye Movement exercise GUI with letter tiles illustrating presentation of a letter sequence, according to one embodiment;

FIG. 63 illustrates an exemplary screenshot of the Eye Movement exercise GUI with letter tiles illustrating the participant's response to the letter sequence, according to one embodiment;

FIGS. 64 and 65 illustrate exemplary screenshots of a GUI for an Eye Movement exercise using letter tiles in close and wider spatial arrangements, respectively, according to one embodiment;

FIG. 66 is a high-level flowchart of one embodiment of a method for cognitive training using face-name associations, according to one embodiment;

FIG. 67 illustrates an exemplary screenshot of a graphical user interface (GUI) for the learning phase of the face-name association exercise, according to one embodiment;

FIG. 68 illustrates an exemplary screenshot of a GUI for the testing phase of the face-name association exercise, according to one embodiment;

FIG. 69 illustrates another exemplary screenshot of a GUI for the testing phase of the face-name association exercise, according to one embodiment;

FIG. 70 illustrates a further exemplary screenshot of a GUI for the testing phase of the face-name association exercise, according to one embodiment; and

FIG. 71 illustrates another exemplary screenshot of a GUI for the testing phase of the face-name association exercise, according to one embodiment.

### DETAILED DESCRIPTION

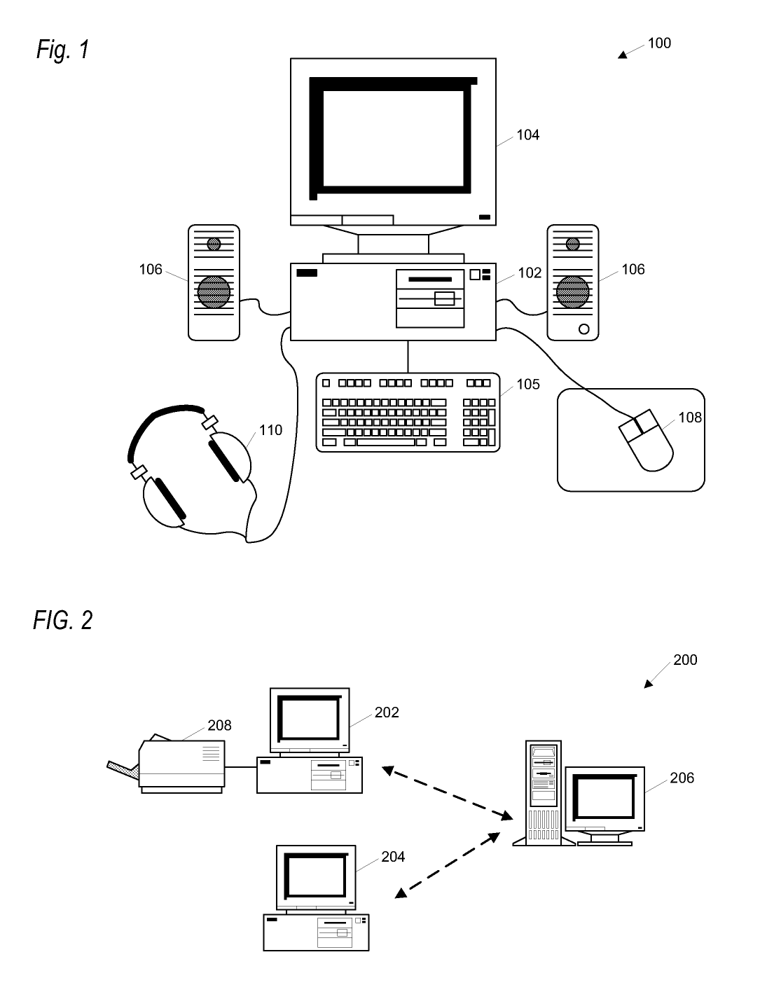

Referring to FIG. 1, a computer system 100 is shown for executing a computer program to train, or retrain an individual according to the present invention to enhance cognition, where the term “cognition” refers to the speed, accuracy and reliability of processing of information, and attention and/or memory, and where the term “attention” refers to the facilitation of a target and/or suppression of a non-target over a given spatial extent, object-specific area or time window. The computer system 100 contains a computer 102, having a CPU, memory, hard disk and CD ROM drive (not shown), attached to a monitor 104. The monitor 104 provides visual prompting and feedback to the subject during execution of the computer program. Attached to the computer 102 are a keyboard 105, speakers 106, a mouse 108, and headphones 110. In some embodiments, the speakers 106 and the headphones 110 may provide auditory prompting and feedback to the subject during execution of the computer program. The mouse 108 allows the subject to navigate through the computer program, and to select particular responses after visual or auditory prompting by the computer program. The keyboard 105 allows an instructor to enter alphanumeric information about the subject into the computer 102. Although a number of different computer platforms are applicable to the present invention, embodiments of the present invention execute on either IBM compatible computers or Macintosh computers, or similarly configured computing devices such as set top boxes, PDA's, gaming consoles, etc.

Now referring to FIG. 2, a computer network 200 is shown. The computer network 200 contains computers 202, 204, similar to that described above with reference to FIG. 1, connected to a server 206. The connection between the computers 202, 204 and the server 206 can be made via a local area network (LAN), a wide area network (WAN), or via modem connections, directly or through the Internet. A printer 208 is shown connected to the computer 202 to illustrate that a subject can print out reports associated with the computer program of the present invention. The computer network 200 allows information such as test scores, game statistics, and other subject information to flow from a subject's computer 202, 204 to a server 206. An administrator can review the information and can then download configuration and control information pertaining to a particular subject, back to the subject's computer 202, 204.

Embodiments of the computer-based exercises or tasks described herein may operate to renormalize and improve the ability of the visual nervous system to perceive, process, and remember, visual information. This may be achieved by having participants perform any of various tasks using visual stimuli under conditions of high engagement/stimulation and under high reward for correct performance in order to encourage renormalization of cognition, visual processing, and memory.

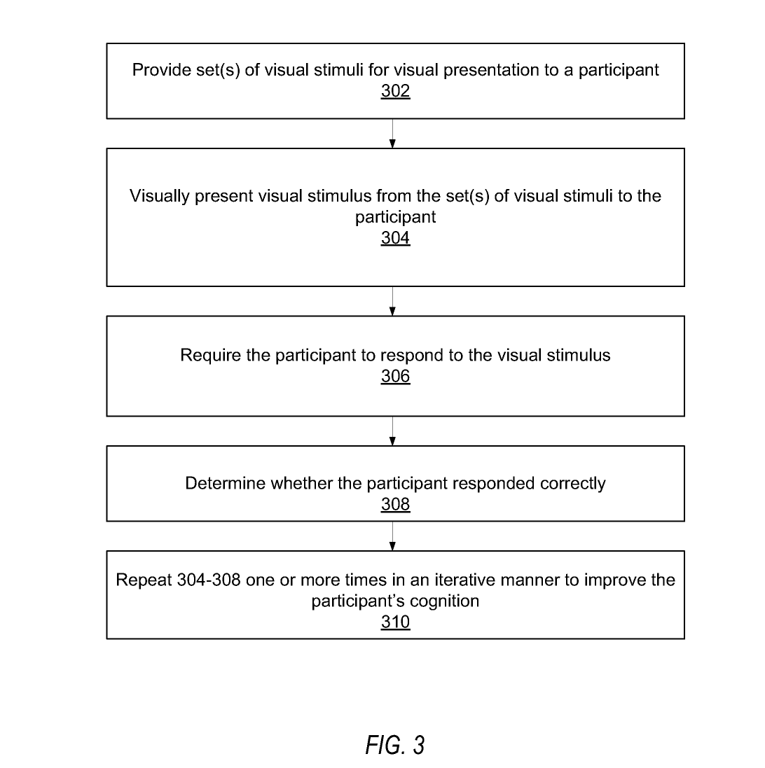

FIG. 3—Flowchart of a Method for Cognitive Training Using Visual Stimuli

FIG. 3 is a high-level flowchart of one embodiment of a method for cognitive training using visual stimuli. More specifically, the method utilizes a computing device to present a visual stimulus, and to record responses from the participant. The method may be used in the context of any of a variety of cognitive training exercises using visual stimuli, examples of which are described below. It should be noted that in various embodiments, some of the method elements may be performed concurrently, in a different order than shown, or may be omitted. Additional method elements may also be performed as desired. As shown, the method may be performed as follows:

In 302, a set (or sets) of visual stimuli may be provided for presentation to the participant, where the set includes a plurality of visual stimuli of varying difficulty. For example, the visual stimuli may be stored on a memory medium of the computing device, on a memory medium coupled to the computing device, e.g., over a network, etc. Note that as used herein, a “more difficult stimulus” means that in the context of a cognitive training task, the presentation of the stimulus would result in a lower probability of correct response by the participant. The visual stimuli may include any of various types of visual stimuli, including, for example, images, animations, text, scenes, sequences, patterns, and visual waveforms, among others. Note that a stimulus may itself include multiple stimuli, e.g., a stimulus may include a sequence or collection of images or patterns, etc.

In 304, a visual stimulus from the set of visual stimuli may be visually presented to the participant, e.g., on a computer monitor or other form of display. In various embodiments, the presented visual stimulus may be a single visual object or image, or may include a plurality of visual objects or images, e.g., a sequence, scene, animation, etc., as indicated above. In preferred embodiments, the exercises described herein are performed via a graphical user interface (GUI), and thus, the visual stimulus may be presented in or by the GUI, e.g., in a visual field.

In 306, the participant may be required to respond to the visual stimulus. For example, in various embodiments, the participant may be required to respond based on information gleaned from the visual stimulus, e.g., characterizing, identifying, completing, recognizing, etc., the visual stimulus, depending on the particular cognitive exercise being performed. In various embodiments, the participant may respond to the scene in any of a variety of ways, including, for example, clicking on objects or images with a mouse, clicking on icons or buttons in the GUI, clicking on specified regions in a visual field, pressing keys on a keyboard coupled to the computing device, using voice recognition to enter responses, responding via a touch screen, etc., among others. Of course, the particular response required of the participant may depend upon the specific cognitive training being performed, e.g., may depend on the specific cognitive training exercise being performed. Note that in various embodiments, any means for responding to the scene may be used as desired, the above being exemplary only.

In 308, a determination may be made as to whether the participant responded correctly. The response, and/or the correctness/incorrectness of the response, may be recorded. In some embodiments, an indication, e.g., a graphical and/or audible indication, may be provided to the participant indicating the correctness or incorrectness of the participant's response, e.g., a “ding” or a “thunk” may be played to indicate correctness or incorrectness, respectively, and/or points may be awarded (in the case of a correct response). Of course, any other type of indication may be used as desired, e.g., graphical images, animation, etc.

The above visually presenting, requiring, determining, may compose a trial in the exercise or task.

In 310, the visually presenting, requiring, and determining may be repeated one or more times in an iterative manner to improve the participant's cognition, e.g., visual processing skills. In other words, a plurality of trials may be performed as described above, preferably using a plurality of different visual stimuli, although multiple trials may certainly be directed to a single stimulus as desired. In some embodiments, multiple trials may be performed under each of a plurality of conditions, e.g., using different stimuli, for different durations, and so forth.

In preferred embodiments, another visual stimulus may be selected based on the determining, e.g., depending on whether the participant responded correctly or incorrectly a specified number of times in a row, where the specified number may be different for correct and incorrect responses, e.g., 1/1 (one correct/one incorrect), 1/3, 3/1, etc., i.e., a first specified number of correct responses in a row (which in some embodiments may be just 1), or a second specified number of incorrect responses in a row (where the first and second numbers may be the same or different). Selecting the other visual stimulus may include selecting another stimulus from the set, and/or may include modifying or adjusting the current visual stimulus (or another from the set) to form the other visual stimulus. For example, in some embodiments, if the participant responded correctly the first specified number of times in a row, then the visual stimulus may be selected to increase the difficulty of the (next) trial. Conversely, if the participant responded incorrectly the second specified number of times, then the visual stimulus may be selected to decrease the difficulty of the (next) trial. Of course, in some embodiments, the particular visual stimuli presented to the participant in the trials may be sequenced according to a specified scheme or schedule, or may be selected for presentation randomly, as desired.

Thus, the repeating of 310 may include selecting the visual stimulus for the next trial based on the determining, e.g., increasing the difficulty of the visual stimulus if the participant responds correctly the first specified number of times in a row, and decreasing the difficulty of visual stimulus if the participant responds incorrectly the second specified number of times in a row (where the specified numbers may be different or the same for correct and incorrect responses). In other embodiments, the visual stimulus may be selected based on the participant's success rate, e.g., based on how many trials the participant has performed correctly.

In some embodiments, visually presenting the visual stimulus may include presenting the visual stimulus at a specified stimulus intensity. As used herein, the term “stimulus intensity” refers to an adaptable or adjustable attribute of the visual stimulus or its presentation that may be modified or adjusted to make trials more or less difficult. As will be described below in detail, examples of stimulus intensity include, but are not limited to: image attributes, such as color, contrast, size, etc., presentation time, e.g., duration, presentation speed, complexity, movement, and so forth. The above-described selecting, modifying or adjusting of the visual stimulus (which in some embodiments may include selecting another visual stimulus with the desired or specified stimulus intensity) may compose (or include, or result in) adjusting the stimulus intensity. In other words, by modifying the visual stimulus, the stimulus intensity of the visual stimulus may be adjusted or modified, thereby making the visual stimulus easier or more difficult to perceive or understand.

In preferred embodiments, adjusting the stimulus intensity may be performed using a maximum likelihood procedure, such as, for example, a QUEST (quick estimation by sequential testing) threshold procedure, and/or a ZEST (zippy estimation by sequential testing) threshold procedure, described below, whereby threshold values for the stimulus intensity may be determined based on the participant's performance.

In some embodiments, adjusting the stimulus intensity may include adjusting the stimulus intensity to approach and substantially maintain a specified success rate for the participant, e.g., using a single stair maximum likelihood procedure, also described below. Moreover, the repeating may include assessing the participant's performance a plurality of times during the repeating. In other words, not only may the stimulus intensity (e.g., the amount of modification) be adjusted on a per trial basis based on the participant's performance, but the participant's performance may be assessed periodically during the exercise, e.g., before, one or more times during, and after the exercise. A description of threshold determination/assessment is provided below. In some embodiments, assessing the participant's performance a plurality of times may be performed according to the maximum likelihood procedure (e.g., QUEST or ZEST). Additionally, in some embodiments, the assessing the participant's performance a plurality of times may be performed using a 2-stair maximum likelihood procedure, described below. Thus, as described below, the repeating may include performing threshold assessments in conjunction with, or as part of, the exercise.

Threshold Determination/Assessment

As indicated above, stimulus intensity is an adjustable attribute (or combination of attributes) of a presented stimulus, whereby trials in the task or exercise may be made more or less difficult. A stimulus intensity threshold is the value of the stimulus intensity at which the participant achieves a specified level of success, e.g., 0.9, corresponding to a 90% success rate. Exercise based assessments (i.e., threshold determination) are designed to assess a participant's threshold with respect to stimuli on a given exercise, and can be used to adjust stimulus presentation to achieve and maintain a desired success rate for the participant, e.g., with respect to a particular exercise, task, and/or condition. As will be described below, such threshold determination may also be used to assess or determine a pre-training threshold that can then be used to calibrate the program to an individual's capabilities on various exercises, as well as serve as a baseline measure for assessing the participant's performance periodically during an exercise. Such assessment may also serve as a baseline measure to which post-training thresholds can be compared. Comparison of pre-training to post-training thresholds may be used to determine the gains made as a function of training with the cognition enhancement exercise or tasks described herein.

There are various approaches whereby such thresholds may be assessed or determined, such as, for example, the well known QUEST (Quick Estimation by Sequential Testing) threshold method, which is an adaptive psychometric procedure for use in psychophysical experiments, or a related method, referred to as the ZEST (Zippy Estimation by Sequential Testing) procedure or method, among others, although it should be noted that such methods have not heretofore been utilized in cognition enhancement training exercises using visual stimuli, as described herein.

The ZEST procedure is a maximum-likelihood strategy to estimate a subject's threshold in a psychophysical experiment based on a psychometric function that describes the probability a stimulus is detected as a function of the stimulus intensity. For example, consider a cumulative Gaussian psychometric function, F(x−T), for a 4-alternative-forced-choice (afc) task with a 5% lapsing rate, with proportion correct (ranging from 0-1) plotted against intensity of the stimulus (ranging from 0-5). As used herein, the term intensity (with respect to stimuli) refers to the value of the adaptive dimension variable being presented to the participant at any particular trial in a particular exercise. In other words, the intensity value is that parameter regarding the exercise stimuli that may be adjusted or adapted, e.g., to make a trial more or less difficult. Below are described various cognitive training exercises that use visual stimuli, and where various different attributes are used as stimulus intensity, including, for example, visual stimulus duration, visual emphasis (described in detail below), complexity, etc. The threshold is defined to be the mean of the Gaussian distribution for a specified success rate—e.g., a value yielding some specified success rate, e.g., 60%, 90%, etc.

The method may make some assumptions about the psychophysics:
1. The psychometric function has the same shape, except a shift along the stimulus intensity axis to indicate different threshold value.
2. The threshold value does not change from trial to trial.
3. Individual trials are statistically independent.

The primary idea of the ZEST procedure is as follows: given a prior probability density function (P.D.F.) centered around the best threshold guess, x, this P.D.F. is adjusted after each trial by one of two likelihood functions, which are the probability functions that the subject will respond “yes” or “no” to the stimulus at intensity as a function of threshold. Since the psychometric function has a constant shape and is of the form F(x−T), fixing the intensity x and treating threshold T as the independent variable, the “yes” likelihood, p=F(−(T−x)), is thus the mirror image of the psychometric function about the threshold, and the “no” likelihood function is then simply 1−p.

The P.D.F. is updated using Bayes' rule, where the posterior P.D.F. is obtained by multiplying the prior P.D.F. by the likelihood function corresponding to the subject's response to the trial's stimulus intensity. The mean of the updated (or posterior) P.D.F. is then used as the new threshold estimate and the test is repeated with the new estimate until the posterior P.D.F. satisfies a confidence interval criteria (e.g. standard deviation of posterior P.D.F.<predetermined value) or a maximum number of trials is reached.

In one example of the ZEST procedure, a single trial of a 4-afc experiment is performed, with x=2.5 (intensity) as the initial threshold guess. If the subject responds correctly, the next trial is placed at the mean of the corresponding posterior P.D.F., ˜x=2.3; if the response is incorrect, the next trial is placed at the mean of the corresponding P.D.F., ˜x=2.65. This sequential adjustment of stimulus intensity is referred to as a single stair maximum likelihood procedure because the value of the stimulus intensity is raised or lowered (based on the participant's performance) along a single “track”, i.e., only one series of values of the intensity is managed.

Thus, in some embodiments, a single stair ZEST procedure such as that described above may be used to adjust the intensity of the stimuli for the trials during training. In contrast, in some embodiments, particularly with respect to the periodic assessments during the exercise (as opposed to the “per response” stimulus adjustment) a 2-stair ZEST procedure may be employed, where two independent tracks with starting values, preferably encompassing the true threshold, each running its own ZEST procedure, are randomly interleaved in the threshold seeking procedure. In addition to their individual termination criterion, the difference between the two stairs may also be required to be within a specified range, e.g., the two stairs may be constrained to be a predetermined distance apart. An exemplary implementation of this approach is described below, although it should be noted that in various embodiments of the exercises described herein, the stimulus intensity may include any of various attributes or aspects of the visual stimulus or its presentation, as desired.

As used herein, the parameters required for ZEST may include the mean of the prior P.D.F. (threshold estimate), the standard deviation of the prior P.D.F. (spread of threshold distribution), the standard deviation of the cumulative Gaussian distribution (slope of psychometric function), the maximum number of trials to run, and a confidence level and interval. Additionally, in one embodiment, the trial-by-trial data saved for analysis may include: the track used, the stimulus intensity presented, the subject's response, the mean of posterior P.D.F., and the standard deviation of the posterior P.D.F., as well as any other data deemed necessary or useful in determining and/or assessing the participant's threshold.

Thus, in preferred embodiments, a maximum likelihood procedure, such as a ZEST procedure, may be used to adjust the stimulus intensity for trials during training (e.g., via a single stair ZEST procedure, possibly per condition), and may also be used for assessment purposes at periodic stages of the exercise (e.g., via a dual stair ZEST procedure, describe below). In one embodiment, such assessment may occur at specified points during the exercise, e.g., at 0% (i.e., prior to beginning), 25%, 50%, 75%, and 100% (i.e., after completion of the exercise) of the exercise. An example of such assessment is now described.

A primary purpose of the exercise threshold assessment is to determine the minimum stimulus intensity used in the exercise that a person can respond correctly to above a statistical threshold. The exercise assessment may be similar to the exercise with respect to visual presentation, where the differences between the assessment and the exercise lie (at least primarily) in the movement or progression through the task and the data that are obtained from this movement for the assessment. The procedure is designed to obtain a threshold, which is a statistical rather than an exact quantity. For the purposes of the exercises disclosed herein, the threshold may be defined as the smallest degree of stimulus intensity of visual stimuli used in an exercise at which the participant will respond correctly a specified percentage, e.g., 69%, 90%, etc., of all trials for the task. In a preferred embodiment, being a computer based task, the assessment may use the ZEST procedure to progress or move through the task, adjust the value of the stimulus intensity for the exercise, and determine the statistical threshold.

As noted above, many aspects of the assessment may generally be similar, or possible even identical, to the exercise with respect to visual presentation. However, some aspects of the exercise version may not be necessary in the assessment. For example, with regard to the GUI, in some embodiments, GUI elements such as score indicators, progress indicators, etc., that may be used in the exercise may not be necessary, and so may be omitted. Features or assets that may remain the same may include such features as correctness/incorrectness indications, e.g., the “ding” and “thunk” sounds that play after a participant responds correctly or incorrectly. The assessment stimulus presentation may also be identical to the training version.

The following describes one embodiment of a 2-stair (dual track) approach for determining a psychophysical threshold for a participant, e.g., an aging adult, specifically, the stimulus intensity threshold. Initially, first and second tracks may be initialized with respective values or degrees of stimulus intensity based on an initial anticipated threshold, where the initial anticipated threshold is an initial estimate or guess of the stimulus intensity corresponding to a specified performance level of the participant, e.g., the stimulus intensity at which the participant responds correctly some specified percentage of the time, e.g., 50%. For example, in one embodiment, the first track may be initialized to a first stimulus intensity that is below the initial anticipated threshold, e.g., preferably just slightly below the initial anticipated threshold, and the second track may be initialized to a second stimulus intensity that is (e.g., slightly) above the initial anticipated threshold. Thus, the initial values of the two tracks may straddle the initial anticipated threshold.

The method elements 302-304 of FIG. 3 may be performed, as described above, where a visual stimulus is presented in accordance with the stimulus intensity of a specified one of either the first track or the second track. In other words, one of the tracks may be selected or otherwise determined, and the visual stimulus for the trial may be presented with a stimulus intensity specified by the selected track. Thus, in preferred embodiments, the initial anticipated threshold, the first stimulus intensity, the second stimulus intensity, and the (to be determined) threshold, each is or specifies a respective amount or degree of stimulus intensity. As also described above, the participant may be required to respond to the visual stimulus (306), and a determination may be made as to whether the participant responded correctly (308).

The stimulus intensity of the specified track may then be adjusted or modified, based on the participant's response. For example, the stimulus intensity of the track may be modified in accordance with a maximum likelihood procedure, such as QUEST or ZEST, as noted above. In one embodiment, for each track, modifying the stimulus intensity of the specified track based on the participant's response may include increasing the stimulus intensity if the participant responds incorrectly, and decreasing the stimulus intensity if the participant responds correctly. Thus, for each assessment trial (in a given track), the stimulus intensity for that trial may be determined by the performance of the previous trial for that track. In other words, the participant's response to the stimulus determines that track's next stimulus intensity via the maximum likelihood method.

Similar to 310 of FIG. 3, the visually presenting, requiring, determining, and selecting (which may include modifying or adjusting the stimulus intensity), may be repeated one or more times in an iterative manner, but in this case, the repeating is performed to determine respective final values of stimulus intensity for the first track and the second track. For example, in one embodiment, trials in the first track and the second track may be performed in an alternating manner, or, alternatively, trials may be performed in the first track and the second track randomly with equal probability. Thus, over numerous trials, the number of trials performed in each track should be equal, or at least substantially equal.

In preferred embodiments, the presenting, requiring, determining, and modifying, may be repeated until the stimulus intensity values of the first track and the second track have converged to values within a specified confidence interval, and where the values are within a specified distance from each other, or, until a specified number of trials have been conducted for each track. In other words, the repetition may continue until either some maximum number of trials has been performed, or until convergence conditions for the tracks have been met, both singly, and together. For example, each track may be required converge to a respective value, and the convergent values for the two tracks may be required to be within some distance or interval of each other.

A threshold for the participant may then be determined based on the respective final values of stimulus intensity for the first track and the second track, where the threshold is or specifies the stimulus intensity of visual stimuli associated with the specified performance level of the participant. For example, as mentioned above, the determined threshold may specify the stimulus intensity at which the participant responds correctly some specified percentage of the trials, e.g., 50%, 90%, etc., although it should be noted that any other percentage may be used as desired. In one embodiment, the threshold for the participant may be determined by averaging the respective final numbers of target images for the first track and the second track.

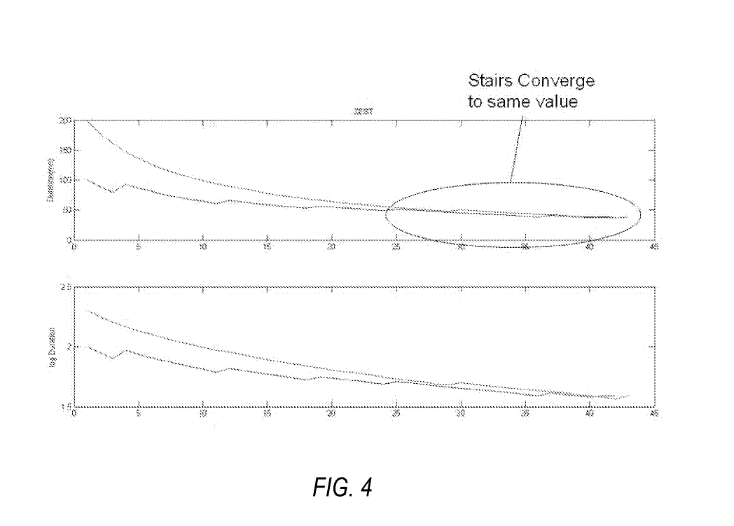

FIG. 4 illustrates an exemplary case where two tracks or “stairs” used in a ZEST threshold procedure are shown converging to a threshold value over a series of trials, where in this case the stimulus intensity is a duration, e.g., the presentation time of a visual stimulus. Note that in the top graph, duration vs. trials is plotted in a linear manner, whereas the bottom graph provides the same information but is logarithmic on the duration (vertical) axis. As may be seen, after about 25 trials, the two tracks or stairs converge to a value at or near 50 ms, thus, the two tracks, initialized respectively to values above and below an initial estimate of the threshold, converge to an approximation of the participant's actual stimulus threshold for the exercise.

In some embodiments, the presenting, requiring, determining, and selecting may compose performing a trial, and certain information may be saved on a per trial basis. For example, in one embodiment, for each trial, the method may include saving one or more of: which track was used in the trial, the visual stimuli used in the trial, the participant's response, the correctness or incorrectness of the participant's response, the mean of a posterior probability distribution function for the maximum likelihood procedure, and the standard deviation of the posterior probability distribution function for the maximum likelihood procedure, among others. Of course, any other data related to the trial may be saved as desired, e.g., distinguishing attributes of the visual stimulus, and/or any other condition of the task or trial.

Additionally, in some embodiments, various parameters for the maximum likelihood procedure besides the respective (initial) durations of the two tracks may be initialized, such as, for example, the standard deviation of a cumulative Gaussian psychometric function for the maximum likelihood procedure, and/or the standard deviation of a prior threshold distribution for the maximum likelihood procedure.

In one embodiment, the method may include determining the initial anticipated threshold. For example, the initial anticipated threshold may be determined based on one or more of: the age of the participant, calibration trials performed by the participant, and/or calibration trials performed by other participants, e.g., in a “pilot” program, although it should be noted that any other type of information may be used as desired to determine the initial anticipated threshold.

In some embodiments, certain information may be maintained and recorded over the course of the exercise. For example, in one exemplary embodiment, the following information may be recorded: the name of the participant; the age of the participant; the gender of the participant; the number of assessments/training segments completed; all scores achieved during the exercise; all threshold estimates for training and assessments; ZEST progressions used in the exercise; task type, conditions and colors used for each trial, session, or level; screen frame rate and spatial resolution; time/date for each session; time spent on each task; and the number of training trials, sessions, or levels and assessments completed. Of course, this information is meant to be exemplary only, and other information may be recorded as desired.

Alternate Adjustment Schemes

In some embodiments, other schemes may be employed to adjust the difficulty of the presented visual stimulus, e.g., to adjust the stimulus intensity for the visually presenting of 304. For example, in some embodiments, selecting another visual stimulus may include adjusting the stimulus intensity for presenting the visual stimulus using an N-up/M-down procedure, including increasing stimulus intensity (making the stimulus less difficult) if the participant incorrectly performs N trials consecutively, and decreasing stimulus intensity (making the stimulus more difficult) if the participant correctly performs M trials consecutively. For example, in one embodiment, the N-up/M-down procedure may be a 1-up/3-down procedure, where if the participant incorrectly performs 1 trial, the visual intensity is increased, and if the participant correctly performs 3 trials in succession, the stimulus intensity is decreased, although it should be noted that any other values (for N and M) may be used as desired. As noted above, adjusting the stimulus intensity may include selecting a visual stimulus with a specified value of stimulus intensity from the set of visual stimuli, and/or modifying the stimulus intensity of a selected visual stimulus from the set of visual stimuli.

As discussed above, in some embodiments, adjusting the stimulus intensity may include adjusting the stimulus intensity to approach and substantially maintain a specified success rate for the participant, e.g., an 85% success rate (or any other rate as desired). Moreover, the adjusting the stimulus intensity to approach and substantially maintain a specified success rate for the participant may be performed for each of a plurality conditions. In one embodiment, adjusting the stimulus intensity to approach and substantially maintain a specified success rate for the participant may be performed using a single stair N-up/M-down procedure.

As also noted above, the repeating may include performing a plurality of trials under each of a plurality of conditions, wherein each condition specifies one or more attributes of the visual stimulus. Additionally, the repeating may include assessing the participant's performance a plurality of times during the repeating, e.g., according to the N-up/M-down procedure described above. In some embodiments, assessing the participant's performance a plurality of times may be performed using a 2-stair N-up/M-down procedure, where, similar to the description above with respect to the maximum likelihood procedure, two tracks are utilized, although in these embodiments, each track employs a respective N-up/M-down procedure or scheme.

In some embodiments, the method may also include performing a plurality of practice trials, i.e., prior to performing the method elements described above. For example, in some embodiments, one or more practice sessions may be performed prior to the beginning of training to familiarize the participant with the nature and mechanisms of the task. In each practice session, a specified number of trials (e.g., 5) for each of one or more practice conditions may be performed. In some embodiments, the participant may be able to invoke such practice sessions at will during the exercise, e.g., to re-familiarize the participant with the task at hand.

In some embodiments, additional trials, referred to as “eureka” trials, may be performed periodically, e.g., every 20 trials or so, comprising non-ZEST trials that are easier than the current threshold estimate—e.g. using values of stimulus intensity that are twice the threshold value. These easier trials may serve to encourage the participant to continue the exercise, and improve or maintain the participant's morale.

Embodiments of Cognitive Training Exercises Using Visual Stimuli

As noted above, embodiments of the methods described above may be used in the context of any of a variety of cognitive training exercises using visual stimuli, examples of which are now described. Moreover, in some embodiments, various of the exercises may be used in combination, e.g., sequentially, and/or in an interleaved manner.

It should be noted, however, that the exercises described below are intended to be exemplary, and that any other cognitive training exercises using visual stimulus may be used as desired.

Visual Sweep Exercise

Embodiments of the computer-based Visual Sweep exercises or tasks described herein may operate to renormalize and improve the ability of the visual nervous system to accurately encode information about multiple visual events of short duration. This may be achieved by having participants perform a time order judgment task under conditions of high engagement/stimulation and under high reward for correct performance in order to encourage renormalization of visual spatiotemporal representations. The design of these exercises is tailored to drive responses in a large proportion of neurons in the early visual cortex (e.g, areas V1, V2, V3, V4, MT, etc.) successively, while forcing neurons at a higher level of sensory processing to extract temporal information about the order in which particular neurons fired.

More specifically, below are described various embodiments of a cognitive training exercise that utilizes visual sweeps, e.g., of spatial frequency and/or orientation patterns, to improve the cognitive skills of the participant, e.g., the processing of visual information by a participant, e.g., an aging adult. Two exemplary tasks using such visual sweeps are first described, after which the general exercise is described. It should be noted that various embodiments of the visual sweep tasks described herein, or other visual sweep tasks, may be used singly or in combination in the exercise. Moreover, as described below, in some embodiments, stimulus threshold assessments may also be performed in conjunction with, or as part of, the exercise, thus facilitating more effective training of the participant's visual processing system.

Note that in preferred embodiments, the exercise may be presented in the context of a game (or games). In other words, the visual sweep exercise(s) described herein may be implemented, embedded, or encapsulated, in a game, where the game elements, although not necessarily related to the particular task(s) of the exercise (e.g., the visual sweeps), may provide mechanisms for engaging the participant, and keeping the participant engaged and interested in progressing through the exercise, e.g., by providing a reward structure, progress cues, and so forth. Examples of such games are described below.

Visual Sweep Tasks

The two tasks described below visually present spatial frequency patterns to a participant, and receive input from the participant in response that characterizes the patterns in some way, such as the direction of a frequency sweep (Task 1) or a changing orientation of the pattern (Task 2), although in other embodiments, other visual sweep tasks may also be utilized. Difficulty on these tasks may be manipulated by adjusting the durations of the stimulus presentations/ISI, as will be described in detail below. These tasks may be performed singly or in combination in the visual sweep exercise, described below.

Task 1: Spatial Frequency Sweep Time Order Judgment

In this task, the participant may perform a time order judgment task in which he or she is required to indicate for each of two time intervals whether a presented spatial frequency pattern was expanding or contracting in spatial frequency. Spatial frequency is a characteristic of how a pattern repeats itself over space. For a pattern made up of bars, the wider the bars, the lower the spatial frequency. A sweep of spatial frequency in the visual domain is analogous to an FM (frequency modulation) sweep in the auditory domain. One of the most salient features of the response properties of neurons in the early visual cortex (e.g., V1, V2, etc.) is their selectivity for the spatial frequency of periodic patterns. Some neurons are tuned to higher spatial frequencies (thin bars), while other neurons are tuned to lower spatial frequencies (thick bars). By sweeping in spatial frequency, many more neurons may be stimulated on a given trial than is possible by presenting a single frequency. Additionally, in this task, the same neurons may be stimulated in both presentation intervals whether patterns are sweeping toward higher or lower spatial frequencies. By engaging the participant repetitively in such an identification task, more precise and temporally segregated representations of spatial frequency and change in spatial frequency in the visual cortex may be facilitated. The ability to encode such information is critical for accurately representing objects that are moving relative to an observer (e.g., the world as the observer moves through it).

In a preferred embodiment, stimuli for the task may be sine wave modulated gratings that change in spatial frequency over time, although in other embodiments, other frequency patterns may be used as desired, e.g., concentric circles, stark black and white bars, etc. A sine wave modulated grating is a pattern that varies in luminance (roughly equivalent to the phenomenal experience of lightness) as a sine function of space along a particular dimension. A horizontal sine wave grating varies in luminance as a function of the y-dimension of space. A vertical sine wave grating varies in luminance as a function of the x-dimension of space. It should be noted that sine wave gratings can appear at any orientation.

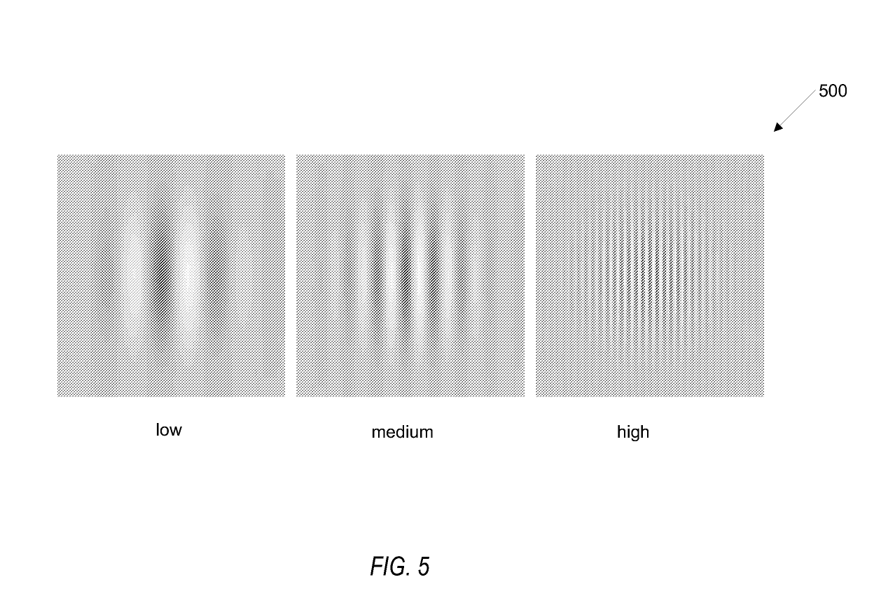

The gratings may be windowed by a 2-dimensional Gaussian to remove sharp edges which otherwise introduce high spatial frequency intrusions. This windowed pattern is referred to as a Gabor stimulus. The frequency of the modulation over space (the spatial frequency) is inversely related to the distance between the luminance peaks (the white stripes), i.e., the “wavelength” of the pattern. FIG. 5 illustrates examples of Gabor gratings 300 at different spatial frequencies. As may be seen, FIG. 5 includes examples of low, medium and high spatial frequency vertically oriented Gabor gratings. Note that due to the Gaussian windowing, each image becomes fainter toward the edges of the image.

The frequency of each Gabor pattern may be represented in cycles (wavelengths) per degree, e.g., c/deg, where the determination of spatial frequency in cycles per degree depends on the distance of the observer from the screen (one exemplary distance value for this purpose used herein is 51 cm, although it should be noted that other distance values may be used as desired, e.g., 57 cm). In one embodiment, the color of the presented patterns may vary pseudo-randomly from trial to trial among colors that map to distinct points in a physiologically motivated chromaticity space (cone contrast space). The colors correspond to +S (increment from white for S cones), −S (decrement from white for S cones), +L/−M (increment for L cones and decrement for M cones), and −L/+M (decrement for L cones, increment for M cones), although other color schemes may be used as desired.

Note that the maximum c/deg that can be adequately rendered on a monitor depends on the spatial resolution of the monitor and the viewing distance. A far viewing distance is best for the Visual Sweep exercises because higher spatial frequency patterns (thinner bars) may be presented. A close viewing distance is better for Eye Movement exercises because the target stimuli can be placed further out in peripheral vision.

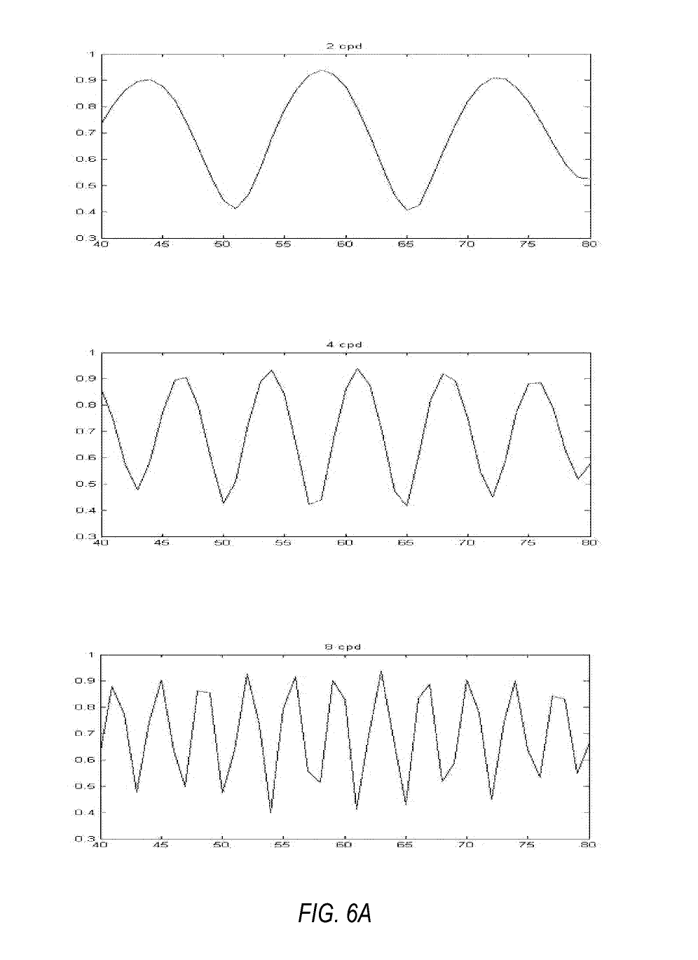

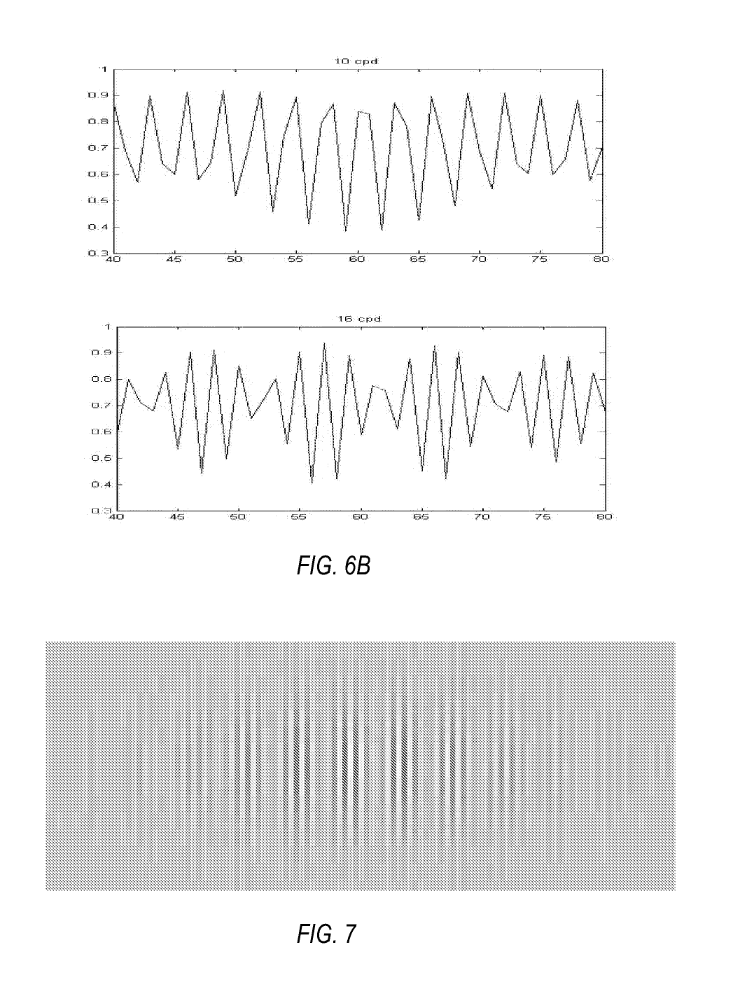

For example, FIGS. 6A and 6B illustrate cross sectional profiles of Gabor stimuli when rendered on a computer monitor at an exemplary spatial resolution of 800×600 and an exemplary viewing distance of 51 cm. As labeled, the profiles are presented for 2, 4, 8 (FIG. 6A), 10 and 16 (FIG. 6B) c/deg. Note that, as the profiles of FIG. 6B show, at about 10 c/deg and above, aliasing may produce secondary spatial frequencies, represented in the profiles as envelopes modulating the amplitudes of the signals. This aliasing is also apparent in the spatial frequency pattern of FIG. 7. Note the secondary periodicity overlaid or superimposed on the light/dark bars, wherein the dark bars lighten and darken in a periodic manner in the horizontal direction.

The maximum c/deg (also referred to as cpd) that can be adequately rendered may be about 5 c/deg. At closer viewing distances and lower spatial resolutions, the profiles will typically deteriorate further. Thus, in preferred embodiments, test patterns between 0.5 c/deg and 5 c/deg may be used. Note that a single sweep of 0.5 to 5 c/deg is generally too easy for the participant and thus may generally be broken down into smaller ranges for training purposes. For example, in some embodiments, 3 ranges may be used for training purposes: a low range of 0.5 to 1.26 c/deg, a medium range of 1.26 to 3.18 c/deg, and a high range of 3.18 to 5 c/deg, although it should be noted that these ranges are intended to be exemplary only, and that other ranges (and numbers of ranges) may be used as desired. In some embodiments, for 17″ monitors, a view distance of approximately 20.0 inches may be desired, and for 19″ monitors, a view distance of approximately 22.5 inches may be desired.

In some embodiments, during the course of the task, patterns may be presented at various orientations, e.g., at 4 orientations: 90 deg (vertical), 0 deg (horizontal), 45 deg (diagonal 1), and 135 deg (diagonal 2), although other orientations may be used as desired (although this should not be confused with Task 2, described below). The contrast of the gratings may be set at 75%, e.g., using the well-known Michelson calculation method. Additionally, the pixels values may be gamma corrected, e.g., using a gamma value of 2.2.

Task 2: Orientation Sweep Time Order Judgment

In this task, the participant may perform a time order judgment task in which he or she may be required to indicate for each of two or more orientation sweeps whether the pattern was rotating clockwise or counterclockwise. In other words, two or more spatial frequency patterns may be presented in succession, where during each presentation, the pattern is rotated at a specified rate through a specified angle, after which the participant may be required to indicate, in order, the rotation direction of each pattern, e.g., clockwise (CW) or counter-clockwise (CCW).

One salient characteristic of the tuning properties of the neurons in the areas of the early visual cortex (e.g, V1, V2, etc.) is their selectivity for the orientation of elongated, periodic patterns. Neurons in these areas (and several other primarily visual areas) will respond selectively to patterns in their receptive fields at their preferred orientation, and are increasingly less likely to respond to patterns at increasingly different orientations. Most neurons in early visual areas will not respond to patterns that presented in their receptive fields at an orientation that is orthogonal (perpendicular) to their preferred orientation. By sweeping these patterns in orientation (i.e., rotating them), many more neurons may be stimulated on a given trial than is possible by presenting a single orientation. Additionally, the same neurons may be stimulated in both presentation intervals whether the patterns are sweeping clockwise or counterclockwise. By engaging participants repetitively in such an identification task, more precise and temporally segregated representations of orientation and change in orientation in the visual cortex may be facilitated. Precise representations of orientation are critical to accurately encoding all spatial information as well as processing motion information, especially regarding self motion—particularly as it pertains to posture.

In a preferred embodiment, stimuli for this task may be Gabor patterns that change in orientation over time (see Task 1 discussion above for a description of Gabor patterns), although, as with the spatial frequency sweep task described above, in other embodiments, other patterns may be used as desired. Orientations may be specified in terms of degrees (0-360°), although other units, such as radians, may be used as desired. An orientation of 0° may represent a horizontal pattern, while 90° may correspond to a vertical pattern.

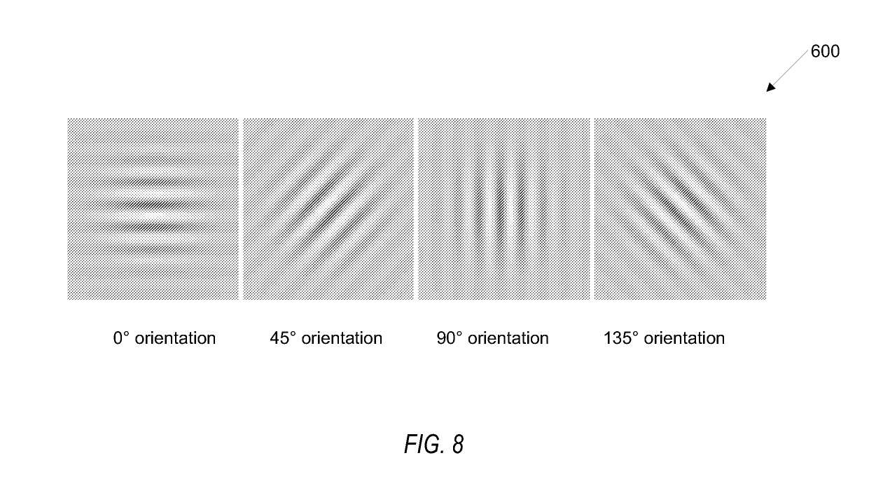

FIG. 8 illustrates exemplary Gabor patterns at various orientations, specifically, at 0, 45, 90, and 135 degrees, respectively. In this orientation sweep task, patterns may be presented at a specified number of speeds of rotation, e.g., 3 different speeds, and at a specified number of spatial frequencies, e.g., 4 different spatial frequencies. In one embodiment, the speeds of rotation may be 180°, 360°, or 720°/sec, although other values may be used as desired. Spatial frequencies may include 0.5, 1, 2 and 4 c/deg, although other values may be used as desired. The initial orientation and color of the pattern may vary randomly from trial to trial. In one embodiment, the maximum sweep may be 45 degrees, although other values may be used as desired.

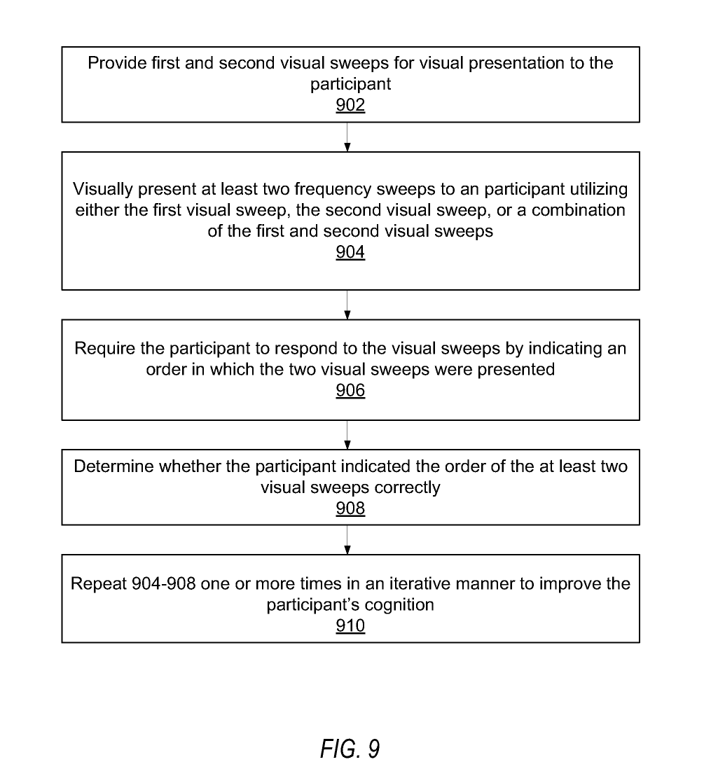

FIG. 9—Flowchart of a Method for Cognitive Training Using Visual Sweeps

FIG. 9 is a high-level flowchart of one embodiment of a method for cognitive training using visual sweeps. More specifically, the method utilizes a computing device to present visual sweeps, such as, for example, spatial frequency and/or orientation sweeps, for training, and to record responses from the participant. It should be noted that in various embodiments, some of the method elements may be performed concurrently, in a different order than shown, or may be omitted. Additional method elements may also be performed as desired. As shown, the method may be performed as follows:

In 902, first and second visual sweeps may be provided, where both the first and second spatial frequency sweeps are available for visual presentation to the participant. For example, the first and second visual sweeps may be spatial frequency sweeps, or orientation sweeps, although other types of visual sweeps may also be used as desired.

Note that in various embodiments, the first and second visual sweeps may sweep in different directions, or in the same direction. Thus, for example, in one embodiment, in the spatial frequency sweep task, the first visual sweep may be a first spatial frequency sweep in which the spatial frequency of a sweep pattern increases in frequency over time, and the second visual sweep may be a second spatial frequency sweep in which the spatial frequency of the sweep pattern decreases in frequency over time. In other embodiments, both the first visual sweep and the second visual sweep may be the same, i.e., may be a spatial frequency sweep in which the spatial frequency of a sweep pattern increases in frequency over time, or a spatial frequency sweep in which the spatial frequency of the sweep pattern decreases in frequency over time.

Similarly, in some embodiments, in the orientation sweep task, the first visual sweep may be a first orientation sweep which rotates counter-clockwise over time, and the second visual sweep may be a second orientation sweep which rotates clockwise over time. In other embodiments, both the first visual sweep and the second visual sweep may be an orientation sweep which rotates counter-clockwise over time, or an orientation sweep which rotates clockwise over time.

In 904, at least two visual sweeps may be visually presented to the participant utilizing either the first visual sweep, the second visual sweep, or a combination of the first and second visual sweeps. In other words, a sequence of two or more visual sweeps may be visually presented to the participant in succession. The two or more visual sweeps may be separated by a specified inter-stimulus-interval (ISI), which in some embodiments may be equal to the duration of each sweep. In other words, the presentation time (i.e., display time) of each of the sweeps may be equal to the ISI between the sweeps. Note, however, that in other embodiments, the ISI may not be equal to the sweep duration.

As one example, in cases where the at least two visual sweeps compose a sequence of two visual sweeps, visually presenting the at least two visual sweeps may include presenting a sequence of two visual sweeps comprising one of the following possible combinations: first visual sweep-first visual sweep, first visual sweep-second visual sweep, second visual sweep-first visual sweep, and second visual sweep-second visual sweep.

With respect to Task 1, where the visual sweeps comprise spatial frequency sweeps and where the frequency either increases or decreases, this increase/decrease of spatial frequency over time may be visually indicated by the bars of the pattern moving in/out, respectively. For example, increasing the frequency of a visual pattern increases the number of bars in a given area of the pattern, and so as the frequency is increased the bars may be seen to move inward towards the center of the pattern. Similarly, decreasing the frequency of a visual pattern decreases the number of bars in a given area of the pattern, and so as the frequency is decreased the bars may be seen to move outward away from the center of the pattern. Examples of Gabor patterns with various frequencies are illustrated in FIG. 7. Note that in some cases the monitor refresh rate may restrict the range of c/deg that can be presented within a certain time. Once the threshold has dropped below a certain number of frames (e.g. 10 frames, or 133 ms at 75 Hz), the c/deg range may be reduced by an equal amount at each end of the range extremes, e.g., using a log 10 scale.

With respect to Task 2, where the visual sweeps comprise orientation sweeps in which the presented pattern rotates CCW or CW, the pattern, e.g., bars, will be seen to rotate through some specified angle. Examples of Gabor patterns at various orientations are illustrated in FIG. 8, specifically, at 0, 45, 90, and 135 degrees.

In 906, the participant may be required to indicate an order in which the at least two visual sweeps were presented, e.g., by providing input indicating the order.

For example, in an embodiment where the visual sweeps are spatial frequency sweeps, if a sweep with increasing frequency is denoted by “IN”, and a sweep with decreasing frequency is denoted by “OUT”, then the possible orders for a two sweep sequence are IN-IN, IN-OUT, OUT-IN, and OUT-OUT. Thus, in the case of such a two-sweep sequence, the participant may be required to indicate one of these four orders. Note that in cases where the number of sweeps in a sequence is greater than two, the number of possible orders increases rapidly.

As will be described below in more detail, the participant preferably performs the exercise via a graphical user interface (GUI), using icons or buttons to indicate the order. Thus, in some embodiments, the method may include associating the first visual sweep (of 902) with a first icon, and associating the second visual sweep (of 902) with a second icon. For example, associating the first frequency sweep with the first icon may include visually presenting the first frequency sweep, and then highlighting the first icon to indicate to the participant the association. Similarly, associating the second frequency sweep with the second icon may include visually presenting the second frequency sweep, and then highlighting the second icon to indicate to the participant the association. Both the first and second frequency sweeps are then available for visual presentation to the participant. Requiring the participant to indicate an order in which the at least two visual sweeps were presented may thus include requiring the participant to select the icons to indicate the order of the at least two visual sweeps.

In 908, a determination may be made as to whether the participant indicated the order of the at least two visual sweeps correctly. In some embodiments, an indication, e.g., a graphical or audible indication, may be provided to the participant indicating the correctness or incorrectness of the participant's response. For example, a “ding” or a “thunk” may be played to indicate correctness or incorrectness, respectively, and/or points may be awarded (in the case of a correct response). Of course, any other type of indication may be used as desired. The above visually presenting, requiring, and determining, may compose a trial in the exercise or task.

Thus, in an exemplary embodiment of a spatial frequency task with 2-sweep sequences, for a given trial, two visual sweeps, e.g., spatial frequency sweeps, may be presented briefly (e.g., for 27-1000 ms) separated by an ISI that may be equal to the presentation time. For 2-sweep sequences, there are four possible combinations of increasing or decreasing spatial frequency (increasing/increasing, decreasing/decreasing, increasing/decreasing, decreasing/increasing, which may be denoted by IN/IN, OUT/OUT, IN/OUT, and OUT/IN, as described above). As also described above, the participant's responses may be mouse clicks on icons indicating increasing or decreasing frequency of the bars, i.e., moving a cursor over the icon and clicking the mouse, although other indication means may be used as desired, e.g., arrow keys, etc. Thus, in this embodiment, the participant may give two responses per trial, corresponding to the two stimulus presentations, e.g., the two spatial frequency sweeps.

Similarly, in an exemplary embodiment of the orientation sweep task with 2-sweep sequences, for a given trial, two stimuli, specifically, two orientation sweeps, may be presented briefly (e.g., for 27-1000 ms) separated by a blank ISI (e.g., for 0-1500 ms). Again, for 2-sweep sequences, there are four possible combinations of rotations (CCW-CCW, CCW-CW, CW-CCW, and CW-CW). As noted above, responses may be mouse clicks on icons indicating clockwise rotation or counterclockwise rotation. Thus, in this embodiment, the participant may give two responses per trial, corresponding to the two stimulus presentations, e.g., the two orientation sweeps.

In preferred embodiments, the participant may perform the exercise or tasks via a graphical user interface (GUI). The GUI may include a stimulus presentation area where the visual sweeps of 904 may be presented to the participant, as well as means for receiving input from the participant. As will be described below with respect to particular task GUIs, additional GUI elements may be provided for indicating various aspects of the participant's progress or status with respect to the exercise or task.

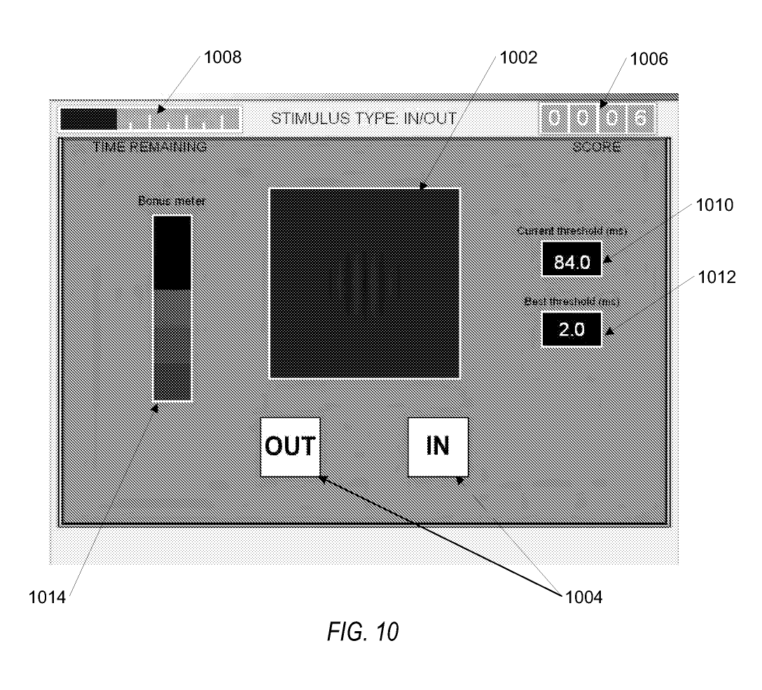

FIG. 10 illustrates an exemplary simple GUI suitable for implementing various embodiments of the present invention, specifically, embodiments of Task 1 (spatial frequency sweep). As FIG. 10 shows, the GUI includes a stimulus presentation area 1002 where the visual sweeps of 904, in this case, spatial frequency sweeps, may be presented to the participant. The GUI may also include means for receiving input from the participant. For example, in the example GUI of FIG. 10, icons 1004, e.g., buttons labeled “IN” and “OUT”, respectively, may be provided whereby the participant may indicate the nature of each sweep. For example, in the case of a sweep sequence IN-OUT, after the two sweeps have been presented (904), the participant may select an icon or button for each of the sweeps, thus, the participant may select the IN icon, then the OUT icon, to indicate the order (and character) of the sweeps. As noted above, in some embodiments, sequences with greater than two sweeps may also be used. As FIG. 10 also shows, in this embodiment, a score indicator 1006 may be displayed in the GUI that indicates the participant's current score in the task or exercise. The GUI may also include a time remaining indicator 1008 that provides an indication of how much time remains in the current task, session, or exercise. As also shown, the GUI may present threshold information, such as the current threshold value 1010, and a best threshold value 1012, where a threshold indicates the value of an adjustable stimulus attribute or adaptive dimension, referred to as the stimulus intensity, that results in a specified performance level, i.e., success rate, for the participant, one example being the duration or presentation time of a sweep, as will be explained below in more detail. In various embodiments, the GUI may also include additional indicators, such as, for example, a bonus meter (or equivalent) 1014, which may indicate the number of correct responses in a row, and may flash, play music, and/or award bonus points, when some specified number, e.g., 5, in a row is attained.

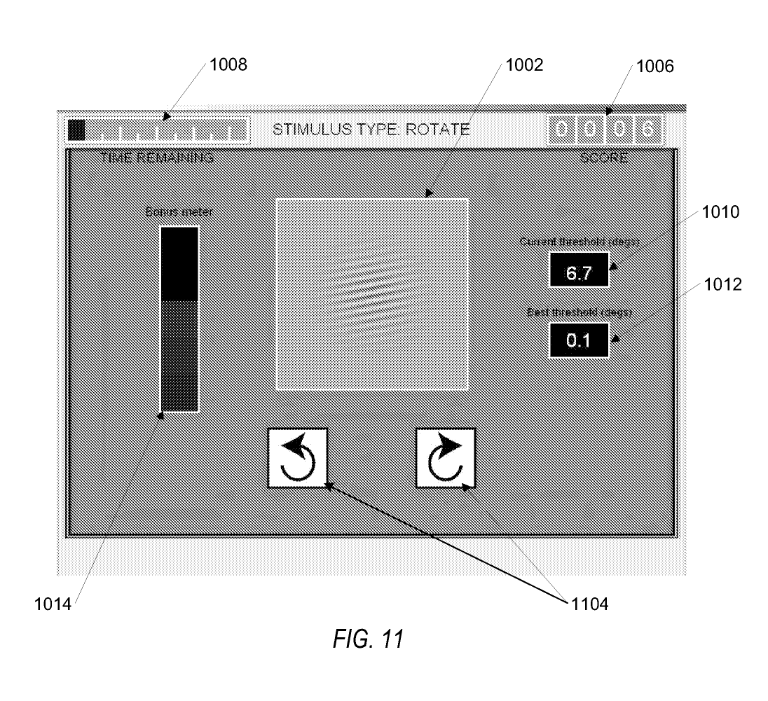

FIG. 11 illustrates an exemplary simple GUI suitable for implementing various embodiments of Task 2 (orientation sweep). As may be seen, this exemplary GUI is similar to that of FIG. 10, but with these differences: the stimulus presentation area 1002 is used to present orientation sweeps to the participant, and rather than icons 1004, e.g., buttons labeled “IN” and “OUT”, the icons or buttons indicate counter-clockwise and clockwise, respectively, corresponding to the possible directions of the pattern rotation (orientation sweep). Thus, for example, in the case of a sweep sequence CCW-CW, after the two sweeps have been presented (904), the participant may select an icon or button for each of the sweeps, e.g., the CCW icon, then the CW icon, to indicate the order (and character) of the sweeps. It should be noted that the GUIs of FIGS. 10 and 11 are meant to be exemplary only, and that other GUIs are envisioned, as will be presented further below.

Thus, in one embodiment, the requiring of 906 may include receiving input from the participant selecting the icons in an order that indicates the order in which the at least two frequency sweeps were presented. Selection of the icons may be made by the participant placing a cursor over an icon and clicking a mouse, where each mouse click is recorded as a selection. The selections made by the participant may be recorded. Additionally, whether in 908 the participant correctly identified the order in which the at least two frequency sweeps were presented may also be recorded.

In 910, the visually presenting, requiring, and determining of 904, 906, and 908 may be repeated one or more times in an iterative manner, to improve the participant's cognition, e.g., to process visual information more quickly, read more efficiently, improve game performance, e.g., skiing, tennis, etc., and so forth. In other words, a plurality of trials may be performed in the exercise (preferably with respect to both tasks), where various orders of visual sweeps are presented to the participant, as described above. For example, the repetitions may be performed over a plurality of sessions, e.g., over days, weeks, or even months. In some embodiments, at the end of each session, the participant's score and thresholds for the session may be shown and may be compared to the best performance.

Such repeating preferably includes trials performed under a variety of specified stimulus conditions, e.g., with visual sweeps covering a range of sweep attributes. Such conditions may include baseline conditions, used before, after, and at specified points during, the exercise to assess the participant's performance (described further below), and non-baseline or training conditions, used for the actual training during the exercise. Thus, blocks of stimuli may contain particular conditions of base spatial frequency and orientation. As mentioned above, in preferred embodiments, the repeating may include performing trials in each of the visual sweep tasks described above.

Each task may have a set of conditions specifying the visual sweeps for that task. For example, regarding the spatial frequency sweep task (Task 1), the conditions may specify one or more of: size of the sweep's image, rate or speed of the sweep, frequency range of the sweep, the colors of the sweep pattern, the orientation of the pattern, and/or the range of cycles/deg for the sweep. Regarding the orientation sweep task (Task 2), the conditions may specify one or more of: the rate or speed of the sweep (i.e., rotation speed), the cycles/deg for the sweep pattern, size of the sweep's image, speed of the sweep, and/or the colors of the pattern. However, it should be noted that other attributes may be used as desired.

There are a variety of ways that the visual sweep tasks may be performed over the course of the exercise. For example, in one exemplary training schedule or regimen, on first alternate sessions, trials under a first number of conditions may be performed for the spatial frequency sweep task, and under a second number of conditions for the orientation sweep task, and on second alternate sessions, trials under the second number of conditions may be performed for the spatial frequency sweep task, and under the first number of conditions for the orientation sweep task, where the first alternate sessions and the second alternate sessions are interleaved, e.g., the respective number of conditions used per task may alternate on a per session basis. Thus, in an embodiment where the repeating is performed over a 48 day training period, and where the participant is trained on 2 conditions per day (e.g., for a total of 10 minutes), of the two conditions, 1 may be from one sweep type, and 1 may be from the other sweep type, and this may alternate with each training session.

In another exemplary schedule, the type of sweep may be consistent for that day (either spatial frequency sweeps or orientation sweeps) and may alternate each day. In other words, on a particular day, the participant may be presented trials under two conditions for one type of sweep only (either spatial frequency or orientation). The next day, the participant may be presented with trials under conditions for the other type of sweep. Thus, for example, a block sequence may be trained on every other day for a total of 5 days. This approach may maximize the training effect of the exercise.

In one embodiment, the participant may train on each condition 5 times, and may take 10 days to finish each of a number of stimulus blocks (e.g., 4) over the 48-day training period, which may minimize uncertainty and maximize the training effect of the exercise. Thus, in these embodiments, there may be a total of 8 hours training (on this exercise) spread over 48 training sessions (e.g., at 10 minutes per session). In another exemplary training regimen, there may be a total of 8 hours of play, where each session is 10 minutes long, with approximately two configurations played per session.

It should be noted that the above training schedules or regimens are meant to be exemplary only, and are not intended to limit the training schedule or regimen used to any particular approach. Thus, in preferred embodiments, the exercise may include performing multiple tasks, e.g., Task 1 and Task 2, using frequency patterns.

Exemplary conditions, including baseline (assessment) and non-baseline (training) conditions, are provided below.

As described above with respect to the method of FIG. 3, in preferred embodiments, the repeating may include modifying or adjusting the stimulus intensity of the presented stimuli, e.g., the duration and/or ISI of the sweeps, based on the participant's response. Said another way, in each trial, and in response to the participant's indicated order of the visual sweeps, the stimulus intensity of the visual sweep may be adjusted for the next trial's visual presentation, i.e., based on whether the participant indicated the order of the at least two visual sweeps correctly (or not). The adjustments may generally be made to increase the difficulty of the stimulus when the participant answers correctly, and to decrease the difficulty of the stimulus when the participant answers incorrectly. Moreover, the adjustments may be made such that a specified level of performance, i.e., level of success, is approached and substantially maintained during performance of the exercise. For example, based on the participant's responses, the intensity of the visual sweeps may be adjusted to substantially achieve and maintain a specified success rate, e.g., 85% or 90%, for the participant, although other rates may be used as desired. In preferred embodiments, the adjustments may be made using a maximum likelihood procedure, such as a QUEST (quick estimation by sequential testing) threshold procedure, or a ZEST (zippy estimation by sequential testing) threshold procedure, described below, such procedures being well-known in the art of stimulus threshold determination. In some embodiments, these adjustments (e.g., using ZEST) may be determined on a per condition basis. In other words, for each condition (used in each task), the visual sweeps may be presented (and adjusted) in accordance with a maximum likelihood procedure (e.g., ZEST) applied to trials under that condition. Moreover, as also described above with respect to the method of FIG. 3, the repeating may also include performing threshold assessments in conjunction with, or as part of, the exercise, e.g., using a 2-staircase maximum likelihood procedure, e.g., a 2-stair ZEST procedure. FIG. 4, described above, illustrates convergence to a threshold value over a series of trials in an exemplary two-stair ZEST threshold procedure.

Thus, in some embodiments, a single staircase (or single stair) ZEST procedure such as that described above may be used to adjust the intensity of the visual sweeps during training, and a 2-stair or staircase ZEST procedure may be employed for occasional or periodic assessments.

As described above, in some embodiments, other schemes may be employed to adjust the stimulus intensity and perform assessments. For example, in some embodiments, a single-stair N-up/M-down procedure may be used to adjust the stimulus intensity of the visual sweeps exercise stimuli during training, and a 2-stair N-up/M-down procedure may be employed for the assessments. It should be noted that other features described above may also apply in these embodiments, e.g., adjusting the stimulus intensity (e.g., the visual emphasis) to approach and substantially maintain a specified success rate for the participant, and so forth. In other words, the use of N-up/M-down procedures does not exclude other aspects of the methods disclosed herein that are not particularly dependent on the use of maximum likelihood procedures.

As noted above, over the course of the exercise, trials may be performed under each of a plurality of visual sweep conditions. Moreover, such conditions may include baseline conditions used for assessment trials, which, as described above, may be performed at specified points during the exercise to assess the participant's performance, as well as non-baseline conditions used for training trials for cognitive training of the participant. The following exemplary sweep conditions may be suitable for use in the respective tasks of the exercise, although it should be noted that any other conditions may be used as desired.

For the spatial frequency sweep task (Task 1), the baseline condition may include: a black and white (or grayscale) sweep pattern; vertical orientation; and a 1.26-3.18 c/deg range. For the orientation sweep task (Task 2), the baseline condition may include: a black and white (or grayscale) sweep pattern; a medium speed or rate of rotation of the sweep pattern; and 2 c/deg for the sweep pattern. In one embodiment, the threshold level for baseline measurements or assessments is 62.5% and two randomly interleaved adaptive staircases may be used, as described above.

For the spatial frequency sweep task (Task 1), there may be 12 non-baseline conditions, which may include: 3 c/deg ranges (0.5-1.26, 1.26-3.18, 3.18-5); and 4 orientations (90, 0, 45, and 135 deg) for each of these ranges. Similarly, for the orientation sweep (Task 2), there may also be 12 non-baseline conditions, which may include: 4 fixed c/deg values (0.5, 1, 2, 4); and 3 rotation speeds or rates (0.5, 1, 2 deg/sec) for each of the c/deg values.

Thus, for both tasks, there may be 24 non-baseline conditions (12 per task), although other numbers and values of conditions may be used as desired. Note that in some embodiments, for non-baseline trials, i.e., for training trials, the colors used for the sweep patterns may be rotated over 96 training segments (e.g., 24 non-baseline conditions*4 repeats per condition). In one embodiment, for baseline and non-baseline training taken together, each of 4 colors may be presented an equal number of times overall (e.g., 26 training segments each).

In some embodiments, the patterns will be presented in four colors, and gray may be used for the assessments: Purple: S+, Yellow: S−, Red: L+, Green: M+, and Gray (for assessments). Note that the colors may be chosen so that they maximally stimulate the color channels in visual cortex. Note further that these colors may vary in chromaticity and saturation in different embodiments.

In some embodiments, the method may also include performing a plurality of “eureka” trials during the exercise. These trials may be performed periodically during the exercise, e.g., every 20 trials or so, where each eureka trial may comprise a non-Zest trial that is easier than the current threshold estimate—e.g. 2×threshold). In other words, the presentation time or duration may be twice that currently used in the exercise. In one embodiment, the maximum presentation time for the eureka trials may be 1000 ms, and the minimum may be 10 ms, although other ranges may be used as desired.

In some embodiments, the method may also include performing a plurality of practice trials, i.e., prior to performing the method elements described above. For example, in some embodiments, one or more practice sessions may be performed prior to the beginning of training to familiarize the participant with the nature and mechanisms of each task. For example, in one embodiment, before training begins for each of the spatial frequency and orientation tasks, the participant may perform at least one single sweep session, in which a single visual sweep is presented, and the participant is required to indicate the nature (e.g., direction) of the sweep, and at least one order task practice session, in which a sequence of visual sweeps are presented and the participant is required to indicate the order of the sweeps, as described above. In each practice session, a specified number of trials (e.g., 5) for each of one or more practice conditions may be performed, e.g., where each stimulus pattern is at 2 c/deg. In some embodiments, the participant may be able to invoke such practice sessions at will during the exercise, e.g., to re-familiarize the participant with the task at hand.

Further Exemplary Embodiments

As noted above, in some embodiments, the visual sweep exercise may be presented and performed in the context of a game. In many cases, game play may be essential to the exercise both to help keep participants engaged in the exercise for the full training period and to stimulate key learning neurotransmitters. Thus, games implementing the above visual sweep exercise(s) may serve to train participants across a complete set of non-hierarchical stimulus categories and hierarchical visual emphasis levels (described below) ordered into configurations that are integrated with game play so that they can experience the full range of stimuli in an engaging way and realize benefits that generalize to their real-life visual experience. Specifically, game play may be designed to engage the user in the following ways: Focus: learning under conditions of sharp focus promotes the release of acetylcholine; Reward: expectation of reward encourages the release of dopamine; and Novelty, e.g., new and surprising experiences: encountering something new or surprising promotes the release of norepinephrine.

Below are described exemplary games within which embodiments of the above exercise may be implemented, embedded, or encapsulated, although it should be noted that other games may be used as desired. Note that each game may be presented and interacted with via a GUI, whereby progress through the game may be effected and indicated, as will be described below in more detail.

Exercise Games

The following describes exemplary games in which the above Visual Sweep exercise may be embedded or encapsulated. It should be noted, however, that these games described are meant to be exemplary only, and are not intended to limit the games to any particular type or appearance.

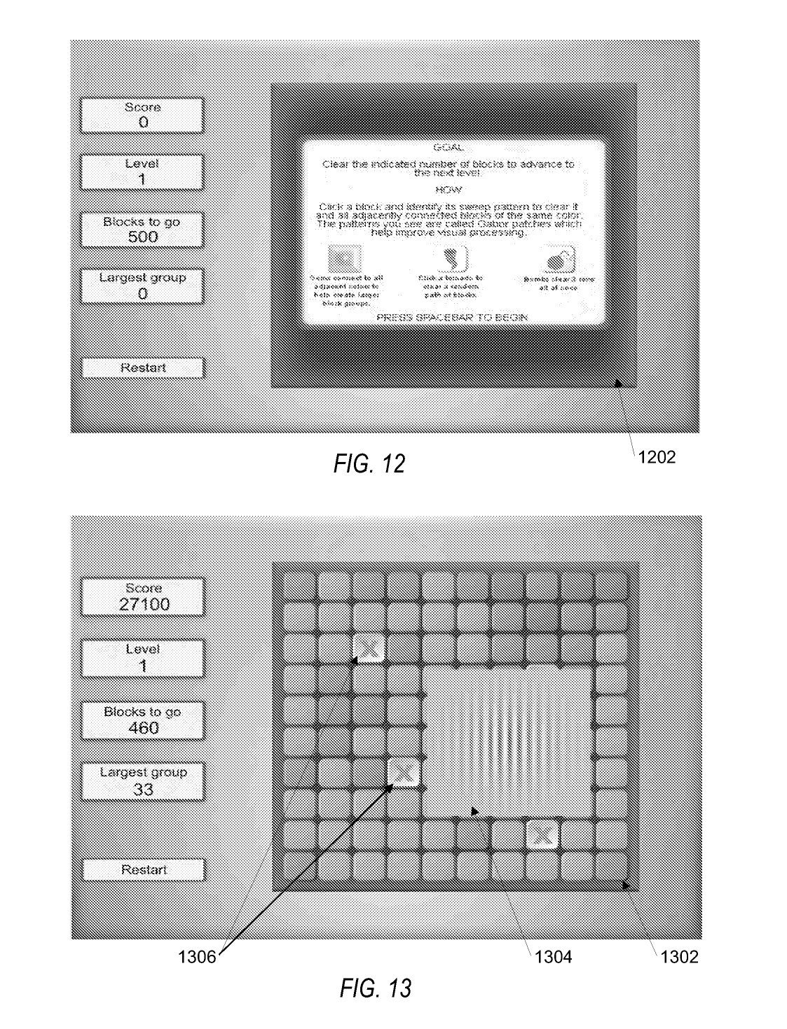

Below is described an exemplary embodiment where the exercise is incorporated into a block style game, illustrated in FIGS. 12-15, in which the participant successively clears blocks from a grid by correctly performing trials in a visual sweep task, such as those described above.

Turning to FIG. 12, an exemplary GUI is shown in which an introductory screen of the block game is displayed. As may be seen, the GUI includes a display area 1202 which, in this introductory screen, displays rules for the game, as well as a number of indicators and controls-specifically, indicators that display the current score, the current level of the game, the number of blocks remaining to be cleared, and the largest group of blocks (of the same color), which in various embodiments may indicate the largest such group currently in the grid, or that has been cleared so far, as well as a button for restarting the game. It should be noted however that these indicators and controls are meant to be exemplary only, and are not intended to limit the GUI to any particular form, function, or appearance.

As the displayed instructions indicate, in this exemplary game, the participant may be presented with a grid of colored blocks. FIG. 13 illustrates such a block grid 1302. The participant may select one of the blocks, thereby invoking a trial in a visual sweep task. In one embodiment, as shown in FIG. 13, upon selection of a block, a pop-up window 1304 may be displayed in which one or more stimulus patterns, e.g., visual sweeps, are presented. In other words, the participant may click on a block and visual sweep stimuli may appear in a temporarily expanded box (the pop-up window 1304). As may be seen, in this example, the sweep stimulus utilizes a Gabor pattern, although other patterns may be used as desired. As FIG. 13 also shows, the grid may also include blocks 1306 that were selected previously, but for which the participant did not perform the associated trial correctly. These blocks are shown labeled with an “X”.

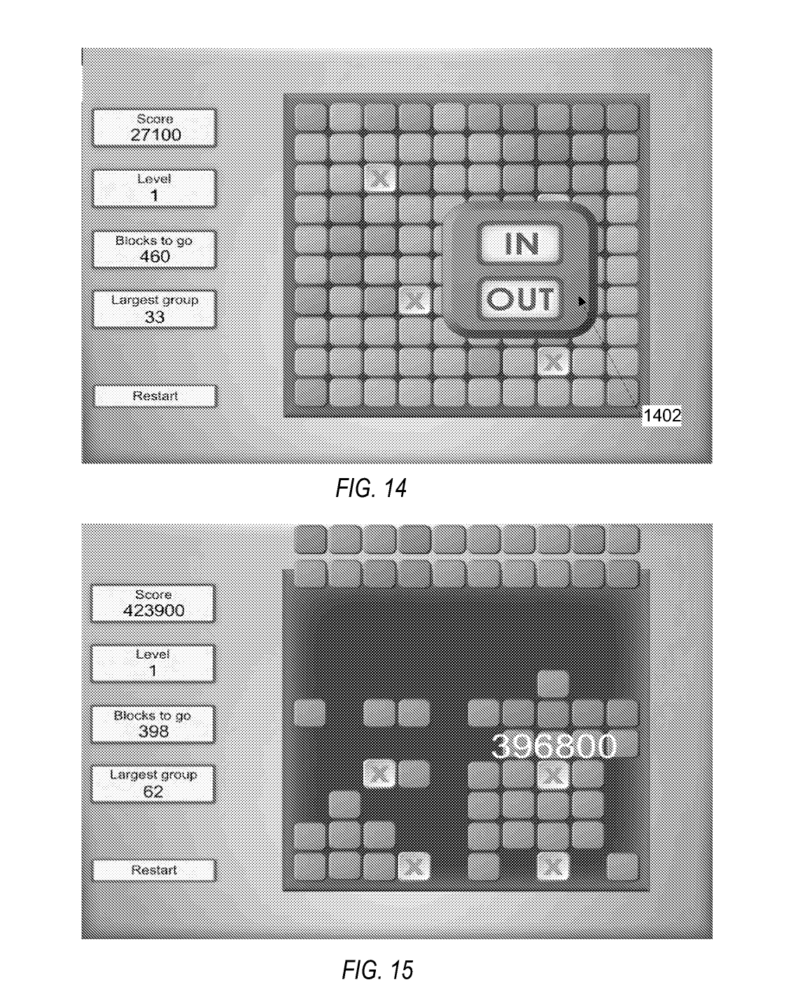

As FIG. 14 shows, once the stimulus patterns (visual sweeps) have finished a response box 1402 may appear that presents selectable icons or buttons whereby the participant may respond, e.g., by selecting the buttons in a sequence that indicates the order of the presented visual sweeps, as described above. Note that in other embodiments, other means for responding may be used as desired. For example, rather than a response box 1402 that appears dynamically after presentation of the stimuli (visual sweeps), the response buttons may be displayed in the GUI continuously or statically, e.g., below the block grid.

As noted above, if an incorrect response is made, the selected block may be marked by an ‘X’. If the participant responds correctly, the selected block and adjacent blocks of the same color may be cleared and additional points received. FIG. 15 illustrates the situation after such a clearing of the blocks and award of points, as reflected by the modified grid and score indicator, respectively.

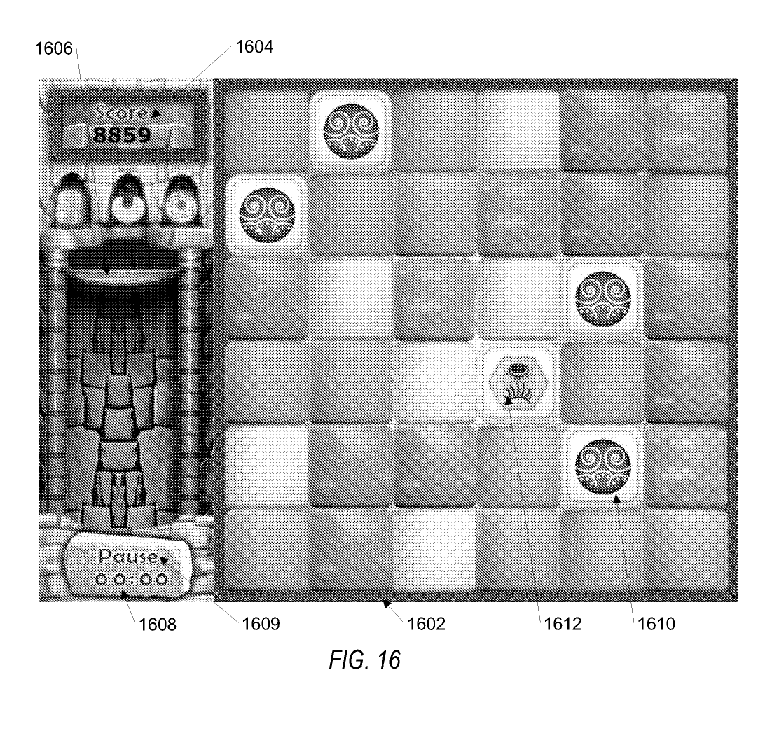

The following describes an exemplary embodiment where the exercise is incorporated into a tile matching game, illustrated in FIGS. 16-22, in which the participant successively clear tiles from a game board by correctly performing trials in a visual sweep task, such as those described above, or by achieving rows or columns of three or more tiles of the same color. Note, however, that in contrast to the block style game described above, illustrated in FIGS. 12-15, in this game, as tiles are cleared from the board, new tiles are added, i.e., constantly replenishing the tiles. Progression through the game includes performing visual sweep trials under a variety of conditions, referred to as “configurations”, that specify such attributes as Gabor pattern orientation, spatial frequency (range), and color of the pattern, although other attributes may be specified as desired. Each configuration may include or specify a plurality of trials using stimuli in accordance with the specified attributes of the configuration.

In one embodiment, the general game process is as follows: a grid of tiles is presented, where each tile has a randomly assigned color selected from a number of available colors, e.g., from four different colors. The game and embedded exercise are played or engaged via a GUI, whereby game and exercise elements are presented or displayed to the participant, and whereby the participant responds, e.g., via buttons, keys, mouse-clicks, etc. FIG. 16 illustrates and exemplary screenshot of the game that illustrates the game board or tile grid 1602, as well as various GUI elements. As may be seen, in this embodiment, the game board 1602 includes tiles of 5 different colors in a 6×6 grid.

In preferred embodiments, the GUI may include various elements indicating the participant's progress in the game. For example, the GUI may include a score indicator (scoreboard) 1604 for displaying accumulated points, i.e., the current score. The score indicator can preferably accommodate 5 digits or more. Moreover, in some embodiments, along with the current score, the scoreboard may show the number of points and tiles cleared in each trial (not shown in FIG. 16).

In some embodiments, the GUI may also include a trial meter 1606 that indicates progress through a current configuration. For example, in one embodiment, the trial meter may comprise a coin scale to which coins may be added, as shown in FIG. 16. Each correct trial may add a coin to the scale, e.g., on the left of the game board, thereby lowering the scale slightly. When the scale reaches bottom (i.e., is full) the configuration is complete and the participant may progress to the next configuration. The number of coins that can be held in the scale determines the exit criteria for the exercises. For example, in one embodiment, the participant may exit a configuration when they have acquired 40 coins, although it should be noted that this value may be different, or may be adaptive based on the participant performance. However, the number of coins needed to exit a configuration is preferably known when the configuration starts. This number may then be used to determine how much the scale should move for each correct trial.

As FIG. 16 also shows, the GUI may also include a timer 1608, where the timer may indicate time remaining in a time-constrained schedule, as well as a pause button 1609, whereby the participant may pause the game, e.g., to assess progress, consider tile selection strategies, and so forth.

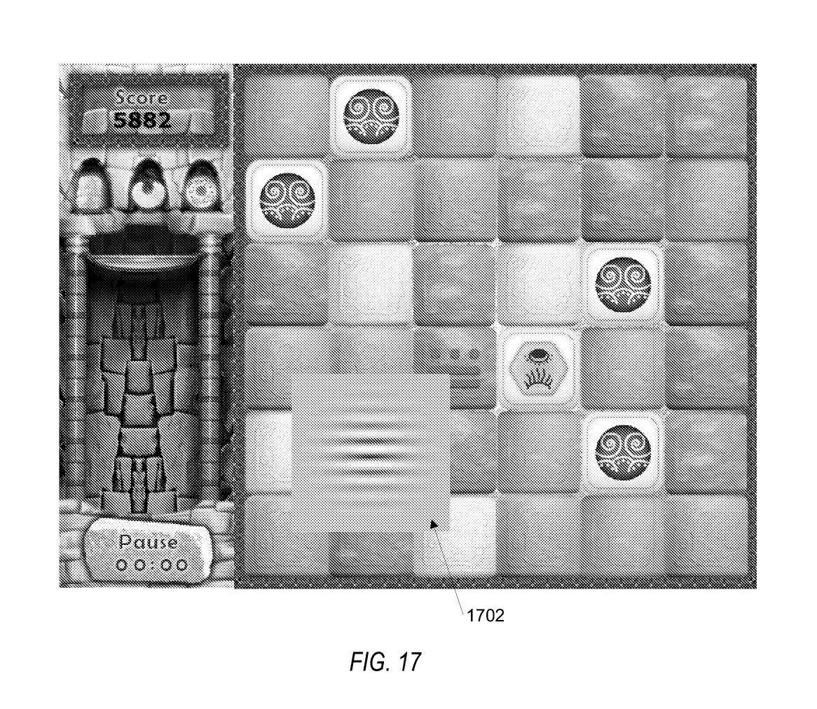

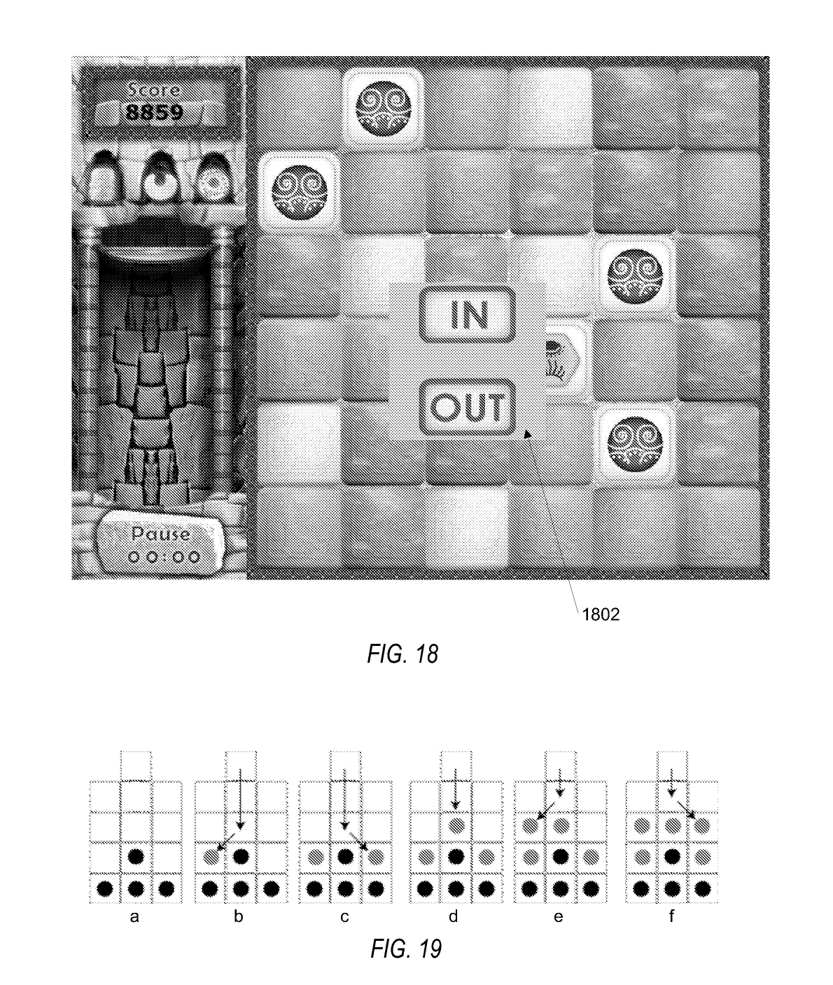

Continuing the general game process, the participant selects a tile (which serves as a “start” button for the trial), and a visual sweeps trial is performed, e.g., a visual frequency sweep trial. FIG. 17 illustrates an exemplary presentation of a Gabor pattern 1702 as part of a visual frequency sweep of a trial, where the trial is performed in response to selection of a tile in the grid. Note that in this embodiment, the stimulus (frequency sweep) is simply overlaid on the game board, although it should be noted that in other embodiments, the trial may be presented in a dialog box, may (temporarily) replace the game board, etc., as desired. FIG. 18 illustrates presentation of a response box 1802 whereby the participant may indicate the direction of the visual sweep, in this case, IN or OUT, as described in detail above.

If the trial is performed successfully, the tile is cleared—possibly with a visually rewarding animation, e.g., illustrating “collapse” of the tile, i.e., the tile disappears, and points are awarded. When the tile is cleared, the tile directly above the original tile “falls” or “slides” down into the vacant position left by the cleared tile, causing the tile above that one to also fall, and so forth, causing a cascade of tile re-positionings in the grid. If these re-positionings result in a sequence of three or more consecutive tiles of the same color (either horizontally or vertically), all the tiles in the sequence may collapse. Thus, during the game, the participant preferably tries to clear tiles to create sets of three or more matching colored tiles. If the trial is performed unsuccessfully, no points may be awarded, and in some embodiment, the tile is inactive or dormant for a specified number of trials, e.g., 3.

Turning back to FIG. 16, as may be seen, in addition to the normal “trial” tiles (the colored tiles), the grid may include, various special tiles, such as treasure tiles 1612 that have an associated treasure reward, and power-up tiles 1610, referred to as “power-ups”, that may have any of various effects on the grid. Another type of tile, referred to as a locking tile, may be placed adjacent to power-ups, and must be cleared before the power-up may be activated or accessed. These game elements and more are described in detail below. As the participant plays this game, he or she progresses through visual sweep trials, e.g., visual frequency sweep trials (and/or orientation sweep trials), under a variety of conditions or configurations, as described above. In some embodiments, the game may allow for 48 10-minute sessions (8 hours) of play, where sessions are 10 minutes long, with two configurations played per session. Note that the game play is designed to be integrated with the stimulus configuration in order to challenge participants to move through the full set of visual sweep trials.

Game Elements

The following provides a functional description of elements in the game that the participant can engage, acquire, or otherwise interact with, according to one embodiment. Note that these elements and their characteristics are meant to be exemplary only, and that other elements and/or characteristics may be used as desired.

Tile States

In some embodiments, none of the tiles may have ‘down’ states. All of the tiles may have rollover states (referring to behavior of the tile when the participant moves the cursor over the tile) with the following exceptions: treasure tiles may never have rollover states and may not be ‘clickable’. Power-up tiles may not have rollover states and may not be ‘clickable’, and additionally, may not slide down when tiles below them are collapsed. Locking tiles for power-ups may not have rollover states and may not be ‘clickable.’ In addition to this locking tiles may not slide down when tiles below them are collapsed. If a participant gets a stimulus incorrect the tile they click may become dormant and may not have a rollover state until the dormant state is cleared. When the tile is in this state it may not respond to participant clicks.

Correct Trial

When the participant correctly performs a trial, the tile may collapse, a coin may pop out of the tile and a sound may be issued or played (indicating success). The coin may be added to a scale that contains coins, e.g., displayed on the left-hand side of the screen. When the scale reaches the bottom of the screen the configuration may be considered completed. The stack has room to accommodate some specified number of correct trials, e.g., 40 (e.g., accommodating 40 coins). Each correct response may add points to the score. If the trial results in further collapse, a graphical effect, e.g., a particle system animation, may accompany each successive collapse and additional points may be awarded.

Incorrect Trial

If the participant incorrectly performs the trial, a sound may be issued (indicating failure) and the tile may change to a muted color, e.g., may change to a dormant state. The participant may not be able to click on the tile until some specified number of trials, e.g., three, have been completed (regardless of whether the participant performs the trials correctly or not). The tile may contain a counter that may indicate to the participant how close they are to freeing the tile from the dormant state. The update to the tile counter may happen at the same time a participant initiate a trial. If the trial frees the tile from the dormant state, the tile state may be reset and a graphical effect, e.g., a particle system animation, may be initiated. This may only happen after the participant responds to the current stimulus set and all collapsing tiles are resolved. Dormant tiles can be collapsed if they are part of a group of three or more matching colors. In other words, by aligning three or more tiles of the same color (either horizontally or vertically), the tiles may collapse, and so the participant may clear those tiles without performing the trials normally required to clear them. Note that no points may be awarded for an incorrect trial and no coins may be released.

Regular Tiles

Tile layouts may be able to support irregularly shaped game boards (e.g. layouts other then rectangular). A correct trial may result in a tile being removed from the game board. As indicated above, any of the tiles that are above the collapsed tile may move down, and new tiles may be added to fill in the gaps above the collapse. In preferred embodiments, the cascading motion of the tiles as they collapse may be smooth and may occur over 2 or 3 frames. As also noted above, if three or more tiles have the same color and are adjacent to each other (vertically or horizontally) they may collapse. When this happens a graphical effect, e.g., a small particle system animation, may be presented to draw the participant's attention to the collapse and a unique sound may be issued. While tiles are collapsing and moving into their new positions the participant may not be allowed to engage in a trial.

Tile Collapsing Rules

When tiles are collapsing any rollover state may be reset, and rollover states may not be active while the collapsing is occurring. Similarly, the participant may not be allowed to click on any of the tiles while they are collapsing. Once the last tile has stopped moving, all of the tiles may be reviewed for additional collapses. For example, the tiles may be checked for three or more in a row of the same color. If additional collapses are detected, the blocks may be collapsed and additional blocks may be added.

Filling in Eliminated Tiles

When a tile falls the following rules may be used to determine the next position to move to. Tiles may continue to move down until they hit an obstruction (e.g., a locked tile or a game board border). FIG. 19(a-f) illustrates various ways in which tiles may adjust to a new space to fill. FIG. 19a shows a tile configuration where the opening or entry point for new tiles is at the top of the middle column of a three column grid (or grid portion). As FIG. 19b shows, if there is an opening to the left of the tile it may move diagonally to fill the space. If there is an opening to the right of the tile it may move right to fill the spot, as shown in FIG. 19c. If there are no openings the tile may stay at rest in its landing position, as illustrated in FIG. 19d. FIGS. 19e-f illustrate these same principles applied a second time, e.g., after the moves of FIGS. 19b-d.

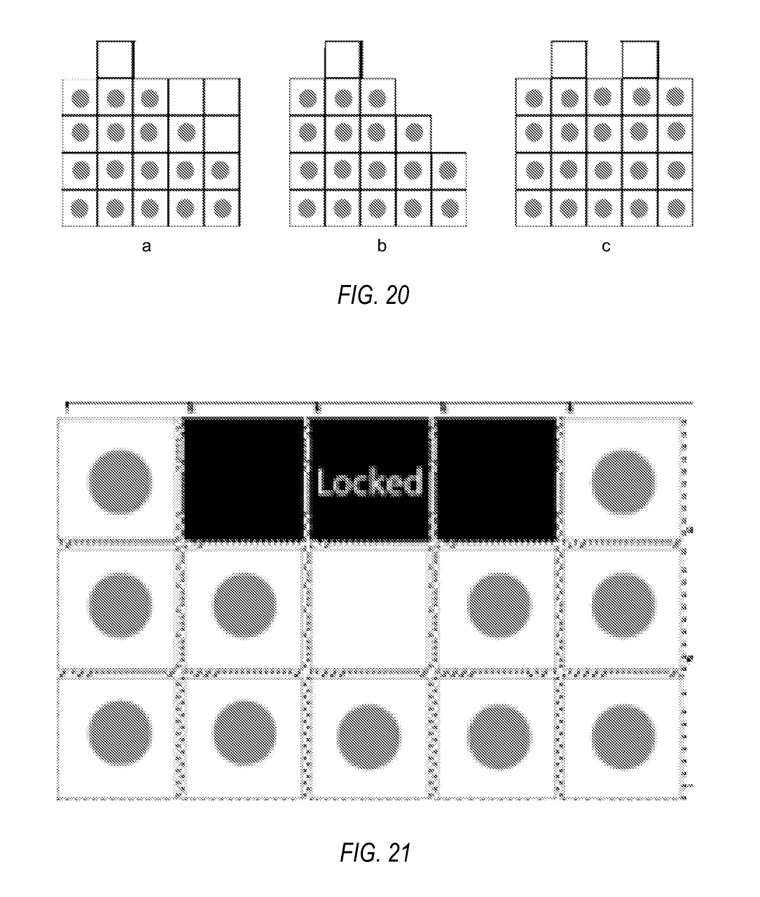

Limitations: Note that in some cases, the rules and mechanisms presented above may limit the amount of area that can be filled. For example, in cases where there is only one opening through which new tiles are added to the grid, only the area shaped in a cone below the opening can be filled. FIG. 20a illustrates this issue, where, as shown, the area (three slots) in the upper right of the grid cannot be filled by cascading tiles entering through the opening or entry point at the top of the second column (counting from the left). There are (at least) two solutions to this problem. First one can simply modify the layout or shape of the grid to accommodate the limitation, e.g., by removing tile slots or positions that are inaccessible to the opening or entry point, as shown in FIG. 20b; or, one may simply add an additional one or more openings or entry points, as illustrated in FIG. 20c, where there are two openings or entry points, such that every slot in the grid is accessible or available for positioning of tiles.

Note that in some embodiments, there may never be more then three locked tiles in a row, e.g., possibly as a result of the above rules. This may have implications for how power-ups are constructed, making constructions like that shown in FIG. 21 impossible to fully support. As may be seen, in this configuration, no further movement of tiles is possible, since the only open space is effectively blocked both from above and on each side.

Treasure Tiles

As noted above, some tiles may contain treasures locked inside of them (see, e.g., tile 1612 of FIG. 16). The participant may not be able to directly click on these items, but may be able to unlock them by collapsing them in groups of three, horizontally or vertically aligned. When the treasure is released it may animate to a side bar of the GUI, and a tally may be incremented to indicate that the participant unlocked the treasure. Moreover, additional points may be added to the score in addition to the point for the correct trial and the collapsed tiles. If more then one treasure is unlocked at the same time the participant may receive credit for all unlocked items. In some embodiments, the introduction of treasure items may increase over time, but may not be available in initial configurations, e.g., in the first four configurations. In one embodiment, a maximum of three types of treasure may be available in any configuration. As one example, a treasure tile may appear with a specified frequency, e.g., 5%. Thus, in this example, when new tiles are added to the board a treasure tile may appear 5 times out of 100.

In some embodiments, the frequency of each of the treasure tile types may be distributed in the following manner, although other frequencies may be used as desired. In scenarios or configurations where there is one treasure, 15% of the tiles may be treasure tiles of a first type. In scenarios or configurations where there are two treasures, 10% of the tiles may be of the first type of treasure tile, and 5% may be of a second type of treasure tile. In scenarios or configurations where there are three treasures, 10% of the tiles may be of the first type of treasure tile, 4% may be of the second type of treasure tile, and 1% of the tiles may be of a third type of treasure tile. Note that each treasure tile type may have a respective type of treasure. Each treasure type may appear at least once in each completed configuration.

Achievements

In some embodiments, during the game, various achievements may be met by the participant with respect to different aspects of the game. These achievements may help motivate the participant to continue through the exercise, and may provide further mechanisms for reward. For example, each time an achievement is met, a reward, such as a congratulatory message or display may be presented to the participant. An exemplary list of such achievements is provided below, although other achievements may be used as desired.

Tracking progress against an achievement can be difficult when a configuration spans multiple sessions. In some cases it may be desirable to save the progress towards the achievement from one session to the next, whereas in other cases this may not be desirable. For example if the participant is trying to complete a configuration in under 3 minutes, the participant may want to remember how much time was spend in the configuration upon exiting. On the other had, if the participant is trying to successfully perform eight trials in a row, the participant may not want the information persisted from one session to the next. Each achievement type may have an indication as to whether the related information for that achievement should persist or not. Note that the game may include various achievements or metrics of success that allow the participant to achieve success with respect to a number of different aspects, including, for example, number of successful trials in a row, overall success rate, success with respect to trials of specified (and increasing) difficulty, and so forth. Exemplary achievements are provided below, although other metrics may be used as desired.

Correct Trails in a Row (information may not persist from session to session): one level of achievement may be met if the participant performs 7 trials in a row correctly. A second level of achievement may be met if the participant performs 10 correct trials in a row

Points (information may persist from session to session): a first level of achievement may be met if the participant gets more then 10,000 points in a configuration. A second level of achievement may be met if the participant gets more then 15,000 points in a configuration. A third level of achievement may be met if the participant gets more then 20,000 points in a configuration.

Game Level Comparison (information may persist): all of these achievements may be based on the best score in the previous game level. Game levels may be advanced per some specified number of configuration, e.g., every 32 configurations. A first level of achievement may be met if the participant completes a configuration in less time then their best time in the previous game level. A second level of achievement may be met if the participant finishes the configuration in less trials then they did in the previous game level. A third level of achievement may be met if the participant gets a higher score then their best score in the previous game level.

Number of Tiles (information may not persist): This achievement may be met if the participant correctly performs the number of trials required to complete a configuration in less than some specified total of trials, e.g., if 40 correct trials are required to complete a configuration, and the participant correctly performs the 40 trials in a total of 48 trials, say, instead of an allowed 60 trials.

Treasures (information may persist): This achievement may be met if the participant collects more than some specified number of treasures in a configuration, e.g., 14 treasures in a configuration.

Tiles (information may not persist): A first level of achievement may be met if the participant collapses more than some specified first number of tiles in a single trial, e.g., more than 8 tiles in a single trial. A second level of achievement may be met if the participant collapses more than some specified second number of tiles in a single trial, e.g., more than 10 tiles in a single trial. A third level of achievement may be met if the participant collapses more than some specified third number of tiles in a single trial, e.g., more than 12 tiles in a single trial.

Time (information may persist): This achievement may be met if a participant completes a configuration in under some specified time, e.g., under 3 minutes.

Introduction of New Game Elements

In some embodiments, the participant may be provided an introduction to the game elements in one (or both) of two different ways. In a first approach, the participant may be introduced to the game elements in an instruction screen that may appear the first time the game is entered. This screen may introduce the basic game concepts and facilitate the participant starting the game. In some embodiments, the instruction screen may also include a general overview of game aspects such as multiple collapses, treasure tiles, and power-ups, among others. The participant may be able to access the instructions screen any time, e.g., from a menu in the GUI.

In some embodiments, in addition to the instructions page the participant may be presented with in-game prompts that may introduce new gaming concepts as they are brought into the game. What follows are a list of areas that may require additional explanation. The information may be presented in a text format, graphically, and/or via animated sequences. Note that some of these items may require instruction only when they are first introduced to the participant. Thus, if the participant has completed the entire game and cycles back to the beginning it may not be necessary to re-introduce these elements. An exemplary list of main points for intervention (in-game explanation) may include, but is not limited to:

Introduction of the game navigation: This explanation may include how to access the side bar menu system and what type of information to look for in the side bar. This should only appear the first time a participant enters an exercise

First time issuing a trial: e.g., click button or tile to start a trial.

First time getting a trial incorrect: This explanation may include information about why the tile is inactive and when it may become active again.

The first time an incorrect trial tile becomes active again.

First time a treasure piece is introduced to the game board.

First time a power-up is acquired.

First time a power-up is activated.

First time the participant is presented with a configuration summary screen.

Points

Points in the game may be awarded using any of a number of schemes. The following presents one such scheme, although other schemes may be used as desired. Note that the scheme below is presented in terms of an elementary point increment, P, which may initially be set to a value of 2, but which may subsequently vary by configuration or other rules.

Action points may be awarded according to the following scheme:

TABLE 1

| Action | Points Awarded |
|---|---|
| Clear single tile | P |
| Clear a row or column of 3 tiles | Number of tiles cleared * P |
| Clear a row or column of more than 3 | Number of tiles cleared * P |
| tiles | |
| Clear a connected row and column of | 2 * (number of tiles cleared * P) |
| tiles | |
| Clear multiple unconnected rows or | Number of tiles cleared * P |
| columns of tiles | |
| Unlock a power-up | 2 * P |
| Use a power-up | Number of tiles cleared * P |
| Clear treasure tile | P (more points stored for bonus) |

As indicated in the last entry of Table 1, when treasure tiles are cleared, additional points, i.e., bonus points, may also be awarded, as described below in Table 2.

Bonus points may be awarded for cleared treasure tiles, and may be added to the participant's score at configuration transitions, i.e., upon exiting a configuration. Bonus points may be awarded in increments of P points. Table 2 presents an exemplary scheme used to award bonus points based on the type of treasure acquired, i.e., based on the type of treasure tile cleared.

TABLE 2

| Treasure | Bonus Points Awarded |
|---|---|
| T1 | 2 * P |
| T2 | 4 * P |
| T3 | 6 * P |
| T4 | 8 * P |
| T5 | 10 * P |
| T6 | 12 * P |
| T7 | 14 * P |
| T8 | 16 * P |

Power-ups

Power-ups (see, e.g., element(s) 1610 of FIG. 16) may offer participants an alternative method of clearing tiles from the game board. For example, each game level may have 3 or 4 power-ups that may be introduced into the game play on a regular schedule. The power-up may include the power-up tile and supporting locked tiles that may need to be solved before the participant can activate and use the power-up.

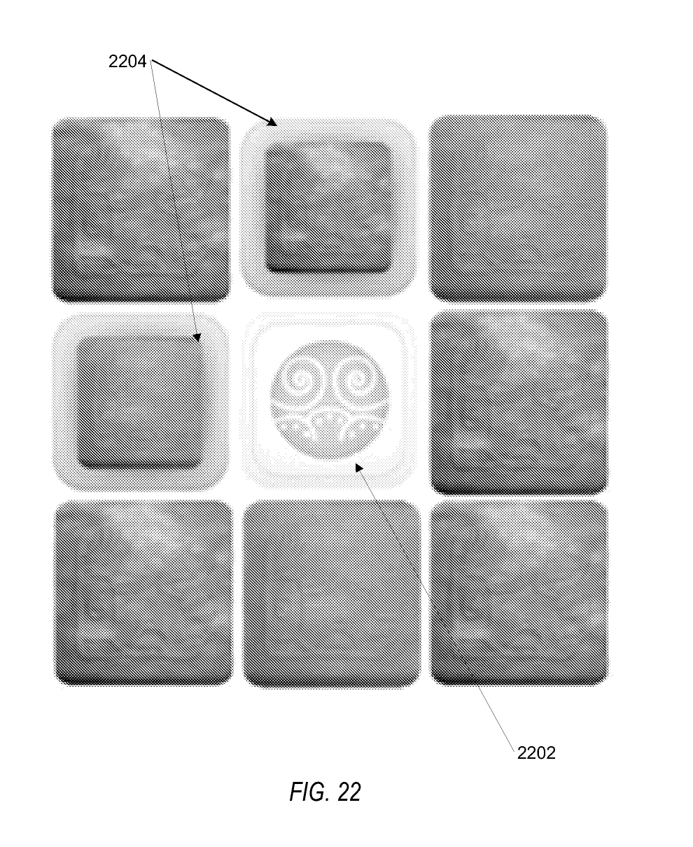

Each power-up tile may be surrounded by 1-3 locking tiles that must be cleared before the power-up can be used. FIG. 22 illustrates this concept. As shown, the center tile 2202 is the power-up tile and the tiles 2204 above and to the left of it are the locking tiles. Note that the locking tiles preferably do not move from their respective locations unless they are collapsed. Thus, considering the arrangement of FIG. 22, if the bottom row of tiles were to be cleared, the locking tiles would not fall to a lower row, but rather, would stay where they are located. In preferred embodiments, the only way to remove a locking tile from the board is to collapse it by matching three (or more) colors in a row. Thus, in the example of FIG. 22, if the tile in the upper right corner were blue, the row would collapse and the locking tile would be cleared. Once all locking tiles adjacent to a power-up are cleared the power-up may become active. Locking tiles may behave according to the following rules:

Locking tiles may have an appearance that identifies them as part of the power-up, such as shown in FIG. 22. Initially the power-up tile and the locking tiles may not be clickable, and so a participant cannot solve the tile by clicking on it to invoke and perform a trial correctly. As noted above, the participant may only eliminate the locking tiles by re-arranging other tiles in such a way that the locking tile is part of a three (or more) in a row combination. When this happens the locking tile collapses, along with the others in the row (or column). When all locking tiles that are adjacent to a power-up have been cleared, an animation, e.g., a particle effect, may be presented, and the power-up may transition from its dormant state to an active state that a participant can then click on. Power-up and locking tiles may not move like normal tiles. For example, in preferred embodiments, they may be placed on the game board at startup and may not change position until they are cleared or solved. If one or more tiles below the power-up or locking tiles are solved, tiles from the side may flow in to fill the new spaces in the game board.

Initially, the power-up tile may appear in its dormant or muted state, and may not have a rollover state or respond to a participant click. Once a power-up tile is unlocked, e.g., by clearing the adjacent locking tiles, the appearance of the power-up may change, an animation, e.g., a particle effect, may be presented to signify that the power-up is activated, and the power-up may then respond to rollovers and mouse-clicks. If a participant clicks on a power up when it is active, a normal trial may be invoked. If they perform the trial correctly, the tile may exercise or unleash its power, examples of which are provided below. If the participant performs the trial incorrectly, some number of the surrounding tiles (e.g., 1-3, depending on the game level) may become locking tiles, and the power-up may returns to its dormant or muted state.

The type of power-up's available and the number of locking tiles associated with them may be determined by a specified schedule or scheme. The power-ups may accumulate over time in each game level, so that once a power-up is introduced into game play there is a possibility that it may be available on every successive configuration until the game level changes. Once the game level changes an entirely new set of power-ups may be used. Table 3 presents the types of power-ups, the configurations in which they appear, and the number of locking tiles associated with them, although it should be noted that the schedule is meant to be exemplary only, and that other schedules and schemes may be used as desired.

TABLE 3

| | | | No |
|---|---|---|---|
| | | No. On | Locking |
| Configuration | Power-Up | Screen | Tiles |
| 1-8 | — | — | — |
| 9-16 | Earthquake | 1 | 1 |
| 17-24 | Fire Fly | 2 | 1 |
| 25-32 | Corn | 3 | 1 |
| 33-40 | Typhoon | 1 | 2 |
| 41-48 | Lighting | 2 | 2 |
| 49-56 | Quicksand | 3 | 2 |
| 57-64 | Might Wave | 3 | 2 |
| 65-72 | Resurrection | 1 | 3 |
| 73-80 | Arrow | 2 | 3 |
| 81-88 | Dust Storm | 3 | 3 |
| 89-96 | Destructive Force | 3 | 3 |

The effects of these various power-ups are described below, although it should be noted that the power-ups described herein are meant to be exemplary only, and that other power-ups with other effects may be used as desired.

Because power-ups have specific functionality, and because they never move, they may follow specific rules, as follows. Power-ups may never be added in the middle of a configuration. All power-ups may be placed on the board when the configuration starts. Power-ups may be placed towards the center of the game board. Moreover, they may be placed such that they always have at least 2 rows of tiles above them and at least 1-2 to columns of tiles on either side. There may never be more then two horizontally consecutive locking tiles. Once a power-up is used it may be removed from the game board. Power-ups may be placed at least two rows and two columns away from each other. As noted above, no power-ups may be available in the first eight configurations.

Example Power-Ups

The following provides a description of the visual effect of each of the above power-ups and the effect each power-up has on the game board. Each of this effect may operate over a relatively short period of time (e.g., 3-5 seconds), and once the effect is completed the game board may check for collapses and add tiles as needed. In some cases these descriptions refer to a specific animation or special effect, although other animations or effects may be used as desired.

Earthquake: When the Earthquake power-up is activated all the tiles on the game board may start shaking. At first the shaking may only involved displacements of 1 or 2 pixels, but may increase over time to 10-15 pixels. This may be followed by an animation, e.g., a particle effect, at which time every tile on the board may be swapped with another tile on the game board. The pattern for swapping may be random. Note that this effect may not change the position of locked tiles or power-ups.

Fire Fly: When this power-up is activated a glowing ball may be released from the tile and begin moving in a random direction. The motion may be defined by a specified function or model, e.g., a sine particle wave model, and a tail may extend from the ball. As the ball moves the tile below the object may glow yellow for a short time then slowly fade to a new color. Once the tile turns completely to the new color a small burst may be displayed or released. The color the tiles change to may be selected at random, but all tiles touched preferably change to the same color. When the glowing ball leaves the game board it may explode into a small particle burst.

Corn: This power-up may release 2-3 balls into the neighboring tiles. The balls may bounce up into the air (“out of the board”) and strike the neighboring tiles in the center. When the balls land on the neighboring tile, 2 or 3 additional balls may be spawned and may behave in a similar manner. None of the spawned balls may travel back in the direction from which they came. Each time a ball hits a tile, the tile may change to a color that is randomly selected when the power-up is activated.

Typhoon: This power-up may release an effect, e.g., a spinning particle effect, that may cover a diameter of 5 tiles. As the effect picks up speed each of the tiles in the area may be picked up and may start spinning around the center of the power-up. When the effect finishes the tiles may be placed back on the grid or board in a different order. Note that this effect preferably does not alter the position of power-ups or locking tiles.

Lightning: A lightning power-up may release a bolt of lighting and collapse all tiles that are in the same row as the power-up. Additionally, all of the tiles in the row directly above or below the power-up may be destroyed. If the effect collapses treasure tiles then the normal behavior defined for the collapse of these tiles may be followed. The effect may also collapse tiles that are dormant or muted due to incorrect responses. Note that this effect preferably does not affect other power-ups or the locked tiles surrounding a power-up.

Quick Sand: This power-up may release a swirling particle system centered on the power-up. All the tiles in a 2-tile radius may begin to shrink and be pulled into the center of the vortex, although power-up and locked tiles may not be affected. Once all the tiles have been pulled into the center a shockwave particle system may be released.

Might Wave: When the might way is activated the tiles in the bottom row may pull back 10-15 pixels, then release forward. This effect may then cascade to the next row and work its way across the entire game board. As the rows move forward all of the tiles that are of a specified color may flip and become a different color. Thus, for example, all red tiles may flip over and become a random color. Locked tiles may not be affected by this power-up.

Resurrection: This power-up may give the participant the ability to randomly resurrect one of the previous power-ups. When this power up is activated the tile may start cycling through all of the previous power-up types. The sixth (or some other specified) tile in the sequence may freeze on the screen and display the ‘hidden’ power-up. When the participant activates the power-up it may have the behavior of the power-up it represents.

Arrow: When this power-up is activated, 8-15 arrows may shoot straight up into the air (e.g., “out of the board”). Each of the arrows may land in the middle of one of the surrounding tiles and change the color of the tile to a pre-determined color. When the color changes a small particle effect may be released. The arrows may never strike power-ups or locked tiles.

Dust Storm: This power-up may create a dust storm that may travel up, down, left or right of the power-up. The direction of travel may be based on the direction that allows the storm to travel the greatest distance. When it is activated the tiles around the power-up may release a particle system that travels in the direction of the storm. Over time, the down-wind tiles may start releasing similar particles effects until the storm reaches the end of the game board. As the tile releases its particle system the tile may slowly start to change its color to a pre-determined color that may be shared with all tiles in the storm. Power-up and locked tiles may not be affected by this effect.

Destructive Force: When activated, this power-up may release a shockwave particle system and collapse all tiles within a 3-tile radius of the power-up. Power-up and locked tiles may not be affected by this effect.

Game Flow, Levels, and Asset Revelation Schedule

The following describes an exemplary game flow, specifying configurations and levels in the game, as well as assets associated with each configuration. As noted above, in this embodiment, the exercise has 3 game levels, each of which has 32 configurations. Each of the game levels represents a different region of the game. The first region is Mayan, the second Oceania and the third centers around Pueblo Indians, although these are meant to be exemplary only. Table 4 represents the progression of backgrounds, game board layouts, power-ups and treasures as they relate to configurations in the Mayan world, i.e., level 1. Table 5 provides this information for subsequent levels.

TABLE 4

| Map 1 | Config. | Background | Layout | | Power-ups | Treasures |
|---|---|---|---|---|---|---|
| First location | 1 | 1 | Easy | 1 | None | None |
| | 2 | | | 2 | | |
| | 3 | | | 1 | | |
| | 4 | | | 2 | | |
| Second | 5 | 2 | Med. | 1 | None | 1 |
| location | 6 | | | 2 | | |
| | 7 | | | 1 | | |
| | 8 | | | 2 | | |
| Third | 9 | 3 | Hard | 1 | 1 | 1, 2 |
| location | 10 | | | 2 | | |
| | 11 | | | 3 | | |
| | 12 | | | 4 | | |
| Fourth | 13 | 4 | | 5 | 1 | 1, 2, 3 |
| location | 14 | | | 6 | | |
| | 15 | | | 7 | | |
| | 16 | | | 8 | | |
| Fifth | 17 | 5 | | 9 | 2 | 2, 3, 4 |
| location | 18 | | | 10 | | |
| | 19 | | | 11 | | |
| | 20 | | | 12 | | |
| Sixth | 21 | 6 | | 13 | 2 | 3, 4, 5 |
| location | 22 | | | 14 | | |
| | 23 | | | 15 | | |
| | 24 | | | 16 | | |
| Seventh | 25 | 7 | | 1 | 3 | 4, 5, 6 |
| location | 26 | | | 2 | | |
| | 27 | | | 3 | | |
| | 28 | | | 4 | | |
| Eighth | 29 | 8 | | 5 | 3 | 5, 6, 7 |
| location | 30 | | | 6 | | |
| | 31 | | | 7 | | |
| | 32 | | | 8 | | |

As noted above, the above table is specific to the first game level in the game, which is different from subsequent game levels in that it has a slow ramp up for gaming elements, which allows the introduction of new game concepts and elements over time. Once the first game level is complete, subsequent levels may proceed as according to the following schedule, where “n” refers to the level number, e.g., 2 or 3.

TABLE 5

| | | Back- | | | | |
|---|---|---|---|---|---|---|
| Map 1 | Config. | ground | Layout | | Power-ups | Treasures |
| First location | n + 1 | 1 | Hard | 1 | 1 | 1 |
| | n + 2 | | | 2 | | |
| | n + 3 | | | 3 | | |
| | n + 4 | | | 4 | | |
| Second location | n + 5 | 2 | | 5 | 1 | 1, 2 |
| | n + 6 | | | 6 | | |
| | n + 7 | | | 7 | | |
| | n + 8 | | | 8 | | |
| Third location | n + 9 | 3 | | 9 | 1 | 1, 2, 3 |
| | n + 10 | | | 10 | | |
| | n + 11 | | | 11 | | |
| | n + 12 | | | 12 | | |
| Fourth location | n + 13 | 4 | | 13 | 1 | 2, 3, 4 |
| | n + 14 | | | 14 | | |
| | n + 15 | | | 15 | | |
| | n + 16 | | | 16 | | |
| Fifth location | n + 17 | 5 | | 1 | 2 | 3, 4, 5 |
| | n + 18 | | | 2 | | |
| | n + 19 | | | 3 | | |
| | n + 20 | | | 4 | | |
| Sixth location | n + 21 | 6 | | 5 | 2 | 4, 5, 6 |
| | n + 22 | | | 6 | | |
| | n + 23 | | | 7 | | |
| | n + 24 | | | 8 | | |
| Seventh location | n + 25 | 7 | | 9 | 3 | 5, 6, 7 |
| | n + 26 | | | 10 | | |
| | n + 27 | | | 11 | | |
| | n + 28 | | | 12 | | |
| Eighth location | n + 29 | 8 | | 13 | 3 | 6, 7, 8 |
| | n + 30 | | | 14 | | |
| | n + 31 | | | 15 | | |
| | n + 32 | | | 16 | | |

Game Board Layout

In some embodiments, the game board layout may change with every configuration change. The layout may begin simply as the participant is learning the game, and then become progressively harder to add interest and complexity to the game. Layouts specify or include the number, size, and color of tiles. For example, in one embodiment, easy layouts (e.g., 2 different versions) may include 36-50 tiles, and 2-3 colors. Medium layouts (e.g., 2 different versions) may include 50-85 tiles, and 4 colors. Hard layouts (e.g., 16 different versions) may include 85-110 tiles, and 5 colors. Of course, other layout schemes may be used as desired.

In one embodiment, the game may utilize a plurality of different backgrounds/locations representing “places” the participant visits during the game. For example, the backgrounds may be the ruins or locations on a map to which the participant seeks to travel. The backgrounds may essentially drive the story of the game, encouraging the participant to move through the exercise to discover the next ruin. Each game level may have a different background. In one embodiment, there may be three levels in the game, represented by Mayan, Oceania, and Pueblo Indian regions, although other regions, backgrounds, and themes may be used as desired, these being exemplary only.

When the participant has completed their last correct trial in a configuration, a large particle system effect (or other effect) may be released that signifies the completion of their goal. In addition, all the tiles may move off the screen (e.g., via animation), and a summary screen may be presented. The main portion of this screen may be occupied by a map specific to the current game level. The map may contain a specified number of milestone markers, e.g., separated by dashes, thus indicating a path with milestones. This summary screen is described in more detail below.

When a treasure tile is collapsed the icon of the tile may move (e.g., via animation) to a fixed location, e.g., on the left hand side of the screen. Each of the three treasure types may be lined up from left to right with the most common treasure type occupying the far left hand position. The additional treasure types may occupy the spaces from left to right based on how common they are. If there are less then three treasures in the game level then the treasure locations will be left empty.

Below each treasure type may be a number that represents how many of each treasure type has been accumulated. When a configuration starts these numbers may be set to 0. Each time a participant acquires a treasure icon the corresponding number may be incremented.

If the participant is in a time-constrained schedule, they will naturally exit the exercises when the timer reaches 0. If the participant is in the middle of a trial when the timer reaches 0, the participant may be allowed to complete the current trial, and may be awarded points. Any collapses that result from the trial may be resolved. Once this is complete the participant may be presented with a dialog box indicating that the allowed time has elapsed in this exercises. Of course, information related to the participant's progress may be saved so that next time the participant enters the exercise they will start in the same place. In some embodiment, a ‘Next” button may be provided whereby the participant may move on to the next exercise.”

If the last trial occurs on the same trail that marks the completion of the configuration, the participant may be presented with a configuration summary screen, where they can review their progress, after which they may be prompted to enter the next exercise.

If the participant is in a non-time constrained schedule, the timer may be set to 00:00 and may be grayed out. The participant may thus only be able to exit the exercises by accessing the side bar menu and clicking the exit button. At this point the participant's exercises data may be saved and the usual process for exiting an exercise followed.

When a participant returns to an exercise, having played it in a previous session, they may be presented with the same background, game board layout and stimulus configuration they were training with in the previous session. The new session may also keep track of the number of correct tiles, e.g., coins that the participant received. The scale (trial meter) may thus be set to reflect this progress by presenting the number of coins in the scale and positioning the scale in the proper location. In addition to this the number of treasures and the timer may be restored to the settings in effect at the end of the previous session.

In one embodiment, the final ZEST value for the configuration may be saved before exiting the exercise. If a participant is returning to a configuration they have played before then the adaptive measure for the configuration may start from the last record threshold value plus 25 to 50%. Thus, if the presentation time in a configuration were 10 ms, when the participant returns to that same configuration they may begin with a presentation time of 12.5 ms-15 ms. This holds true for participants who have completed the entire set of (e.g., 96) configurations and are returning to the exercise for a second time, and may also apply to participants who have finished the first half (e.g., 48) of the configurations and continue to repeat the confirmations in the second half of training.

Note that the specifics of the game may not need to be saved, e.g., the location of power-ups, treasure tiles, and the location of the individual tiles themselves may not need to be reconstructed.

In some embodiments, the participant may be permitted to continue the exercise after they have finished all of the stimulus configurations. For example, the participant may have the option to (re)start the exercises from the beginning. None of their previous data from the exercise may carry over to the restarted exercise, with the possible exception of the participant's assessment data, goal, and assessment history.

In one embodiment, when the participant starts the exercises for the second time they may begin on the second configuration as opposed to the first. The adaptive measure for each configuration may start from the last recorded threshold value for the configuration plus 25-50%. Thus, as above, if the presentation time in a configuration were 10 ms, when the participant returns to that same configuration they may begin with a presentation time of 12.5 ms-15 ms.

As noted above, when a configuration is complete the participant may be presented with a configuration summary screen. The summary screen may display a map that shows the participant where they are and how much further they need to go. A particle system effect (or some other graphical effect) may indicate the current completed segment on the map. The timer may be paused while the participant is reviewing their information on this screen, and the pause button may be active so the participant can exit the exercise at this point if desired.

As the participant completes each configuration one of the dashes on the map may be checked off to represent the completion of the configuration. Thus, each dash between the milestones may represent a configuration. The larger milestone markers may be denoted with images that represent different locations on the journey though the stimulus set. When a participant enters a new milestone they may be presented with a new background. Moreover, in some embodiments, the game board or grid may obtain new power-ups and may acquire new treasure tiles. Once all (e.g., 8) markers are filled the participant may move on to a new theme all together.

In some embodiments, in addition to the map, the summary screen may provide the participant with a summery of their progress in the configuration. This progress may be completely in the context of the game play elements and may include their score and the number of tiles they have collapsed or cleared. A participant may also see a list of achievements they have met in the configuration, e.g., in the form of a list of no more then three icons with titles that explain the significance of the achievement.

The participant may receive additional bonus points for each gold coin (correct trial) and treasure they have received or earned. These may be animated from the side menu bar into a container on the summary screen, and the points may accumulate as the coins and treasures hit their target. Point advancement may be accompanied with a sound, e.g., a “ding”.

In one embodiment, all of this information may be stored in a “book” in the middle of the map. The participant may be able to click back and forward buttons to review their progress in different configurations. Each page may have a small icon in the upper left hand corner that indicates which game level the information represents. So for example if the participant is in the Oceania game level and they flip back to the Mayan game level the icon in the upper left hand corner may change to reflect the game level they are viewing.

Additionally, when a participant is flipping though the pages and crosses over from one game level to the next they may see a full page map that contextualizes the information they are about to see. So, for example, if the participant is flipping forward in the book and they leave the Mayan level to enter the Oceania level they may see the map associated with Oceania. If, on the other hand, they are flipping backwards in the book and move from Oceania to the Mayan level then they may see a full page map of the Mayan world before they see the information for the Mayan world.

In one embodiment, the bottom of the map may include a button marked “Continue” (or equivalent). Upon pressing this button, if the participant still has time left in the configuration they may be taken to the next stimulus configuration. If on the other hand there is no more time in the configuration the participant may be presented with a message indicating that the time for the configuration has elapsed or expired.

If the participant is in the final configuration for the game level, the words “completed” (or equivalent) may be displayed on the screen (possibly animated) after all of the points have been added up. Particle effects (or other effects) may highlight each of the milestones markers on the map and the text on the continue buttons may change to “advance to next level” (or equivalent). The participant may be able to review their progress in the configuration summery book before they continue on to the next level, as described above. In some embodiments, special messaging may be presented in or around the final screen of the exercise that explains what the participants options are for continuing the exercise.

Thus, in some embodiments, the visual sweep exercise may be included as part of a game, such as the block and tile matching games described above, although it should be noted that in other embodiments, other games may be used as desired.

Visual Emphasis

Age-related changes cause neural systems to respond more slowly and less robustly to preferred visual stimuli than they once did. In large part these changes are due to plastic reorganization of network properties that are locally adaptive, resulting in relatively unimpaired performance under a limited and specific range of environmental stimulation encountered by the aging organism. However, these changes are generally globally maladaptive, with simple task performance, such as central foveal detection, being relatively maintained at the cost of more complex and challenging visual tasks, such as peripheral object identification.

In order to renormalize visual processing in a global sense, the efficiency of mechanisms involved in complex, speeded task performance must be improved. In order to drive positive plasticity in these systems to improve their speed, accuracy, and overall function, slow and poorly tuned neurons and neural networks need to be strongly and coherently activated in the initial phases of training in a fashion that will engage these plastic mechanisms in a robust manner. In the context of adaptive visual training, i.e., training with visual stimuli, this effect can be elicited by initially strongly “emphasizing” the visual scene. As used herein, the term “visual emphasis” generally refers to creation of a combination of a target stimulus and background stimulus, where one or both stimuli have been individually modified to have visual properties specifically chosen to drive cortical neurons strongly and coherently, and whose combination is specifically chosen to further enhance the overall configuration's ability to drive cortical neurons strongly and coherently. In other words, visual emphasis refers to image modification or manipulation that serves to increase the distinguishability of foreground objects, e.g., with respect to the background. Embodiments of the visual emphasis techniques described below are specifically designed to engage these neural mechanisms in a fashion that will robustly engage them and drive positive brain plasticity that leads to faster, more finely tuned processing.

There are several aspects or dimensions along which stimuli may be manipulated to create the emphasis levels. Some dimensions may be described with respect to the objects of interest in a scene, i.e., foreground objects, some with respect to the background of a scene, and some with respect to object/background relations. In some embodiments, the manipulations described herein may occur at two levels; the first level being the a priori level of stimulus selection and artistic design. In other words, the stimuli may be illustrated, animated or selected based on the principles described herein. The second level is the post hoc level of post-processing manipulations. Each manipulation may map to a corresponding image-processing algorithm. Commercially available programs such as Photoshop®, provided by Adobe Systems Incorporated, implement many of these algorithms. Moreover, many of these algorithms may be implemented using image processing packages such as those available in Matlab®, provided by The MathWorks. Of course, any other means for performing the image processing or manipulations described herein may be used as desired. Note that the appropriate application of visual emphasis manipulations may depend on the visual task. Not all dimensions of emphasis may apply in all cases.

Below are described exemplary aspects of visual stimuli that may be manipulated for visual emphasis. It should be noted, however, that the aspects listed are meant to be exemplary only, and are not intended to limit the visual aspects used for visual emphasis to any particular set or type of visual attributes.

Foreground Objects

The following visual attributes or aspects relate to foreground objects in a scene, i.e., objects of interest.

Spatial frequency: As used herein, and as is well known to those of skill in the imaging arts, “spatial frequency” refers to the level of graphical detail or sharpness of an image. An object that has been manipulated to have a relatively large proportion of high spatial frequency information is said to be sharpened. When the converse manipulation is made, i.e., increasing the relative amount of low spatial frequency information, the object is said to be blurred. Thus, at high levels of visual emphasis, objects may be sharpened. The increased high-spatial frequency information may strongly activate neural mechanisms in the cortex that are under-stimulated, while creating a salient contrast from the background. In other words, the object may become more distinct with respect to the background. Conversely, as the visual emphasis is decreased to low levels, the objects may become somewhat blurred, creating a more photo-realistic effect by simulating natural atmospheric scattering and optical defocus, and reducing the spatial frequency gradient cue to object/background segregation. In other words, the object may become less distinct with respect to the background.

Internal luminance contrast: As used herein, “luminance contrast” refers to the range of luminance or brightness values of pixels in an image. Stimuli with a high degree of overall (e.g., root-mean-squared) internal luminance contrast may drive impaired visual processors more strongly than stimuli with low internal luminance contrast. Neural mechanisms that are impaired or poorly tuned may be activated by high luminance contrast stimuli to the same degree that normally functioning neural mechanisms are activated by low to medium luminance contrast stimuli. This strong engagement may drive differential responses in mechanisms tuned to the relevant stimulus dimension in the object. At the high levels of emphasis, the internal luminance contrast may be made artificially high by increasing the root-mean-squared luminance contrast of the object. At lower levels, luminance contrast may be reduced, e.g., slightly below the nominal baseline level for the object.

Internal chromatic contrast: As used herein, chromatic or color contrast refers to the range of color or hue saturation values of pixels in an image. Visual cortical neurons are tuned to chromatic contrast as well as luminance contrast, and so increasing the chromatic contrast internal to the object may engage a partially overlapping distribution of neural mechanisms to those preferentially affected by increasing internal luminance contrast. Moreover, the effect of increasing both luminance contrast (see above) and chromatic contrast simultaneously is synergistic. At high levels of visual emphasis, the internal chromatic contrast may be made artificially high by increasing the root-mean-squared chromatic contrast of the object. At lower levels of visual emphasis, chromatic contrast may be reduced, e.g., to slightly below the nominal baseline level for the object.

Background

The following visual attributes or aspects relate to a background in a scene. Note that since visual emphasis refers to increasing the visual distinction or distinguishability of foreground objects with respect to backgrounds, foreground and background operations for visual emphasis may be conversely related, since increasing a background attribute may have substantially the same distinguishing effect as decreasing the foreground attribute, and vice versa.

Spatial frequency: At high levels of emphasis (for the scene), the low spatial frequency content of the background may be increased relative to the high spatial frequency content (i.e., the background may be blurred), thus making the foreground object(s) appear sharper in contrast. Conversely, as the visual emphasis level is decreased, the blurring of the background may be reduced until, at the final stage, no spatial frequency manipulation is performed.

Internal luminance contrast: At high levels of visual emphasis, the luminance contrast of the background elements may reduced, thereby making the foreground object(s) appear to have more luminance contrast in contrast to the background. At low levels of visual emphasis, the luminance contrast of the background may be increased until, by the final level, the luminance contrast may be set at a naturalistic level, i.e., no modification.

Internal chromatic contrast: At the high levels of emphasis, the chromatic contrast of the background elements may be reduced. At low levels of visual emphasis, the chromatic contrast may be increased until, by the final level, the chromatic contrast is set at a naturalistic level.

Structure: Units in the visual cortex respond most robustly to stimuli presented against plain, artificially unstructured backgrounds. In contrast, stimuli presented against “natural scene” backgrounds generally result in relatively attenuated responses. To create a very salient stimulus that may drive strong visual cortical responses, an unstructured background may be superior. Thus, at the high levels of visual emphasis, the background may be quite plain, i.e., with few structured distracting elements. At low levels of visual emphasis, the background may become more complex, where at the final level of visual emphasis, the background may be a visually rich, complex background environment.

Object-Background Relation

The following visual aspects or attributes relate to the visual relationship between foreground object(s) and background of a scene, and may be set, adjusted, or modified to achieve a specified visual emphasis.

Luminance contrast between object and background: An impaired visual processor may respond most robustly to an object stimulus that is quite distinct from its background, e.g., along the most basic visual dimensions. A fundamental or primary visual dimension is the light intensity or luminance dimension. Scenes with high degrees of visual emphasis may thus involve objects that differ in luminance from their backgrounds. At low levels of emphasis, more typical luminance contrasts for the object(s) and background may be used.

Chromatic contrast between object and background: Another fundamental visual dimension is the chromatic, i.e., color or hue contrast dimension. High degrees of visual emphasis may involve scenes that contain objects that differ in chromaticity (hue or color) from their backgrounds. Low levels of emphasis may involve more typical chromatic contrasts between the objects and their backgrounds.

Motion/dynamic contrast between object and background: One of the most dramatic methods for creating a salient contrast between an object and its background is to effect relative motion or other dynamic contrast (e.g., flashing or flickering) between the object and its background. High degrees of visual emphasis may involve objects that move in a different direction or at a different velocity from background elements, or that flash or flicker with respect to the background, among other dynamic contrast effects. At low levels of emphasis, the objects may be slow moving or static, or may flash or flicker slightly or slowly, among other dynamic contrast effects.

Texture contrast between object and background: Regular patterns may be an important cue to object segregation. When these patterns are consistent and continuous with the background, the effect is known as camouflage. In this camouflaged state, an impaired visual processor may be challenged to represent an object in a salient fashion. Thus, high visual emphasis may be achieved by utilizing a great deal of texture contrast between the object and its background. Similarly, low visual emphasis may be achieved by utilizing a lesser texture contrast between the object and its background.

Object/background opacity: Opacity refers to the degree to which an object or image is opaque or non-transparent. Thus, at high levels of visual emphasis, the object may be presented on or in a (graphical) layer entirely above the background, resulting in a very sharp, high-contrast border between object and background, thus driving strong responses even in an impaired visual processor. At lower levels of emphasis, the object may be given some transparency or presented in a partially occluded fashion behind background elements.

Object size: An object (e.g., a foreground object) in a scene may be made more noticeable or obvious by increasing the size of the object, e.g., with respect to the background, elements in the background, or the visual field. Thus, at high levels of visual emphasis, the object may be larger, while at low levels of visual emphasis, the object may be smaller. Note that in some embodiments, in addition to, or instead of, such size modification of the foreground object(s) in a scene, the background may be modified by decreasing the size of features in the background. In other words, the background, or features of the background, may be shrunk (or magnified), thereby increasing (or decreasing) the relative size of the foreground object(s) with respect to the background (features). Thus, for example, in an abstract scene where a square (foreground object) is displayed in a background of many circular dots, the dots may be reduced or magnified in size to change the relative size of the square. Either technique may serve to emphasize or enhance the distinction between the object and the background.

Cognitive Training Exercise with Visual Emphasis

Below are described various embodiments of a cognitive training exercise that utilizes visual emphasis to improve cognition, specifically, to improve visual processing in a participant, e.g., an aging adult. More specifically, embodiments of an exercise are presented to improve the ability of the participant to process visual information in a scene presented by a computing device. Said another way, embodiments of the computer-based exercise described herein may operate to renormalize and improve the ability of the visual nervous system of a participant to perceive and process elements in a visual scene.

In one exemplary embodiment, the exercise may include a specified number of stages of emphasis (e.g., 5), beginning initially with the highest degree of visual emphasis and ending at a naturalistic and un-emphasized visual stimulus arrangement. This approach may strongly engage positive plasticity to reorganize information processing in the visual/cognitive systems of individuals with initially poor visual processors. Additionally, embodiments of this visual emphasis approach may move an otherwise very challenging task into a performance range accessible by a person with an impaired visual processor in order to allow them to engage with the task and benefit from the training.

It should be noted that various embodiments of the tasks described herein, or other visual stimulus tasks, may be used singly or in combination in the exercise. Moreover, as described below, in some embodiments, stimulus threshold assessments may also be performed in conjunction with, or as part of, the exercise, thus facilitating more effective training of the participant's visual processing system.

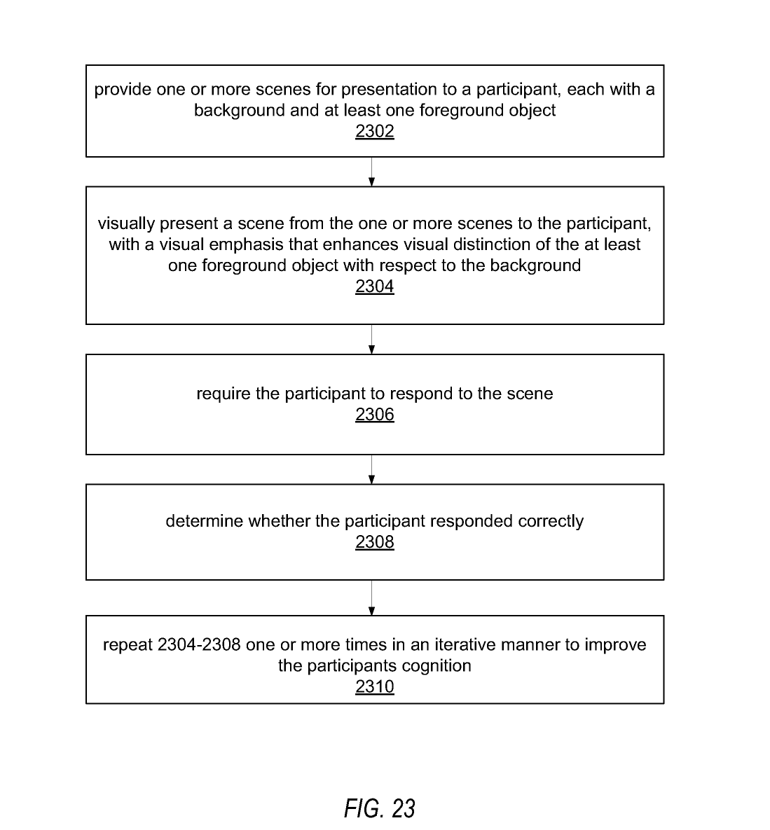

FIG. 23—Flowchart of a Method for Cognitive Training Using Visual Emphasis

FIG. 23 is a high-level flowchart of one embodiment of a method for cognitive training using visual emphasis. More specifically, the method utilizes a computing device to present a scene, including at least one foreground object and a background, where the at least one foreground object and/or the background has been modified to visually emphasize the foreground object(s) with respect to the background, and to record responses from the participant. The method may be used in the context of any of a variety of cognitive training exercises using visual stimuli. It should be noted that in various embodiments, some of the method elements may be performed concurrently, in a different order than shown, or may be omitted. Additional method elements may also be performed as desired. As shown, the method may be performed as follows:

In 2302, one or more scenes, each having a background and at least one foreground object, may be provided, where the one or more scenes are available for visual presentation to the participant. For example, the scenes may be stored on a memory medium of the computing device, on a memory medium coupled to the computing device, e.g., over a network, etc. The scenes may be stored as complete scenes, or in separate parts, in separate parts, e.g., backgrounds and foreground objects, and assembled as needed, e.g., for visual presentation to the participant, described below. Note that the backgrounds and foreground objects may be of any type desired, i.e., may have a wide range of complexity, subject matter, and so forth. For example, in some scenes, the background may be a blank visual field, while in others the background may be visually rich in detail, color, etc. Similarly, the at least one foreground object may be singular, or may include a plurality of foreground objects, of any level of complexity desired. For example, foreground objects included in the scenes may include simple objects, e.g., geometrical objects, such as circles, squares, etc., of various colors, sizes, and so forth, or more complex objects, such as images of people, faces, animals, plants, products, machines, buildings, or other structures, among others. In other words, the scenes may include images of any type desired.

In 2304, a scene from the one or more scenes may be visually presented to the participant with a specified visual emphasis that visually distinguishes the at least one foreground object with respect to the background. Said another way, visually presenting the scene may include visually presenting the at least one foreground object and/or the background with a specified visual emphasis that visually distinguishes the foreground object(s) with respect to the background. This visual emphasis may facilitate easier perception by the participant of the foreground object(s) against the background.

In some embodiments, this visually presenting with visual emphasis may include modifying the visual emphasis of the at least one foreground object and/or the background to achieve the specified visual emphasis. In other words, the at least one foreground object and/or the background may be graphically processed, such as described above in detail, to emphasize or enhance visual distinction between the foreground object(s) and the background. Thus, for example, some standard image (i.e., foreground object(s) and/or background) may be manipulated or processed “on demand” to achieve the specified visual emphasis.

In other embodiments, the visually presenting with visual emphasis may include selecting the at least one foreground object and/or the background in accordance with the specified visual emphasis to enhance visual distinction of the at least one foreground object with respect to the background. In other words, the at least one foreground object and/or the background may be selected from a set or collection of foreground objects and/or backgrounds that includes foreground objects and/or backgrounds of varying visual emphasis, where the at least one foreground object and/or the background are selected based on the desired or specified degree of visual emphasis. In some embodiments, the set or collection of foreground objects and/or backgrounds may be created by modifying one or more basis or standard foreground objects and/or backgrounds, e.g., according to one or more of the visual emphasis techniques described below, and/or by accumulating or collecting images that happen to include the various levels of visual emphasis.

This distinguishability of foreground object(s) with respect to the background of a scene may be referred to as the salience of the foreground object(s). Said another way, the visual emphasis techniques described herein may operate to make foreground objects more noticeable or obvious to the participant.

As described above, there are a variety of ways the foreground object(s) and/or the background may be modified to visually emphasize the distinctions between them, e.g., to effect visual emphasis for the scene. For example, in various embodiments, the specified visual emphasis may specify one or more of: luminance contrast of the at least one foreground object and/or the background, chromatic contrast of the at least one foreground object and/or the background, spatial frequency of the at least one foreground object and/or the background, size of the at least one foreground object and/or features in the background, flashing the at least one foreground object, moving the at least one foreground object with respect to the background, texture of the at least one foreground object and/or the background, opacity of the at least one foreground object and/or the background, distance of the at least one foreground object from one or more other foreground objects and/or one or more features of the background, and/or distracting effects of one or more features in the background., among others. In other words, any of the above effects, including any combination of them, may be increased (or decreased) to achieve a specified visual emphasis for the scene.

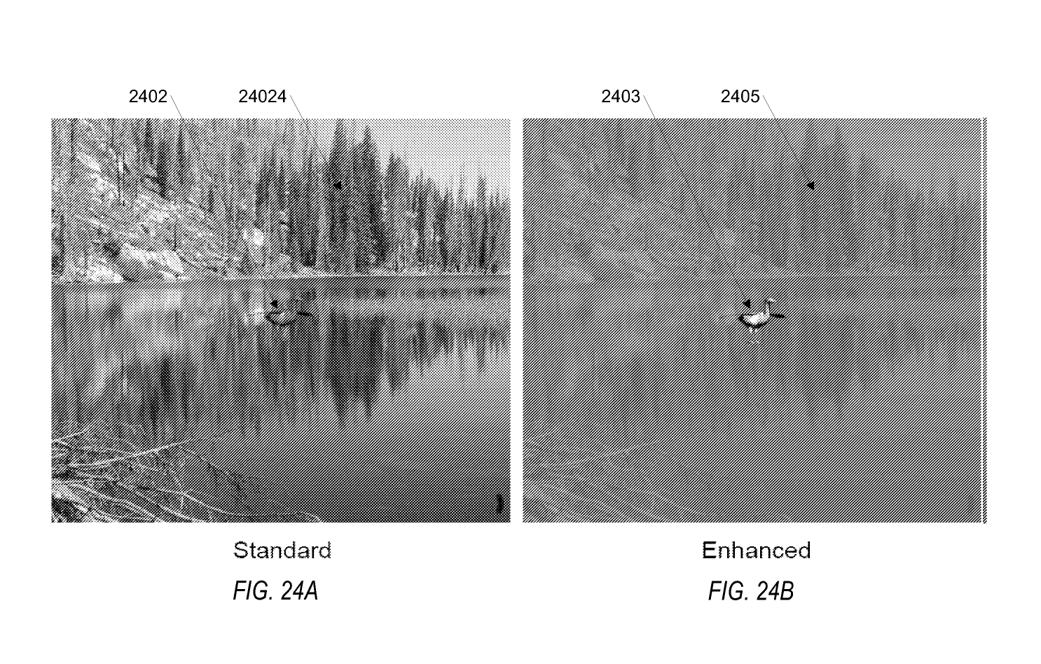

FIGS. 24A/24B, 25A/25B, 26A/26B, 27A/27B, 28A/28B, and 29A/29 respectively illustrate pairs (“A” and “B” figures) of exemplary screenshots demonstrating specific ways of modifying a scene for visual emphasis, where the first figure of each pair (the “A” figure) presents the scene with no modification, and the second figure of each pair (the “B” figure) illustrates the same scene, but with modification for visual emphasis. As may be seen, in FIG. 24A (and each of the other “A” figures), a foreground object 2402, specifically, a duck, is displayed against a background 2404, in this case, a lake with surrounding trees, where neither the foreground object 2402 nor the background has been modified. Note that the duck is somewhat difficult to perceive against the complex background of the scene. Note further that the scene shown in these figures is meant to be exemplary only, and that any other scenes may be used as desired. Since each of the “A” figures is the same, only the “B” figures are described in detail below, the multiple “A” figures only being included for easy comparison with the “B” figures. Moreover, note that the following figures illustrate only a subset of the various visual emphasis techniques described above.

FIGS. 24A and 24B are exemplary screenshots of above-described scene, where FIG. 24A shows the scene with no visual emphasis, and FIG. 24B shows the scene with modified luminance contrast, specifically, a modified foreground object 2403 (duck) and a modified background 4205 (wooded lake), where the foreground object 2403 is a version of the foreground object 2402 of FIG. 24A, but with increased luminance contrast. Note the darker edges and brighter interior of the image of the duck 2402. Similarly, the background 2405 is a version of the background of FIG. 24A, but with decreased luminance contrast. Note the relative lack of luminance contrast in the background of FIG. 24B. Thus, the luminance contrast of the foreground object has been enhanced, and that of the background diminished, thereby increasing the visibility of the foreground object 2403 with respect to the background 2405. Note that were the visual emphasis, i.e., the distinguishability of the foreground object with respect to the background, to be decreased instead, the luminance contrast of the foreground object would be decreased, and/or that of the background increased.

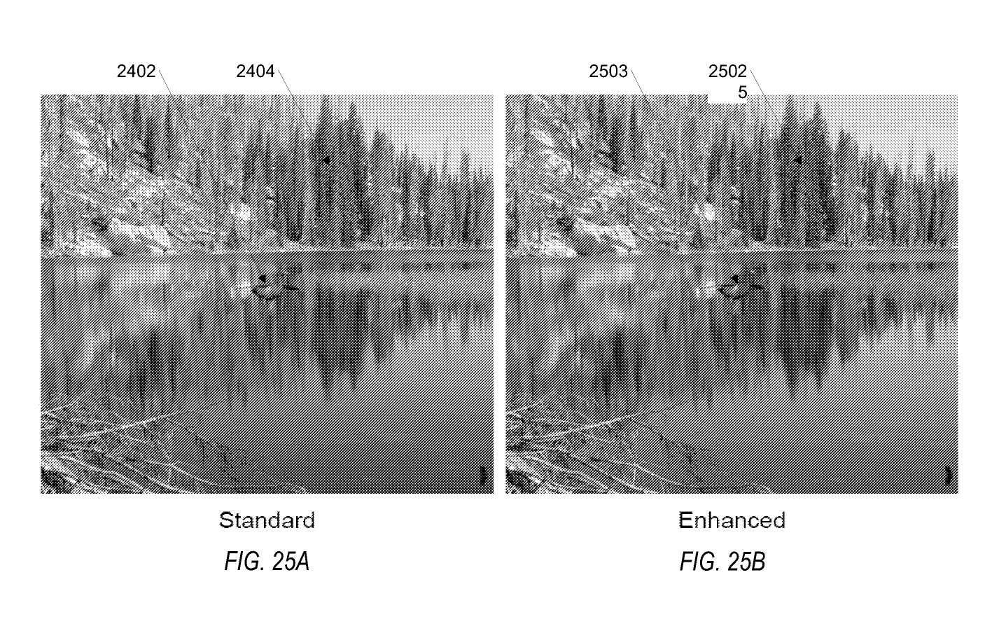

FIGS. 25A and 25B are exemplary screenshots of the scene of FIGS. 24A and 24B, but where FIG. 25A shows the scene with no visual emphasis Oust like FIG. 24A), and FIG. 25B shows the scene with modified chromatic or color contrast, specifically, with a modified foreground object 2503 and a modified background 2505, where, in this example, the foreground object 2503 is a version of the foreground object 2402 of FIG. 25A (and FIG. 24A), but with increased chromatic contrast. Note the increased color saturation of the duck's head and breast in FIG. 25B as compared to FIG. 25A.

Similarly, the background 2505 is a version of the background of FIG. 25A (and FIG. 24A), but with decreased chromatic or color contrast. Note the relative lack of chromatic or color contrast of the background of FIG. 25B as compared to FIG. 25A. Thus, the chromatic (color) contrast of the foreground object has been enhanced, and that of the background diminished, thereby increasing the visibility of the foreground object 2503 with respect to the background 2505. As with the above modifications, were the distinguishability of the foreground object with respect to the background to be decreased instead, the chromatic or color contrast of the foreground object would be decreased, and/or that of the background increased.

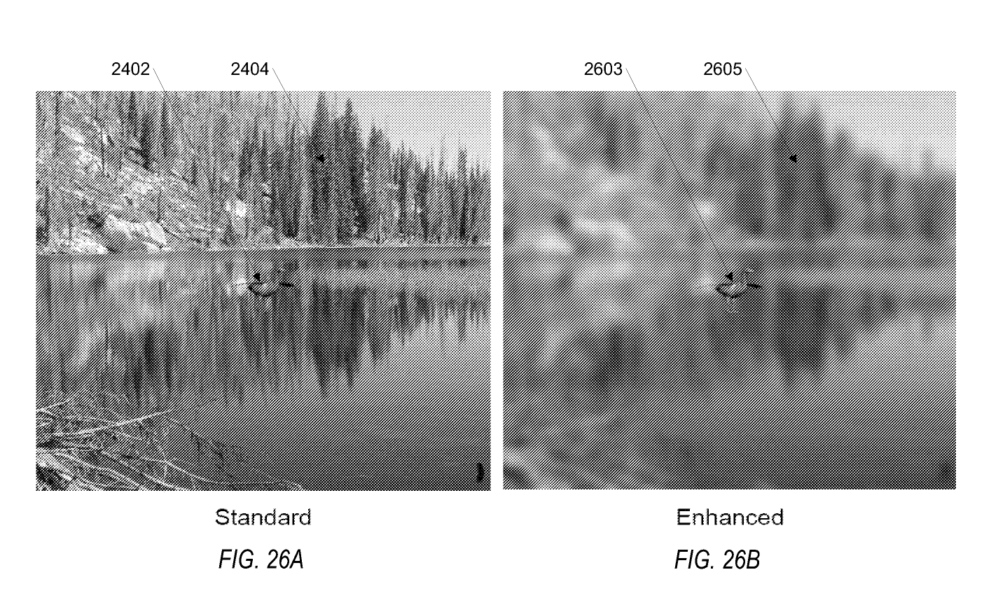

FIGS. 26A and 26B are exemplary screenshots of the scene, where, as with each of the other “A” figures, FIG. 26A shows the scene with no visual emphasis, and FIG. 26B shows the scene with modified spatial frequency, specifically, where the foreground object 2603 is a version of the foreground object 2402 of FIG. 26A, but with increased spatial frequency. Note the increased sharpness of the duck in FIG. 26B as compared to FIG. 26A. Similarly, the background 2605 is a version of the background of FIG. 26A (and each of the other “A” figures), but with decreased spatial frequency. In other words, the background has been filtered to reduce high spatial frequency components-note the relative blurring of the background of FIG. 26B as compared to FIG. 26A. Thus, the spatial frequency of the foreground object has been enhanced, and that of the background diminished, thereby increasing the visibility of the foreground object 2603 with respect to the background 2605. Of course, as above, were the visual emphasis or distinguishability of the foreground object with respect to the background to be decreased instead, the spatial frequency of the foreground object would be decreased, and/or that of the background increased.

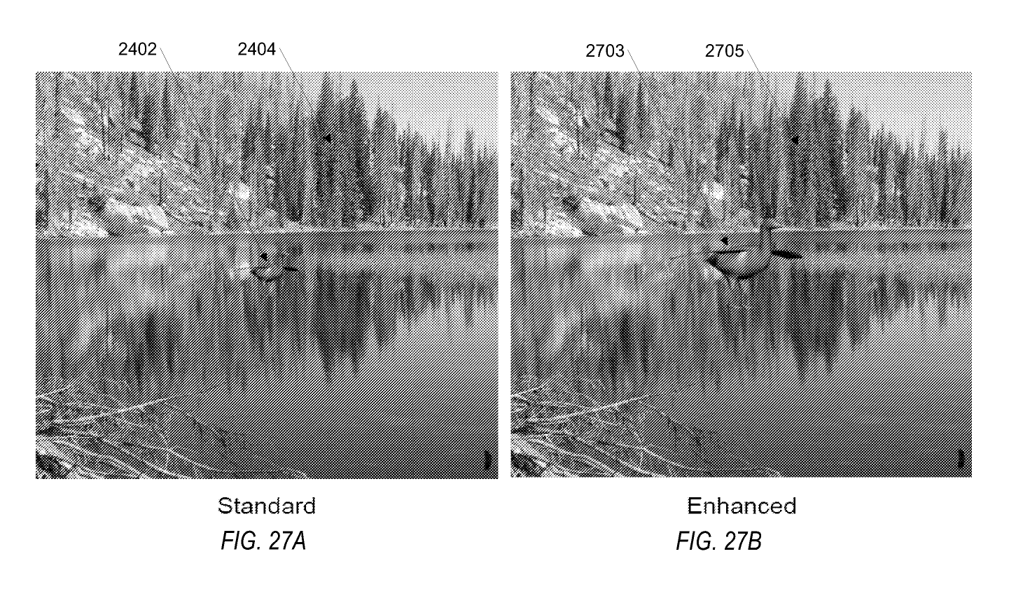

FIGS. 27A and 27B are exemplary screenshots of the scene, where, as with each of the other “A” figures, FIG. 27A shows the scene with no visual emphasis, and FIG. 27B shows the scene, but where the foreground object 2703 (the duck) is larger, i.e., has increased size, as compared to FIG. 27A. Thus, the size of the foreground object has been increased, thereby increasing the visibility of the foreground object 2703 with respect to the background 2705. Of course, making the foreground object 2703 smaller would decrease its distinguishability with respect to the background 2705, i.e., would decrease the visual emphasis of the scene.

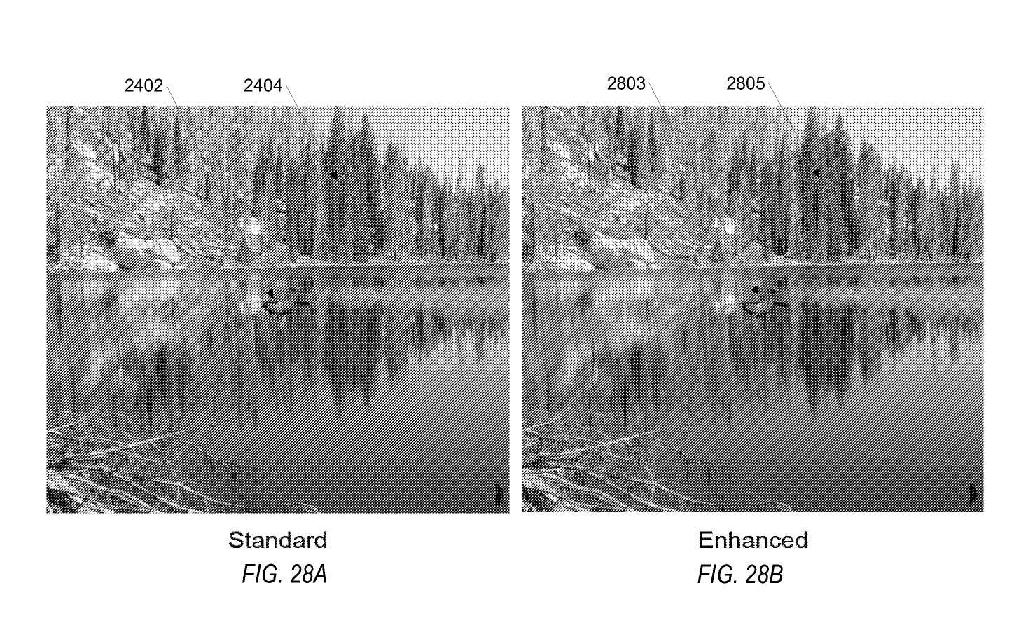

FIGS. 28A and 28B are exemplary screenshots of the scene, where, as with each of the other “A” figures, FIG. 28A shows the scene with no visual emphasis, and FIG. 28B shows the scene, but where the foreground object 2803 (the duck) is flashed or flickered, e.g., at some specified frequency, as compared to FIG. 28A. In other words, the foreground object is shown, then removed from view, shown again, removed, and so on in an iterative manner at some frequency, thereby calling the participant's attention to the object. Note that while such flashing cannot be shown in a static image such as FIG. 28B, the reader may imagine the duck 2803 flashing, flickering, or blinking on and off. Such flashing of foreground objects may increase the ease with which the participant notices or perceives the foreground objects.

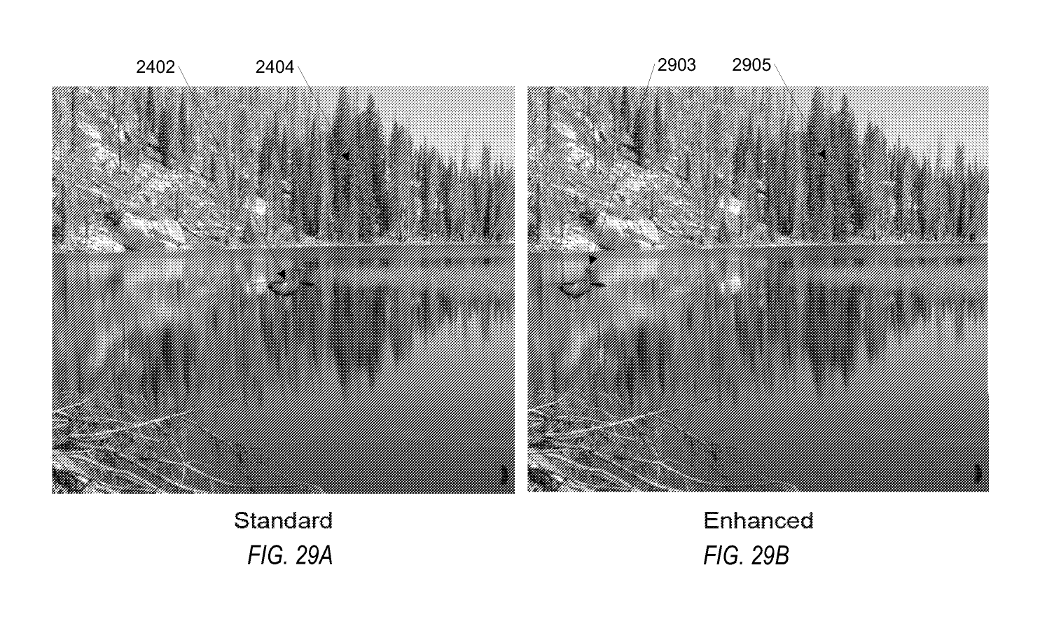

As noted above, in some embodiments, visual emphasis may include moving the at least one foreground object with respect to the background to emphasize or enhance the distinction between them. FIGS. 29A and 29B are exemplary screenshots of the scene, where, as with each of the other “A” figures, FIG. 29A shows the scene with no visual emphasis, and FIG. 29B shows the scene, but where the foreground object 2903 (the duck) is moved, e.g., at some specified speed, across the background, as compared to the static foreground object of FIG. 29A. In other words, the foreground object is incrementally moved at some speed with respect to the background, thereby calling the participant's attention to the object. Note that while such movement cannot be shown in a static image such as FIG. 29B, the reader may imagine the duck 2903 in motion across the scene. As with the above flashing, such movement of foreground objects may increase the ease with which the participant notices or perceives the foreground objects.

Of course, other means of enhancing visual emphasis or distinction of the foreground object(s) with respect to the background of a scene may be used as desired. As another example, visual emphasis may include distance of the at least one foreground object from one or more other foreground objects and/or one or more features of the background. In other words, foreground objects and/or background features may be positioned in such a way as to make the foreground object(s) more noticeable, e.g., by placing the at least one foreground object a greater distance from other objects in the scene. For example, in the duck/lake scene described herein, the duck may be displayed against the blue sky (upper right corner of the image) to increase its salience, or against the trees to decrease its salience. As another example, some of the background features, such as trees, could be moved or positioned to make a clearing surrounding the duck, thereby increasing its noticeability or salience. As a further example, in some embodiments, visual emphasis may include reducing distracting effects of one or more features in the background. For example, if there are features or objects in the background that are confusable with the foreground object(s), these features or objects may be modified to decrease the confusability, e.g., by removing or replacing the features or objects from the scene, changing their coloration, or otherwise making them less noticeable to the participant. As one example, in a scene where a duck is displayed against a background that includes many other, different, birds, the background birds may be replaced with some other animals, e.g., squirrels. Note that the above techniques are meant to be exemplary only, and that other approaches for visual emphasis may be used as desired.

Note further that in some embodiments, two or more the above-described modifications, among others, may be made in conjunction. In other words, in various embodiments, any of the various visual emphasis techniques may be used singly or in combination to enhance or emphasize visual distinction of the foreground object(s) with respect to the background.

In 2306, the participant may be required to respond to the scene. For example, in various embodiments, the participant may be required to respond based on information gleaned from foreground objects in the scene, and/or features in the background, e.g., depending on the particular cognitive exercise being performed. In various embodiments, the participant may respond to the scene in any of a variety of ways, including, for example, clicking on objects in the scene with a mouse, clicking on icons or buttons in a graphical user interface (GUI) (possibly within which the scene is displayed), clicking on specified regions in the visual field, pressing keys on a keyboard coupled to the computing device, using voice recognition to enter responses, responding via a touch screen, e.g., by touching objects in the scene, buttons in the GUI, etc., among others. Of course, the particular response required of the participant may depend upon the specific cognitive training being performed, e.g., may depend on the specific cognitive training exercise being performed. Note that in various embodiments, any means for responding to the scene may be used as desired, the above being exemplary only.

In 2308, a determination may be made as to whether the participant responded correctly. The response, and/or the correctness/incorrectness of the response, may be recorded. In some embodiments, an indication, e.g., a graphical and/or audible indication, may be provided to the participant indicating the correctness or incorrectness of the participant's response, e.g., a “ding” or a “thunk” may be played to indicate correctness or incorrectness, respectively, and/or points may be awarded (in the case of a correct response). Of course, any other type of indication may be used as desired, e.g., graphical images, animation, etc.

The above visually presenting, requiring, determining, may compose a trial in the exercise or task.

In 2310, the visually presenting, requiring, and determining may be repeated one or more times in an iterative manner to improve the participant's cognition and visual processing skills. In other words, a plurality of trials may be performed as described above, preferably using a plurality of different scenes, although multiple trials may certainly be directed to a scene as desired. In some embodiments, multiple trials may be performed under each of a plurality of conditions, e.g., using different types of scenes, with scenes visually presented with different visual emphasis, for different durations, and so forth.

In some embodiments, the specified visual emphasis may be modified based on the determining, e.g., based on whether or not the participant responded correctly a specified number of times (e.g., 1, 10, 40, etc.). Similar to above, modifying the specified visual emphasis may include one or more of: modifying the visual emphasis of the at least one foreground object and/or the background to modify the visual emphasis, and/or selecting a different at least one foreground object and/or a different background for the scene to modify the visual emphasis.

Thus, the repeating of 2310 may include adjusting or modifying the (amount or degree of) visual emphasis based on the determining. In some embodiments, for any given visual emphasis technique described herein, the amount of the modification may be adjusted based on the participant's performance. Thus, for example, using the size modification of a foreground object as an example, if the participant responds correctly for some specified number of trials, the size of the foreground object may be decreased for the next trial. Conversely, in one embodiment, if the participant responds incorrectly some specified number of trials, then the size of the foreground object may be increased. As noted above, the specified numbers (of times) may be different for correct and incorrect responses. Thus, modifying the visual emphasis may include adjusting the degree of visual emphasis based on any of the above visual emphasis techniques, e.g., increasing or decreasing the amount of any particular technique(s).

More generally, modifying the specified visual emphasis may include adjusting the degree of visual emphasis (of the scene) according to one or more visual emphasis techniques. As noted above, visual emphasis is directed to distinguishability of foreground objects against backgrounds, and so there are a number of ways the visual emphasis of a scene may be modified, given access to one or more visual emphasis techniques. As discussed above, each of the one or more visual emphasis techniques specifies a corresponding attribute (e.g., spatial frequency, luminosity contrast, chromatic contrast, etc, described above).

In situations where adjusting the degree of visual emphasis includes increasing the visual emphasis of the scene, increasing the visual emphasis of the scene may be accomplished in any of a variety of ways. For example, in one embodiment, visual emphasis may be increased by increasing the attribute for the at least one foreground object according to a first visual emphasis technique, e.g., sharpening the foreground object(s) by increasing the spatial frequency of the foreground object(s). As another example, visual emphasis may be increased by decreasing the attribute for the background according to a first visual emphasis technique, e.g., blurring the background by decreasing the spatial frequency of the background. As another example, visual emphasis may be increased by increasing the attribute for the at least one foreground object according to a first visual emphasis technique, e.g., sharpening the foreground object(s) by increasing the spatial frequency, and decreasing the attribute for the background according to the first visual emphasis technique, e.g., blurring the background by decreasing the spatial frequency of the background. As yet another example, visual emphasis may be increased by increasing the attribute for the at least one foreground object according to a first visual emphasis technique, e.g., sharpening the foreground object(s) by increasing spatial frequency, and decreasing the attribute for the background according to a second visual emphasis technique, e.g., darkening the background by decreasing luminosity, thereby increasing the luminosity contrast between the foreground object(s) and the background.

Conversely, in situations where adjusting the degree of visual emphasis includes decreasing the visual emphasis of the scene, decreasing the visual emphasis of the scene may be accomplished various ways. For example, in one embodiment, visual emphasis may be decreased by decreasing the attribute for the at least one foreground object according to a first visual emphasis technique, e.g., blurring the foreground object(s) by decreasing the spatial frequency of the foreground object(s). As another example, visual emphasis may be decreased by increasing the attribute for the background according to a first visual emphasis technique, e.g., sharpening the background by increasing the spatial frequency of the background. As another example, visual emphasis may be decreased by decreasing the attribute for the at least one foreground object according to a first visual emphasis technique, e.g., blurring the foreground object(s) by decreasing the spatial frequency, and increasing the attribute for the background according to the first visual emphasis technique, e.g., sharpening the background by increasing the spatial frequency of the background. As yet another example, visual emphasis may be decreased by decreasing the attribute for the at least one foreground object according to a first visual emphasis technique, e.g., blurring the foreground object(s) by decreasing spatial frequency, and increasing the attribute for the background according to a second visual emphasis technique, e.g., brightening the background by increasing luminosity, thereby decreasing the luminosity contrast between the foreground object(s) and the background.

Thus, the foreground object(s) and the backgrounds may be modified in various ways using different visual emphasis techniques, possibly in combination, to adjust the visual emphasis of a scene. It should be noted, however, that other combinations of visual emphasis techniques may be used with respect to foreground objects, background objects, or both, as desired.

As noted above, in various embodiments, the various visual emphasis techniques described above may be used singly or in conjunction. Thus, in addition to, or instead of, the above approach to modifying the visual emphasis, in embodiments where the at least one foreground object and/or the background are modified by (or selected in accordance with) one or more of the above visual emphasis techniques, modifying the visual emphasis, e.g., modifying visual aspects of foreground object(s) and/or the background, may include applying or using one or more additional or less of the techniques, based on the participant's response(s), e.g., to make trials easier or more difficult. Thus, for example, if the scene were presented with a specified visual emphasis based on luminance and chromatic contrast, then, based on the participant's response, the number and/or type of visual emphasis techniques applied to the scene may be changed. For example, to make trials easier, the visual emphasis may be increased, e.g., by further applying a spatial frequency emphasis, e.g., increasing the sharpness of the foreground object (in addition to the luminance and chromatic contrast) thereby making the stimulus (the scene) more easily perceived, and conversely, to increase the difficulty of trials, then the visual emphasis may be decreased, e.g., by removing one (or more) of the luminance contrast or chromatic contrast emphasis, thereby making the stimulus (the scene) more difficult to perceive. In other words, decreasing the visual emphasis may include ceasing to perform at least one of the one or more modification techniques, thereby making the next trial more difficult.

Described more specifically, in embodiments where modifying the visual emphasis includes modifying one or more of: luminance contrast of the at least one foreground object and/or the background, color contrast of the at least one foreground object and/or the background, spatial frequency of the at least one foreground object and/or the background, size of the at least one foreground object and/or features in the background, flashing the at least one foreground object, moving the at least one foreground object with respect to the background, texture of the at least one foreground object and/or the background, distance of the at least one foreground object from one or more other foreground objects and/or one or more features of the background, and/or distracting effects of one or more features in the background, increasing the visual emphasis may include increasing one or more others of the luminance contrast, color contrast, spatial frequency, size, flashing, moving, texture, distance, or distracting effects, thereby making the next trial less difficult, and decreasing the visual emphasis may include ceasing to modify at least one of the one or more of: luminance contrast, color contrast, spatial frequency, size, flashing, moving, texture, distance, or distracting effects, thereby increasing the difficulty of trials.

In yet another embodiment, the visual emphasis of the scene may be modified by exchanging or switching out an applied visual emphasis technique, e.g., color or chromatic contrast, with another visual emphasis technique, e.g., movement of the foreground object(s), with the presumption that various of the visual emphasis techniques described herein may differ in the perceptual effects they have with respect to the participant.

Thus, in some embodiments, the number of modification techniques brought to bear on the scene may change based on whether the visual emphasis is to be increased or decreased.

In preferred embodiments, the visual emphasis of the scene may be determined by the stage of training that a participant is in, which itself may be based on the number of trials the participant has performed correctly. For example, at the beginning of a training program, scenes may be presented with a high level of visual emphasis, i.e., with a specified high degree of one or more of the visual emphasis aspects or attributes described above (e.g., luminance or chromatic contrast, spatial frequency, size, etc.), to engage the participant, and to facilitate easier perception of foreground objects against backgrounds. As the participant progresses, the scenes may be presented with lower levels of visual emphasis.

For example, the degree of visual emphasis may be determined by the participant's cumulative success or progress in the exercise, e.g., beginning with high visual emphasis scenes, when the participant has responded correctly some specified number of times, i.e., has correctly performed the specified number of trials, the specified visual emphasis may be decreased. Thus, each time the participant has correctly responded the specified number of times (or possibly a different specified number of times as the exercise progresses), the specified visual emphasis may be decreased again, and so forth, until the scenes are substantially un-emphasized, or even de-emphasized. In other words, the repeating may include beginning with scenes of higher visual emphasis, and the method may further include decreasing the visual emphasis if the participant responds correctly a specified number of times, i.e., the visual emphasis levels may be changed (decreased) after a specified number of correct responses. In some embodiments, the specified number of times may be required to be consecutive rather than cumulative.

Thus, as the participant correctly performs increasing numbers of trials, the visual emphasis of the presented scenes may decrease. There may be a specified number of levels (e.g., 5), where the participant progresses through the levels from highest emphasis to lowest emphasis. In other words, the participant may progress through a plurality of levels, with each successive level specifying lower visual emphasis.

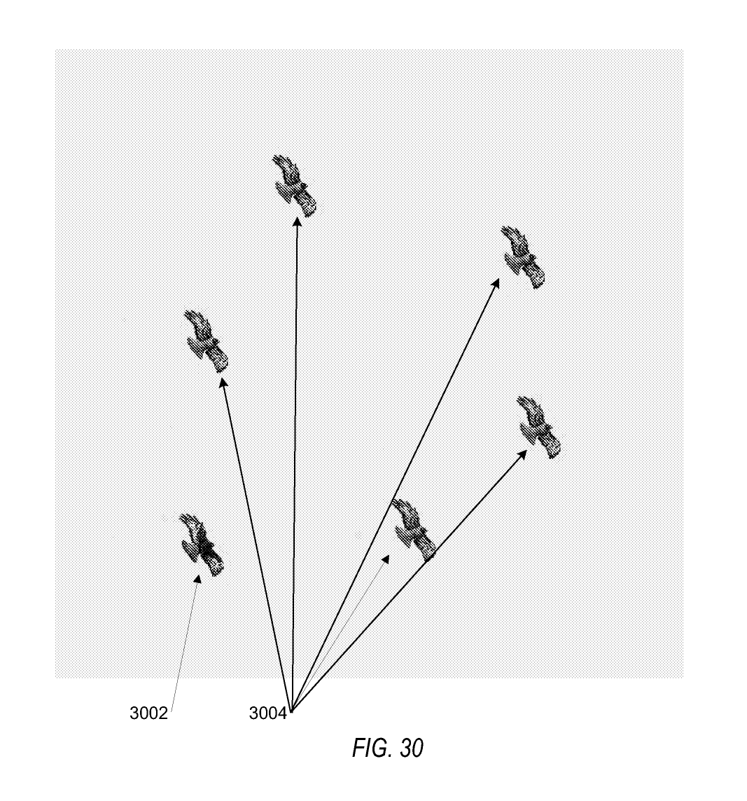

FIGS. 30-34 illustrate exemplary scenes at different levels of visual emphasis, specifically, at 5 different visual emphasis levels, although it should be noted that other numbers of levels may be used as desired.

FIG. 30 illustrates an exemplary level 1, high visual emphasis scene, where a target bird 3002 and a plurality of distracter birds 3004 are displayed against a light blue background. In this scene, the birds are sharpened, the color contrast is increased, and the luminance is reduced to create a large contrast from the light background. The unstructured background creates maximal spatial frequency and texture contrast between object and background. The target bird 3002 is the red tail morph hawk in the lower left corner. The other birds are identical illustrations of a red tail hawk. The birds are chosen based on their relative discriminability; however, this choice is not germane to the present discussion of visual emphasis.

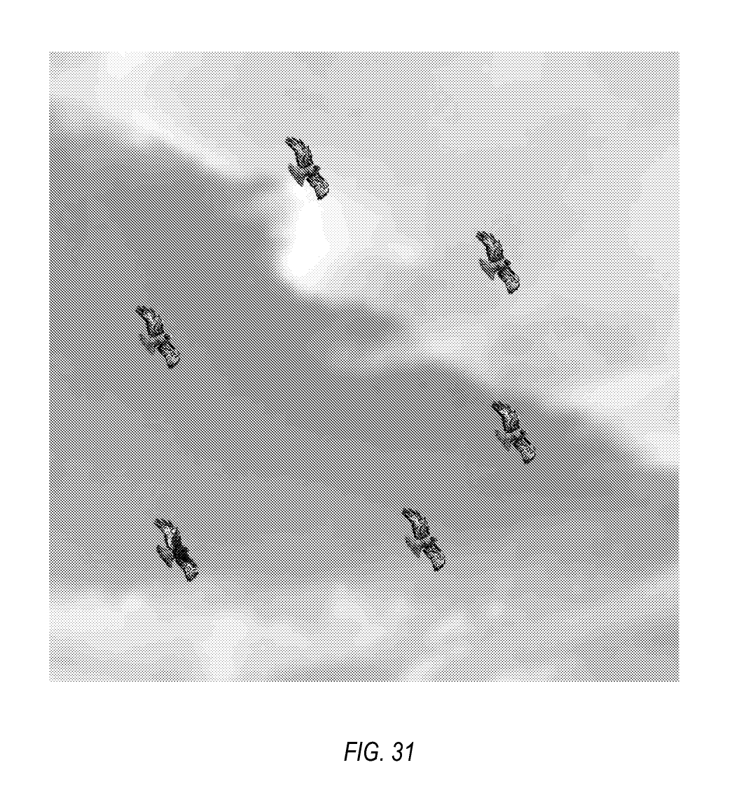

FIG. 31 illustrates an exemplary level 2, medium-high visual emphasis scene. The birds are the same as in the level 1 FIG. 30. However, in this scene, naturalistic background structure has been added, though blurred. The luminance and chromatic contrast of the background has also been modified and the blue parts of the sky are darker to be closer to the luminance of the birds. Thus, the birds are not quite as distinguishable from the background as those in FIG. 30.

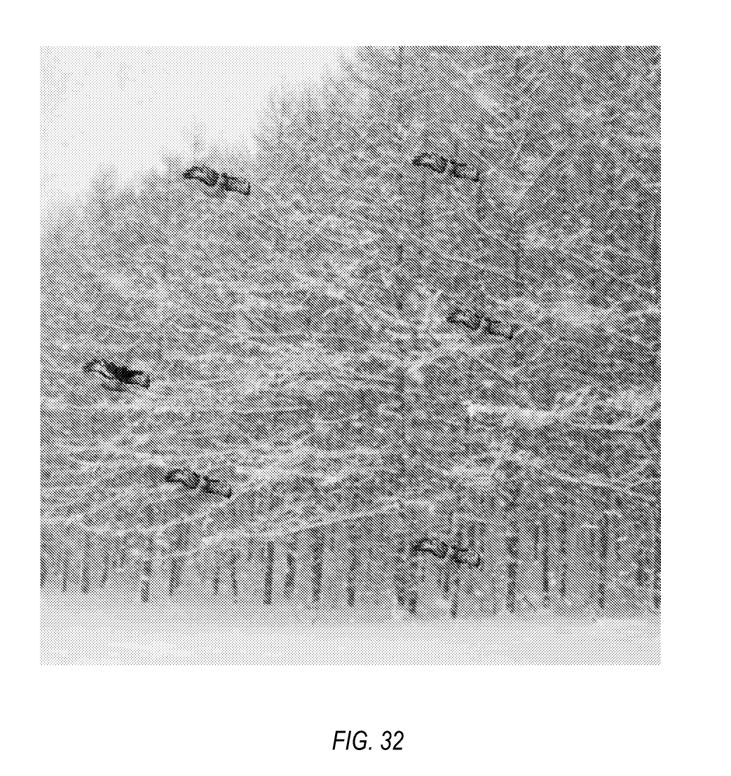

FIG. 32 illustrates and exemplary level 3, medium visual emphasis scene. In this scene, the birds are sharpened, the color contrast is increased, and the luminance is reduced to create a large contrast from the light background, athough each of these effects is applied significantly less than in level 1. Additionally, more textural, chromatic, and luminance contrast structure is added to the background, with a slight blurring. Note also that the complexity of the background has been increased. Thus, the birds of FIG. 32 may be somewhat less distinguishable from the background as compared to FIG. 31.

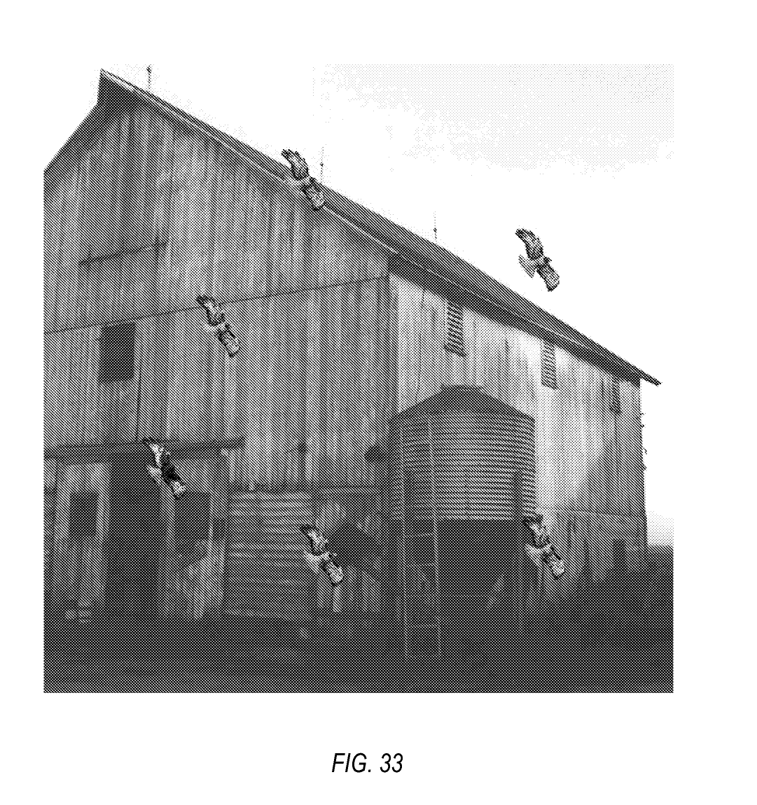

FIG. 33 illustrates an exemplary level 4, low visual emphasis scene. In this case, the birds presented are photo-realistic drawings mimicking the appearance of a canonical bird of each type, where the images are not altered or modified for visual emphasis. The background is based on a photograph of a barn, and is also unaltered. The internal spatial frequency content, color, luminance, color contrast, luminance contrast and texture of the background are quite similar to those of the foreground objects. This example thus represents a case that is close to a natural scene. However, without some blur and/or transparency in the foreground objects, there is an artificially large apparent plane difference (as though they are taken from different scenes), due in part to inconsistent lighting effects.

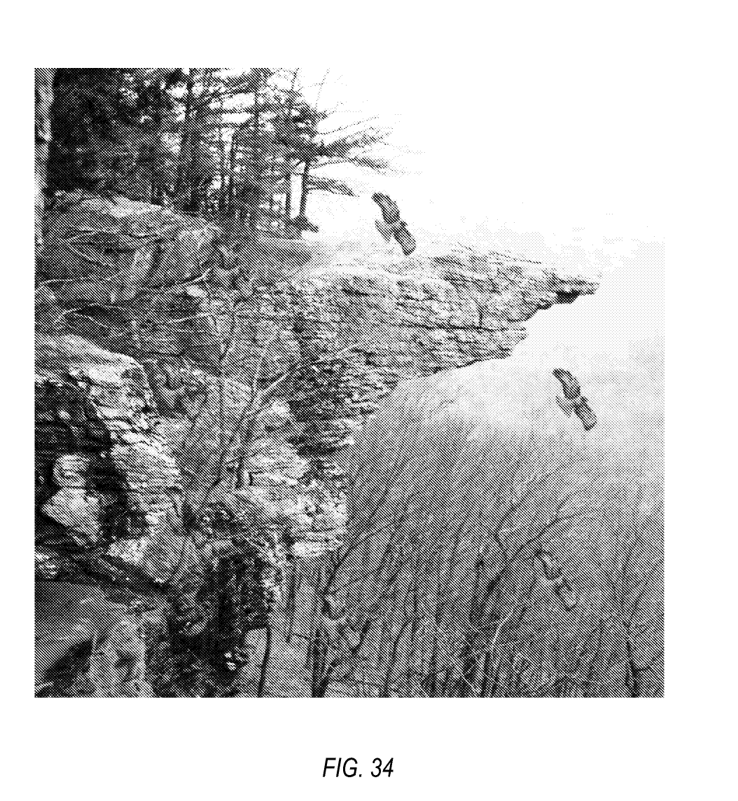

FIG. 34 illustrates an exemplary level 5, low visual emphasis scene. In this case, the birds are slightly blurred and some transparency is added to make the birds blend into the background. Also, the chromatic contrast and luminance contrast of the background is manipulated to be more similar to that of the birds. Thus, while the scene still represents a plausible natural scene, scene elements have been modified to decrease the distinguishability of the foreground objects from the background.

Thus, preferred embodiments of the exercise may include specified levels of visual emphasis through which the participant may progress based on successful performance of trials, where the progression proceeds from high visual emphasis levels to low visual emphasis levels.

In other embodiments, the visual emphasis of the scene for the subsequent trial may be modified or adjusted depending on whether the participant responded correctly or incorrectly for the trial, e.g., using a maximum likelihood procedure, such as ZEST or QUEST, or an N-up/M-down procedure. For example, in one embodiment, if the scene were presented with a specified visual emphasis, i.e., with a specified degree of one or more of the visual emphasis aspects or attributes described above (e.g., luminance or chromatic contrast, spatial frequency, size, etc.), then, based on the participant's response, the degree of visual emphasis applied to the scene may be modified or changed. For example, if the participant responded correctly a first specified number of times in a row (e.g., 3, 1, etc.), then the visual emphasis may be decreased, i.e., one or more of the aspects or attributes described above may be decreased, thereby making the stimulus (the scene) more difficult to perceive, and conversely, if the participant responded incorrectly a second specified number of times in a row (e.g., 1, 3 etc.), then the visual emphasis may be increased, i.e., one or more of the aspects or attributes described above may be increased, thereby making the stimulus (the scene) more easily perceived.

In one embodiment, visually presenting the scene may include visually presenting the scene at a specified stimulus intensity. As used herein, the term “stimulus intensity” refers to an adaptable or adjustable attribute of the scene or its presentation that may be modified or adjusted to make trials more or less difficult. The above-described adjusting of the visual emphasis may compose (or include, or result in) adjusting the stimulus intensity. In other words, by adjusting the visual emphasis, the stimulus intensity of the scene may be adjusted or modified. Said another way, in some embodiments, the stimulus intensity may be or include the visual emphasis. In preferred embodiments, adjusting the stimulus intensity may be performed using a maximum likelihood procedure, such as, for example, QUEST or ZEST threshold procedures, as described above, whereby threshold values for the stimulus intensity may be determined based on the participant's performance. As also described above, in some embodiments, adjusting the stimulus intensity may include adjusting the stimulus intensity (e.g., the visual emphasis) to approach and substantially maintain a specified success rate for the participant, e.g., using a single stair maximum likelihood procedure.

Moreover, the repeating may include assessing the participant's performance a plurality of times during the repeating. In other words, not only may the stimulus intensity (e.g., the amount of modification) be adjusted on a per trial basis based on the participant's performance, but the participant's performance may be assessed periodically during the exercise, e.g., before, one or more times during, and after the exercise. A description of threshold determination/assessment is provided above. In some embodiments, assessing the participant's performance a plurality of times may be performed according to the maximum likelihood procedure (e.g., QUEST or ZEST). Additionally, in some embodiments, the assessing the participant's performance a plurality of times may be performed using a 2-stair maximum likelihood procedure, also described above. Thus, the repeating may include performing threshold assessments in conjunction with, or as part of, the exercise.

As described above, in some embodiments, other schemes may be employed to adjust the stimulus intensity and perform assessments. For example, in some embodiments, a single-stair N-up/M-down procedure may be used to adjust the stimulus intensity of the scenes during training, and a 2-stair N-up/M-down procedure may be employed for the assessments. It should be noted that other features described above may also apply in these embodiments, e.g., adjusting the stimulus intensity (e.g., the visual emphasis) to approach and substantially maintain a specified success rate for the participant, and so forth. In other words, the use of N-up/M-down procedures does not exclude other aspects of the methods disclosed herein that are not particularly dependent on the use of maximum likelihood procedures.

In some embodiments, the method may also include performing a plurality of practice trials, i.e., prior to performing the method elements described above. For example, in some embodiments, one or more practice sessions may be performed prior to the beginning of training to familiarize the participant with the nature and mechanisms of the task. In each practice session, a specified number of trials (e.g., 5) for each of one or more practice conditions may be performed. In some embodiments, the participant may be able to invoke such practice sessions at will during the exercise, e.g., to re-familiarize the participant with the task at hand.

It should be noted that the visual emphasis techniques disclosed herein may be employed in any of the cognitive training exercises described herein (among others).

Visual Search Exercise

Below are described various embodiments of a cognitive training exercise that utilizes visual searches to improve cognition, e.g., to reverse declines in visual search by incorporating distracters, as well as features to stimulate brain neuromodulatory systems to optimize learning in a participant, e.g., an aging adult. More specifically, embodiments of the exercise may improve the efficiency, capacity and effective spatial extent of visual attentional processing, by training participants to detect targets among distracters. Two exemplary visual search tasks, referred to as Task 1 and Task 2, are presented. In the first task, referred to as a single attention visual search task, there is a single target, while in the second, referred to as a dual attention visual search task, there are two potential targets and the participant is advised which one is the current target by information presented at the fixation point, e.g., at the center of the scene or visual field. It should be noted that in various embodiments, the exercise may include the first task and/or the second task, i.e., may include either task singly, or in combination, as desired.

It should be noted that various embodiments of the visual search tasks described herein, or other visual search tasks, may be used singly or in combination in the exercise. Moreover, as described below, in some embodiments, stimulus threshold assessments may also be performed in conjunction with, or as part of, the exercise, thus facilitating more effective training of the participant's visual processing system.

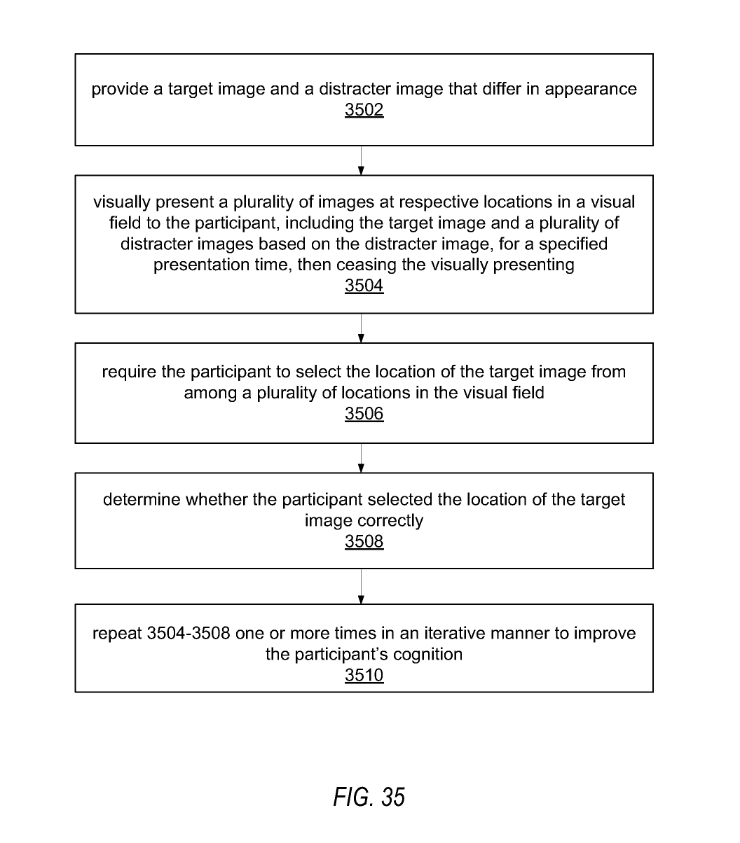

FIG. 35—Flowchart of a Method for Cognitive Training Using Visual Searches

FIG. 35 is a high-level flowchart of one embodiment of a method for cognitive training using visual searches. More specifically, the method utilizes a computing device to present a plurality of images, including a target image and a plurality of distracter images, from which the participant is to select the target image, and to record responses from the participant. It should be noted that in various embodiments, some of the method elements may be performed concurrently, in a different order than shown, or may be omitted. Additional method elements may also be performed as desired. As shown, the method may be performed as follows:

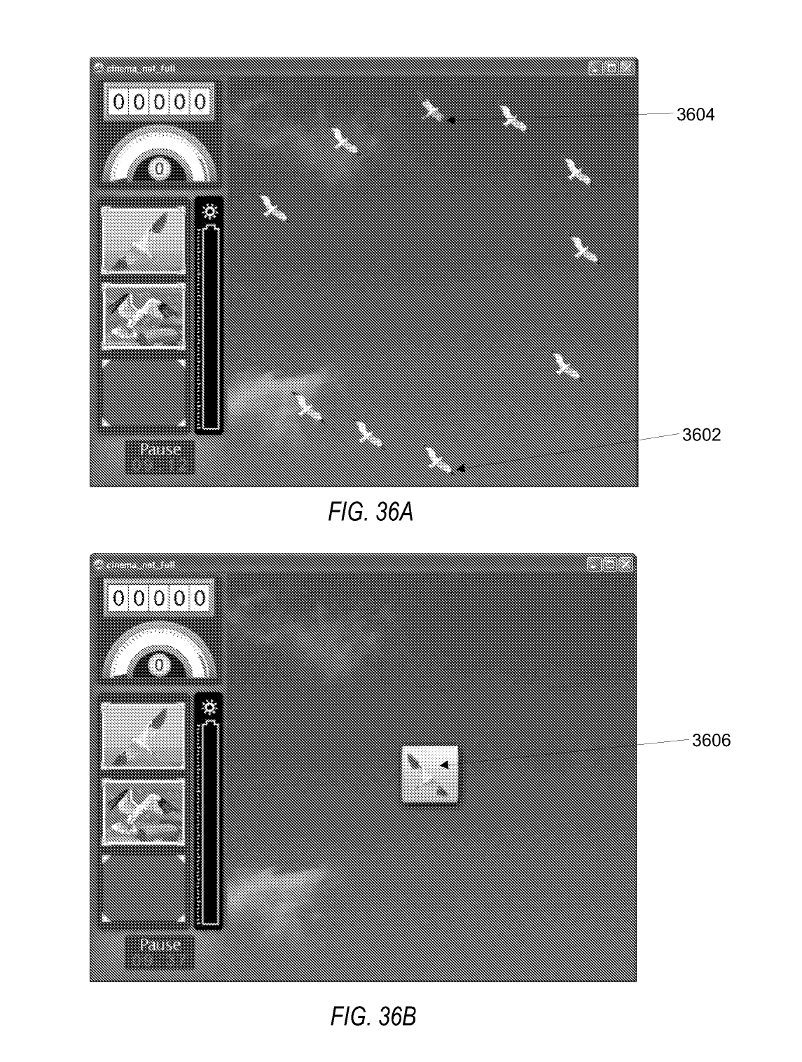

In 3502, a target image and one or more distracter images may be provided, where the target image and the one or more distracter images differ in appearance, and where the target image and the one or more distracter images are available for visual presentation to the participant. For example, each image may illustrate an object, such as an animal, with any of various distinguishing attributes, e.g., species, size, object type, object orientation, texture, shape, etc., whereby the target image may be distinguished from the one or more distracter images. In preferred embodiments, the target image may be a first species of bird, and the one or more distracter images may be of a second, different, but possibly related, species of bird, e.g., first and second species of gulls, owls, hawks, etc. Of course, other types of image distinctions may be used as desired. Exemplary images are described below and illustrated in FIGS. 36A, 36B, 37, and 39-40.

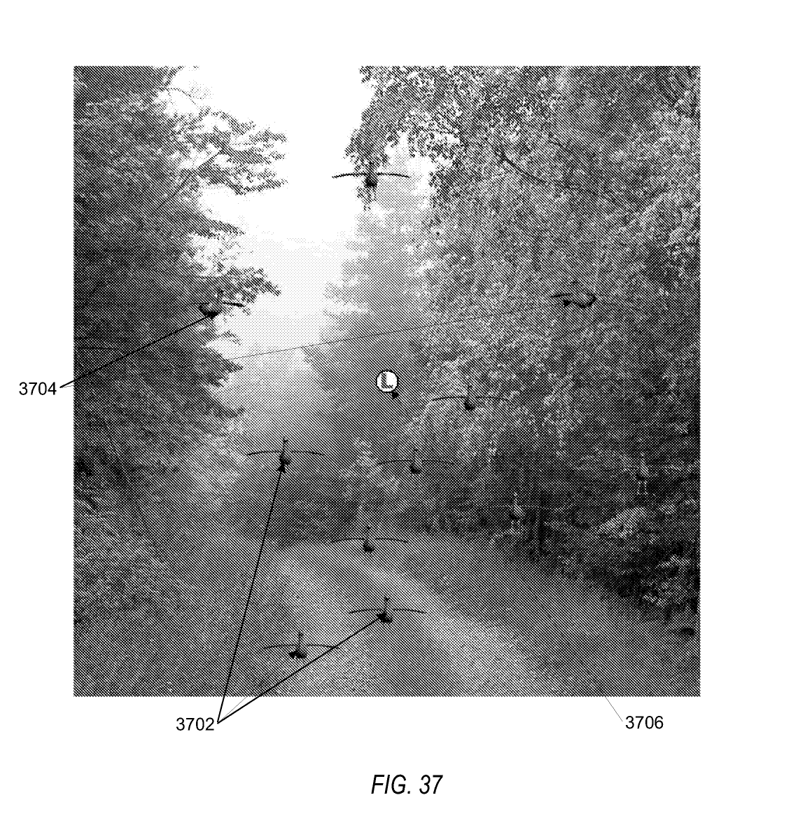

In a single attention visual search task, e.g., Task 1, only the target image and the one or more distracter images may be provided. However, in a dual attention task, e.g., Task 2, in addition to the one or more distracter images, at least two potential target images may be provided, where one of the potential target images is the target image. The potential target images may differ from each other by a specified attribute, e.g., species of bird, or orientation of the object in the image. For example, in a case where there are two potential target images, the two potential target images may be mirror images of one another, as illustrated in FIG. 37, described below, where one potential target image illustrates a bird tilted to the right, and the other potential target image illustrates a bird tilted to the left. Note, however, that all the potential target images are particularly distinct with respect to the distracter images. In other words, the differences between the potential target images and the distracter images are significantly greater than the differences between the potential target images.

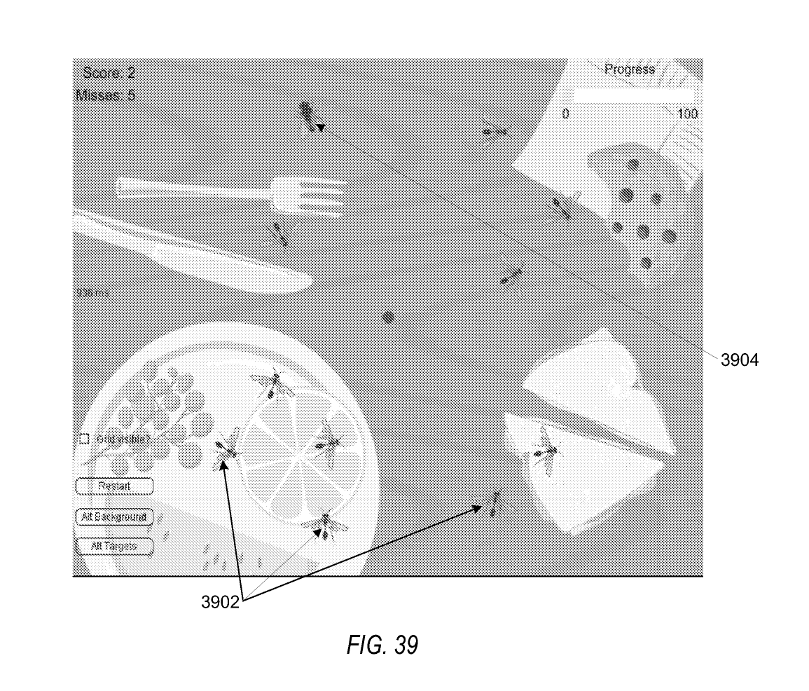

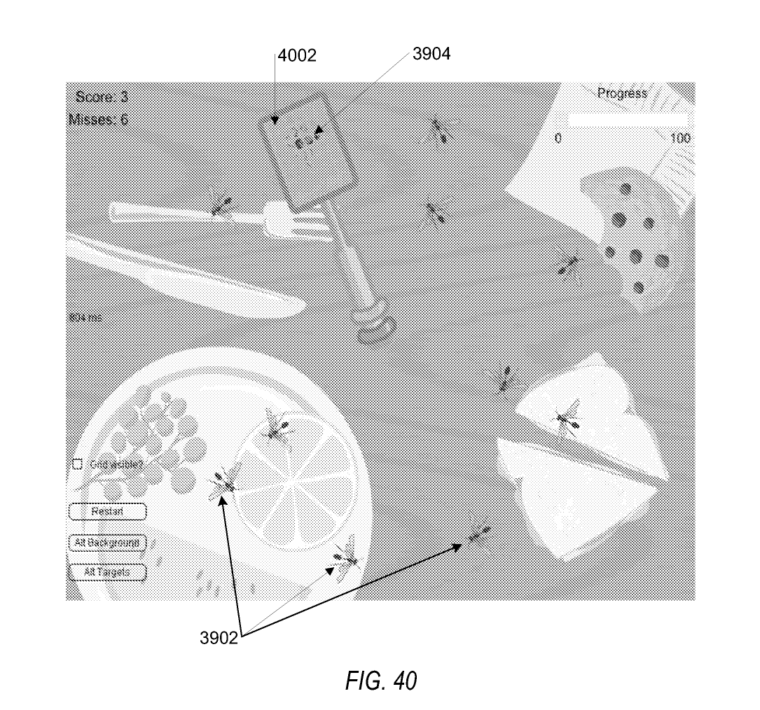

In 3504, a plurality of images may be visually presented at respective locations in a visual field to the participant for a specified presentation time, including the target image and a plurality of distracter images based on the one or more distracter images, where at the end of the specified presentation time the visually presenting is ceased. In other words, in addition to the target image, multiple instances of the one or more distracter images of 3502 may also be displayed, where these distracter images may be identical (see FIGS. 36A and 37), or in some embodiments may include rotated versions of the original image(s), i.e., the one or more distracter images of 3502 (see, e.g., FIGS. 39 and 40), where the images are displayed for a specified period of time (the presentation time), then removed from the display.

FIGS. 36A and 36B illustrate exemplary screenshots for a single attention visual search task (e.g., Task 1), where, as shown in FIG. 36A, a plurality of distracter images 3602 are displayed in a visual field, in this case, identical images of flying birds. In some embodiments, the distracter images may be placed according to some specified scheme, e.g., at some specified eccentricity, according to a perturbed regular grid, e.g., a polar coordinate grid, a 2-dimensional low-discrepancy sequence, etc., as desired, while in other embodiments, the distracter images may be displayed at random positions in the visual field.

As FIG. 36A also shows, in this embodiment, a single target image 3604 is displayed among the distracter images 3602. Note that in this particular example, the target image 404 illustrates a bird of a different species from the distracter image birds, with different wing coloration from that of the distracter image birds. Note that in the example screenshot of FIG. 36A, the background is somewhat simple, showing a lightly clouded blue sky, and so may not make visual search of the visual field more difficult. However, under different search conditions, the background may be more complex and confusing to the participant, thereby making visual searches more difficult. An example of such a complex background is shown in FIG. 37, described below. It should be noted that in some embodiments, the target and distracter images may be presented against background scenes that make target/distracter distinction more or less difficult based on covariance of image characteristics in the target/distracters and background scene elements, referred to as visual emphasis, described in more detail below. In other words, factors other than the complexity of the background may contribute to the ease or difficulty of distinguishing the target and/or distracters, with respect to the background, such as, for example, the degree of camouflage of the target image and/or the distracters with respect to the background, among others.

In some embodiments, prior to presentation of the target and distracter images, the target image may be displayed, e.g., in the center of the visual field, allowing the participant to familiarize himself/herself with the target. Such a presentation is illustrated in the exemplary screenshot of FIG. 36B, where, as may be seen, an image of the target bird 3606 is shown in isolation. In various embodiments, the target image may be displayed for a specified duration, or may remain displayed until dismissed by the participant. In other words, in some embodiments, prior to the visually presenting the plurality of images, the method may include presenting the target image, then removing the target image.

As noted above, in the case of a dual attention visual search task (e.g., Task 2), in addition to the plurality of distracter images, at least two potential target images may be displayed, one of which is the target image, and where the at least two potential target images may differ by a specified attribute. FIG. 37 illustrates an exemplary screenshot for a dual attention visual search task, where, as may be seen, a plurality of distracter images 3702 of birds flying straight ahead (out of the screen) is displayed, along with two potential target images 3704, one on the left side of the visual field and one on the right side of the visual field. Note that the potential target on the left is shown tilted to the right (is shown flying in a direction to the right of straight ahead), while the potential target on the right side of the screen is shown tilted to the left (is shown flying in a direction to the left of straight ahead). Thus, in this case, the distinguishing specified attribute (of the potential targets) is the left/right orientation of the birds in the potential target images. As mentioned above, one of these potential target images is the target image.

As FIG. 37 also shows, a fixation point 3706 is also displayed in the center of the visual field. In some embodiments, an indication of the specified attribute corresponding to a first potential target image of the at least two potential target images may be displayed, where the first potential target image is the target image. In other words, an indication of which of the potential target images is the target image may be displayed. In some embodiments, such as that illustrated in FIG. 37, this indication may be displayed at the center of the visual field, for example, in or on the fixation point. For example, in one embodiment, an “L” or “R” may be displayed indicating which direction the target image bird is tilted. As FIG. 37 shows, in this particular case, an “L” is displayed, and so the potential target image located in the right portion of the visual field is the target image, since the bird in that image is tilted to the left. Note, however, that in other embodiments, other distinguishing attributes and indicators (and means of displaying the indicators) may be used as desired. For example, in one embodiment, the distinguishing attribute between the potential target images may be color, e.g., dark brown vs. light brown, and the indicator may simply be a dot (or other shape) with the same color as the target image.

Although in preferred embodiments, the indicator is displayed at the fixation point (center of the visual field) to facilitate dual attention search (using central and peripheral vision), in other embodiments, the indicator may be displayed in other ways or in other locations, as desired. Note that, as with the single attention task, in the dual attention task, the images (and the indicator) are only displayed for the specified presentation time, after which they images (and indicator) may be removed from the display.

Note the difference between the complex background of FIG. 37 and the simple background of FIG. 36A. As may be seen by comparing the two scenes, the complexity of the background (e.g., in FIG. 37) significantly increases the difficulty of locating and discriminating between the various images.

In preferred embodiments, visually presenting the plurality of image may include visually presenting the plurality of images at a specified stimulus intensity, where, as used herein, the term “stimulus intensity” refers to an adjustable stimulus attribute or adaptive dimension that may be modified to make the search more or less difficult. For example, in a preferred embodiment, the stimulus intensity may be or include the presentation time for the visually presenting of 3504. In other words, the stimulus intensity may be the duration of time for which the plurality of images (and in the dual attention tasks, the indicator as well) is displayed. Of course, in other embodiments, other attributes may be used for stimulus intensity as desired.

In some embodiments, the relative difference in appearance between the target and distracters may be manipulated, where the more similar the two are, the more information must be extracted from each image by the participant, thus placing greater demand on the visual attentional system.

In 3506, the participant may be required to select a location of the target image from among a plurality of locations in the visual field. In other words, the participant may be required to indicate where in the visual field the target image was displayed. The participant may (attempt to) select the location of the target image in any of a number of ways. For example, in one embodiment, selection of a location of an image may be performed by the participant placing a cursor over the location and clicking a mouse. In a preferred embodiment, the visual field may be partitioned into a plurality of graphically indicated regions, where the location of the target image comprises a specified region of the plurality of regions in the visual field, i.e., the target image is contained in a specified region of the visual field. In preferred embodiments, the selection grid isn't displayed until the images are removed from the visual field.

Thus, in some embodiments, selection of a location of an image is performed by the participant placing a cursor over (or in) a region that contained the image and clicking a mouse.

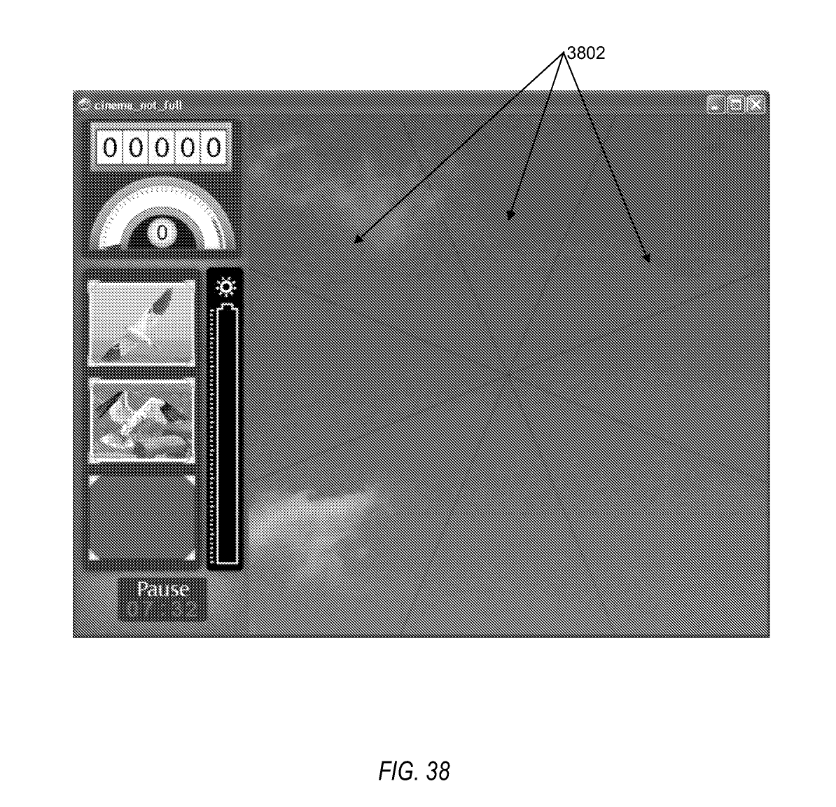

FIG. 38 illustrates such an exemplary partitioning of the visual field into selectable regions, such as regions 3802. As may be seen, in this example the visual field is divided into 8 regions, all converging at the center (fixation point) of the field. It should be noted that in some embodiments, each image's location may specified by its respective region, and each location may also have an associated eccentricity, where an image's eccentricity refers to the angular distance from the fixation point to the image given a specified viewing distance from the screen. For example, exemplary eccentricity values may include 10, 15 and 20 degrees (or equivalents), at a viewing distance of 35 cm, although other values may be used as desired.

Note that in this particular embodiment (of FIG. 38), the radial distance of an image from the fixation point is not a factor in indicating the image's location (since each region extends from the center to the edge of the visual field); however, the placement or location of that image may depend (at least partially) on its eccentricity, where, for example, an image's eccentricity value may make the visual search by the participant more or less difficult. For example, in some embodiments of the dual attention visual search task, potential target images with high eccentricities may be more difficult to process, given that the participant's attention is divided between the indication (of a distinguishing attribute of the target image) at the fixation point at the center of the visual field, and the potential target images, which, due to their eccentricities, are located near the edge of the visual field. In some embodiments, the regions may be defined by both angular partitions (as shown in FIG. 6), and radial partitions (not shown), e.g., demarcated by concentric circles around the fixation point, reflecting different eccentricities.

In some embodiments, there may be multiple presentations of target/distracter sets shown (in 3504) before the participant makes a response. For example, 3 sets of target/distracter sets (scenes) may be visually presented, after which the participant may be required to respond, indicating the order of locations (selectable regions) where the targets appeared in each set. In other words, a sequence of target/distracter/background scenes may be presented, after which the participant may be required to indicate the corresponding sequence of target image locations (regions).

Note that while in the single attention visual search task, the participant is required to select the location (or sequence of locations) of the target image (or target images) from among a plurality of locations in the visual field, where the displayed images include the target image and a plurality of distracter images, in embodiments of the dual attention visual search task, e.g., where there are at least two potential target images displayed, a first of these potential target images being the target image itself, as well as an indication of the distinguishing attribute of the target image (with respect to the other potential target image(s)), the participant may be required to select the location of the first potential target image from among the plurality of locations in the visual field, including selecting a location of the first potential target image from among the locations of the at least two potential target images based on the visually presented indication.

In 3508, a determination may be made as to whether the participant selected the location of the target image (or sequence of target image locations) correctly. In some embodiments, whether the participant correctly selected the location of the target image (or not) may be recorded. In some embodiments, an indication, e.g., a graphical or audible indication, may be provided to the participant indicating the correctness or incorrectness of the participant's response. For example, a “ding” or a “thunk” may be played to indicate correctness or incorrectness, respectively, and/or points may be awarded (in the case of a correct response). Of course, any other type of indication may be used as desired. The above visually presenting, requiring, and determining, may compose a trial in the exercise or task.

In some embodiments, the participant may perform the exercise or tasks via a graphical user interface (GUI). The GUI may include a stimulus presentation area where the images of 3504 may be presented to the participant, such as the exemplary visual fields of FIGS. 36A, 37, and 38, as well as means for receiving input from the participant, e.g., the selectable regions described above. Moreover, in some embodiments, additional GUI elements may be provided, e.g., for indicating various aspects of the participant's progress or status with respect to the exercise or task. For example, the GUI may include one or more of: a score indicator that indicates the participant's current score in the task or exercise, a time remaining indicator that provides an indication of how much time remains in the current task, session, or exercise, a threshold field that displays stimulus threshold information, such as the current threshold value and a best threshold value, where a threshold indicates or is the value of an adjustable stimulus attribute or adaptive dimension, referred to as the stimulus intensity, that results in a specified performance level, i.e., success rate, for the participant, as will be explained below in more detail. In various embodiments, the GUI may also include additional indicators, such as, for example, a bonus meter (or equivalent), which may indicate the number of correct responses in a row, and may flash, play music, and/or award bonus points, when some specified number, e.g., 5, in a row is attained. It should be noted that the GUIs described above are meant to be exemplary only, and that other GUIs are envisioned.

For example, FIGS. 39 and 40 illustrate an exemplary embodiment of a GUI for a single attention visual search task in which the distracter images are images of small flying insects, and the target image is that of a large fly 3904. As shown, this GUI includes a display area, i.e., the visual field wherein the images are displayed (and in some embodiments, then removed), as well as various GUI elements for displaying progress in the exercise or task or interacting with the GUI. For example, in the upper left corner of the display are displayed a score indicator, and an indicator that displays how many misses have occurred. In the upper right corner of the display, a progress bar is shown that indicates the participant's progress in the current exercise or task. As FIG. 39 also shows, in this embodiment, various controls are displayed in the bottom left corner of the display, including a restart button, an alternate background button, whereby the participant may switch to a different background for the images, and an alternative targets button, whereby the participant may switch the types of targets presented in the exercise or task. However, it should be noted that these particular GUI elements are meant to be exemplary only, and are not intended to limit the GUIs contemplated to any particular form, function, or appearance. In the embodiment of FIGS. 39 and 40, the participant may (attempt to) select the target image 3904 by “swatting” the area of the scene where the fly appeared, i.e., using a fly swatter-shaped cursor 4002, as shown in FIG. 40. In one embodiment, once the swatter is used the insects may reappear so that the participant can see if the response is correct. Thus, in this embodiment, rather than selecting specified regions within which images may be located, the participant may select the specific location of the target image (i.e., where the target image was temporarily displayed).

In 3510, the visually presenting, requiring, and determining of 3504, 3506, and 3508 may be repeated one or more times in an iterative manner, to improve the participant's cognition, e.g., efficiency, capacity and effective spatial extent of visual attentional processing, e.g., visual processing skills.

In other words, a plurality of trials may be performed in the exercise (with respect to either or both tasks), where various search fields and images are visually presented to the participant, as described above. For example, the repetitions may be performed over a plurality of sessions, e.g., over days, weeks, or even months, e.g., for a specified number of times per day, and for a specified number of days. In some embodiments, at the end of each session, the participant's score and thresholds for the session may be shown and may be compared to the best performance.

Such repeating preferably includes trials performed under a variety of specified search conditions, wherein each visual search condition specifies one or more attributes of the plurality of images or their presentation, e.g., with visual searches covering a range of search attributes. Such conditions may include baseline conditions, used before, after, and at specified points during, the exercise to assess the participant's performance (described further below), and non-baseline or training conditions, used for the actual training during the exercise. Thus, blocks of stimuli may contain particular conditions affecting the difficulty of the searches.

In some embodiments, trials in the exercise may be directed to a single visual search task, e.g., to a single attention visual search task, or a dual attention visual search task; however, as mentioned above, in preferred embodiments, the repeating may include performing trials in each of the visual search tasks (e.g., the single and dual attention visual search tasks) described above (and/or other visual search tasks).

Each task may have a set of conditions specifying the visual searches for that task. For example, in some embodiments of the single attention visual search task (Task 1), each of the visual search conditions may specify one or more of: colors of the target image and the distracter images, textures of the target image and the distracter images, shapes of the target image and the distracter images, sizes of the target image and the distracter images, orientations of objects shown respectively by the target image and the distracter images, object types shown respectively by the target image and the distracter images, number of distracter images, location of the target image, visual background, and/or visual emphasis of the target image, distracter images, and/or the background, although it should be noted that any other attributes may be used as desired. In some embodiments of the dual attention visual search task (Task 2), each condition may specify any or all of the above, and may also specify the number and type of potential target images, and/or the distinguishing attribute of the potential target images (e.g., object orientation—see FIG. 37). However, as mentioned above, other attributes may be used as desired.

It should be noted that in some embodiments, the various search conditions used in trials over the course of the exercise may include visual emphasis levels in accordance with any of the visual emphasis techniques described above, among others. For example, visual emphasis may be increased to make trials easier, or decreased to make trials more difficult, as desired.

As noted above, there are a variety of ways that the visual search task(s) may be performed over the course of the exercise. For example, in a preferred embodiment, only the single attention task may be performed, where, for example, conditions, e.g., parameters such as eccentricity (of image placement), the number of distracters, and visual emphasis level (among others), may be varied after some number, e.g., 50, of correct trials have been performed.

For example, in a preferred embodiment, the participant may be trained at a selected eccentricity at a time, with a selected number of distracters, and a selected background. It may be important to train in one type of a condition at a time to maximize the training effect. In one exemplary embodiment, the conditions used over the course of the exercise may vary as follows: 9 target/distracter object pairings (e.g., different pairs of bird species); 5 visual emphasis levels (with more similar object/background pairings corresponding to lower levels of visual emphasis); and 3 co-varied groupings of number of distracters and eccentricity (with increasingly large numbers of distracters at greater eccentricities). This schedule results in a total condition set of 135 conditions. Each condition may be performed until some specified number, e.g., 50, of correct responses have been made. However, it should be noted that the above training schedule or regimen is meant to be exemplary only, and is not intended to limit the training schedule or regimen used to any particular approach.

In one exemplary training schedule or regimen utilizing both visual search tasks, on first alternate sessions, trials under a first number of conditions may be performed for the single attention search task, and under a second number of conditions for the dual attention search task, and on second alternate sessions, trials under the second number of conditions may be performed for the single attention search task, and under the first number of conditions for the dual attention search task, where the first alternate sessions and the second alternate sessions are interleaved, e.g., the respective number of conditions used per task may alternate on a per session basis. Thus, in an embodiment where the repeating is performed over a 40 day training period, and where the participant is trained on 3 conditions per session (e.g., 3 conditions per day), e.g., for a total of 15 minutes, of the 3 conditions, 1 may be from one search type, and 2 may be from the other search type, and this may alternate with each training session.

In another exemplary schedule, the type of search may be consistent for that day (either single attention searches or dual attention searches) and may alternate each day. In other words, on a particular day, the participant may be presented trials under three conditions for one type of search only (either single attention or dual attention). The next day, the participant may be presented with trials under conditions for the other type of search. Thus, for example, a block sequence may be trained on every other day for a total of 5 days. This approach may maximize the training effect of the exercise.

As noted above, the participant may be trained at a selected eccentricity at a time, with a selected number of distracters, and a selected background. It may be important to train in one type of a condition at a time to maximize the training effect. In one embodiment, the particular task performed may also be considered a condition. In one exemplary embodiments, the conditions used over the course of the exercise may vary as follows: 2 task types (single versus dual attention); 4 target/distracter horizontal rotation differences (90, 67.5, 45, 22.5 degrees); 3 eccentricities; 2 background levels; and 3 sets of distracter numbers (i.e., numbers of distracter images). This results in a total condition set of 144 conditions. Thus, at 5 minutes per condition, the exercise may require a total of 12 hours of training. However, it should be noted that the above training schedule or regimen is meant to be exemplary only, and is not intended to limit the training schedule or regimen used to any particular approach. Thus, in some embodiments, the exercise may include performing multiple tasks, e.g., Task 1 and Task 2, using visual searches.

In one embodiment, the repeating may include modifying or adjusting the stimulus intensity of the presented stimuli based on the participant's response. For example, as noted above, in a preferred embodiment, the stimulus intensity may be the presentation time of the stimulus, i.e., the duration of the display of the plurality of images (and possibly the attribute indicator). Thus, in each trial, and in response to the participant's indicated selection of the target image, the stimulus intensity of the visual search may be adjusted for the next trial's visual presentation, i.e., based on whether the participant indicated the target image correctly (or not). The adjustments may generally be made to increase the difficulty of the stimulus when the participant answers correctly a first specified number of times in a row (e.g., 3, 1, etc.), e.g., shortening the presentation time, and to decrease the difficulty of the stimulus when the participant answers incorrectly a second specified number of times in a row (e.g., 1, 3, etc.), e.g., increasing the presentation time. Moreover, the adjustments may be made such that a specified level of performance, i.e., level of success, is approached and substantially maintained during performance of the exercise. For example, based on the participant's responses, the intensity of the visual searches may be adjusted to substantially achieve and maintain a specified success rate, e.g., 85% or 90%, for the participant, although other rates may be used as desired.

In preferred embodiments, the adjustments may be made using a maximum likelihood procedure, such as a QUEST or a ZEST threshold procedure, described above. In some embodiments, these adjustments (e.g., using ZEST) may be determined on a per condition basis. In other words, for each condition (used in each task), the visual searches may be presented (and adjusted) in accordance with a maximum likelihood procedure (e.g., ZEST) applied to trials under that condition. Moreover, as described below, the repeating may also include performing threshold assessments in conjunction with, or as part of, the exercise, as described above.

Thus, in preferred embodiments, a maximum likelihood procedure, such as a ZEST procedure, may be used to adjust the stimulus intensity of the visual searches during training (e.g., via a single stair ZEST procedure per condition), and may also be used for assessment purposes at periodic stages of the exercise (e.g., via a dual stair ZEST procedure, describe below). In one embodiment, such assessment may occur at specified points during the exercise, e.g., at 0% (i.e., prior to beginning), 25%, 50%, 75%, and 100% (i.e., after completion of the exercise) of the exercise. Thus, for example, in a 40-day exercise schedule, these assessments, which may be referred to as baseline measurements, may be made on days before and after training, and after 10, 20, and 30 days of training, to gauge improvements over the training time.

In another embodiment, the participant may be prompted or instructed to take an assessment on the first training day, and may be offered the opportunity to take an assessment at any other point during the training. For example, the participant may be prompted or advised to take an assessment at certain points during the training when the participant's performance during training reaches a certain level, possibly weighted by the number of training trials that have been performed.

In some embodiments, the presenting, requiring, determining, and modifying may compose performing a trial, and certain information may be saved on a per trial basis. For example, in one embodiment, for each trial, the method may include saving one or more of: the current visual task, which track was used in the trial, the duration used in the trial, the number of distracter images presented to the participant in the trial, the eccentricity of the target, the visual emphasis level, the participant's selection, the correctness or incorrectness of the participant's response, the mean of a posterior probability distribution function for the maximum likelihood procedure, and the standard deviation of the posterior probability distribution function for the maximum likelihood procedure, among others. Of course, any other data related to the trial may be saved as desired, e.g., the distinguishing attribute of the target image, eccentricity of the target image, and/or any other condition of the visual search.

As described above, in some embodiments, other schemes may be employed to adjust the stimulus intensity and perform assessments. For example, in some embodiments, a single-stair N-up/M-down procedure may be used to adjust the stimulus intensity of the visual search stimuli during training, and a 2-stair N-up/M-down procedure may be employed for the assessments. It should be noted that other features described above may also apply in these embodiments, e.g., adjusting the stimulus intensity to approach and substantially maintain a specified success rate for the participant, and so forth. In other words, the use of N-up/M-down procedures does not exclude other aspects of the methods disclosed herein that are not particularly dependent on the use of maximum likelihood procedures.

In some embodiments, the method may also include performing a plurality of practice trials, i.e., prior to performing the method elements described above. For example, in some embodiments, one or more practice sessions may be performed prior to the beginning of training to familiarize the participant with the nature and mechanisms of each task. For example, in one embodiment, before training begins for each of the single attention and dual attention tasks, the participant may perform at least one practice single attention visual search session and at least one practice dual attention visual search session. In each practice session, a specified number of trials (e.g., 5) for each of one or more practice conditions may be performed. In some embodiments, the participant may be able to invoke such practice sessions at will during the exercise, e.g., to re-familiarize the participant with the task at hand.

In some embodiments, the participant may be required to show an understanding of the task by achieving a specified level of performance, referred to as a criterion level, on the initial assessment before moving on to the training exercise.

Multiple Object Tracking Exercise

Below are described various embodiments of a cognitive training exercise that utilizes multiple object tracking (MOT) to improve the participant's cognition, e.g., to improve divided attention (attending to multiple events simultaneously), sustained attention (attending for a prolonged period), motion processing, and visual memory, e.g., by renormalizing and improving the ability of the visual nervous system of a participant to track multiple objects in a visual scene, e.g., to reverse declines in multiple object tracking.

In embodiments of the present invention, a number of identical static objects (images) may be shown on a display, e.g., on a computer monitor. A plural subset of these objects may be identified or indicated as targets, e.g., by highlighting them. The indication may be removed, and the objects may move for a specified period of time, after which the participant is to indicate or select the target objects at the end of each trial. The number of objects may adapt to track the participant's performance using an adaptive staircase algorithm. A range of conditions may be used in the training, including different image/object speeds, different display sizes, overlapping vs. repelling objects, objects that can occlude the images, and so forth.

It should be noted that in various embodiments of the multiple object tracking exercise described herein, stimulus threshold assessments may also be performed in conjunction with, or as part of, the exercise, thus facilitating more effective training of the participant's cognitive systems.

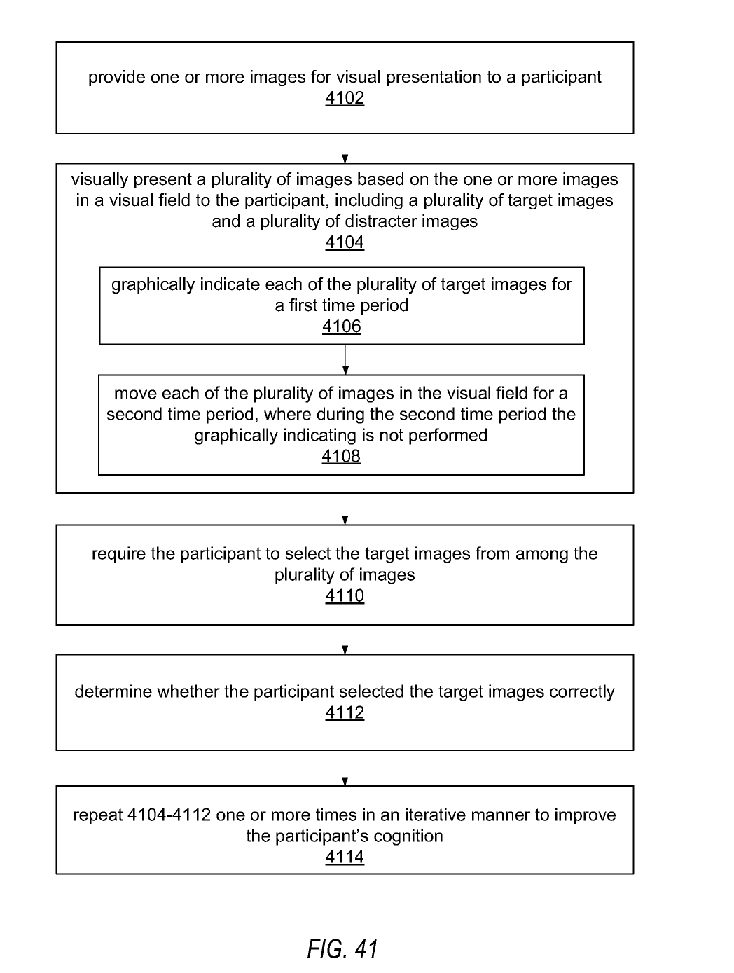

FIG. 41—Flowchart of a Method for Cognitive Training Using Multiple Object Tracking

FIG. 41 is a high-level flowchart of one embodiment of a method for cognitive training using multiple object tracking. It should be noted that in various embodiments, some of the method elements may be performed concurrently, in a different order than shown, or may be omitted. Additional method elements may also be performed as desired. As shown, the method may be performed as follows:

In 4102, one or more images may be provided, where the one or more images are available for visual presentation to the participant. The images may be of any type desired. For example, in one embodiment, the one or more images may include an image of a bubble, as will be described below and illustrated in various figures. In some embodiments, the images may include or be associated with various items, e.g., bonus items, as will be described below

In 4104, a plurality of images based on the one or more images may be visually presented in a visual field to the participant, including a plurality of target images (also referred to as target objects) and a plurality of distracter images (or distracter objects). In one embodiment, all the images may be identical, although in other embodiments, images with different appearances may be presented. In one embodiment, the visual presentation of 4104 may be invoked or initiated by the participant clicking a Start button (presented in a graphical user interface).

The visual presentation of the plurality of images preferably includes graphically indicating each of the plurality of target images for a first time period, as shown in 4104, and moving each of the plurality of images in the visual field for a second time period, where during the second time period the graphically indicating of 4104 is not performed, as shown in 4106. In other words, the participant may temporarily be shown which of the plurality of images are target images (4104), after which the images revert to their original appearance, which is indistinguishable from the distracter images, and the images may be moved, e.g., in random directions, for a specified period of time.

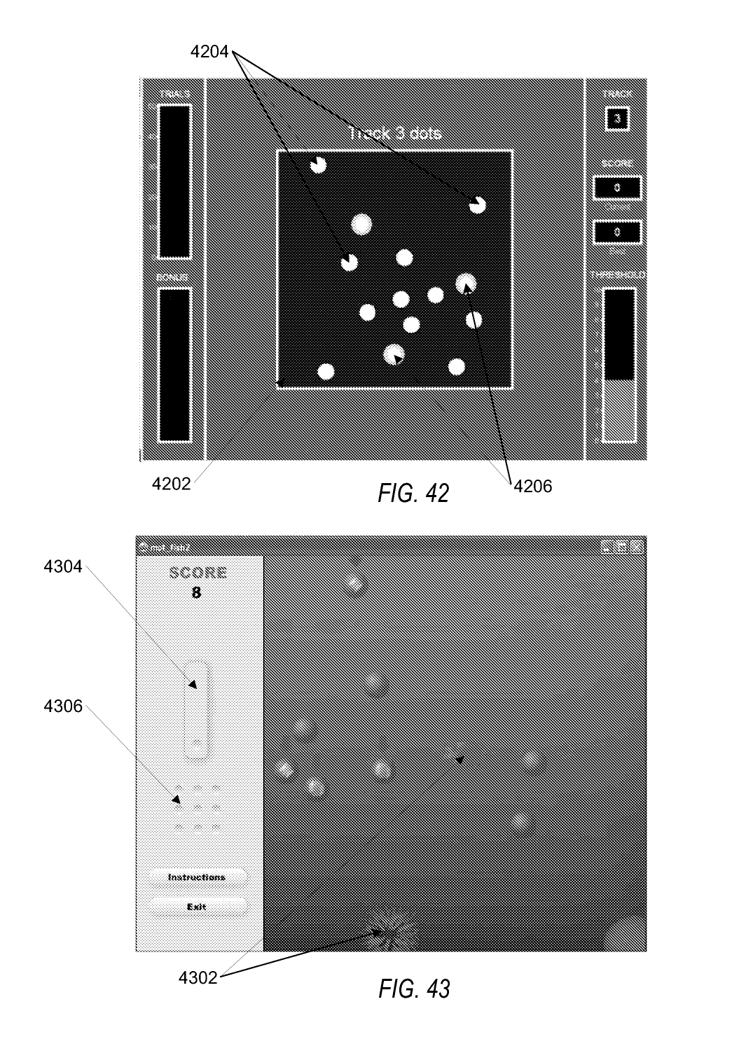

In preferred embodiments, the participant may perform the exercise described herein via a graphical user interface (GUI). FIG. 42 illustrates an exemplary screenshot of a graphical user interface (GUI) for a multiple object tracking task, according to one embodiment. As may be seen, the GUI preferably includes a visual field 4202, in which may be displayed a plurality of images, in this case, identical circles. In some embodiments, the visually presenting 4104 may include setting initial positions for each of the plurality of images. For example, in some embodiments, the various images may be displayed at (possibly weighted) random positions in the visual field, while in other embodiments, the images may be placed according to some specified scheme, e.g., according to a 2-dimensional low-discrepancy sequence, a perturbed regular grid, e.g., a polar coordinate grid, etc., as desired. The target images may be initially positioned at various eccentricities with respect to the center of the visual field, referred to as the fixation point. Note that this distance may be a simple linear distance, or may refer to the angular distance from the fixation point to the image given a specified viewing distance from the screen. For example, exemplary eccentricity values may include 10, 15 and 20 degrees (or equivalents), at a viewing distance of 35 cm, although other values may be used as desired.

As FIG. 42 also shows, in this embodiment, target images 4206 are indicated via highlighting, whereas the distracter images 4204 are not. It should be noted, however, that other means of indicating the target images 4206 may be used as desired, as illustrated in FIG. 43, described below. Note that in the example screen of FIG. 42, the background is simple, specifically, a blank field, and so does not complicate the multiple object tracking task. However, in other embodiments or tracking conditions, the background may be more complex and confusing to the participant, thereby making multiple object tracking more difficult. An example of such a complex background is shown in FIG. 43, described below.

As FIG. 42 also shows, in some embodiments, the GUI may include various indicators regarding aspects of the exercise, such as, for example, indicators for bonus points and trials performed in the exercise, as shown on the left side of the GUI, and labeled accordingly, as well as indicators for the number of target images being tracked, labeled “tracks”, the participant's score, including a current value and a best value, labeled accordingly, and a threshold indicator, so labeled, which indicates the value of a stimulus intensity for the tracking task, explained in detail below. Of course, in other embodiments, other indicators or controls may be included in the GUI as desired.

FIG. 43 illustrates an exemplary screenshot of a graphical user interface (GUI) for a multiple object tracking task, according to another embodiment, where the exercise is presented as a game called “Jewel Diver”. As shown, in this embodiment, the various images are of bubbles, and are displayed in an underwater scene that includes additional objects 4302, such as a fish and sea urchin, which in some embodiments may be operable to hide or occlude one or more of the images, as discussed below. The target images, indicated by downward pointing arrows, each contains a respective jewel, which may be shown during the graphically indicating of 4106. In other words, in this embodiment, before the movement of 4108 begins, the normally opaque target bubbles may temporarily become transparent, displaying the respective jewels contained therein.

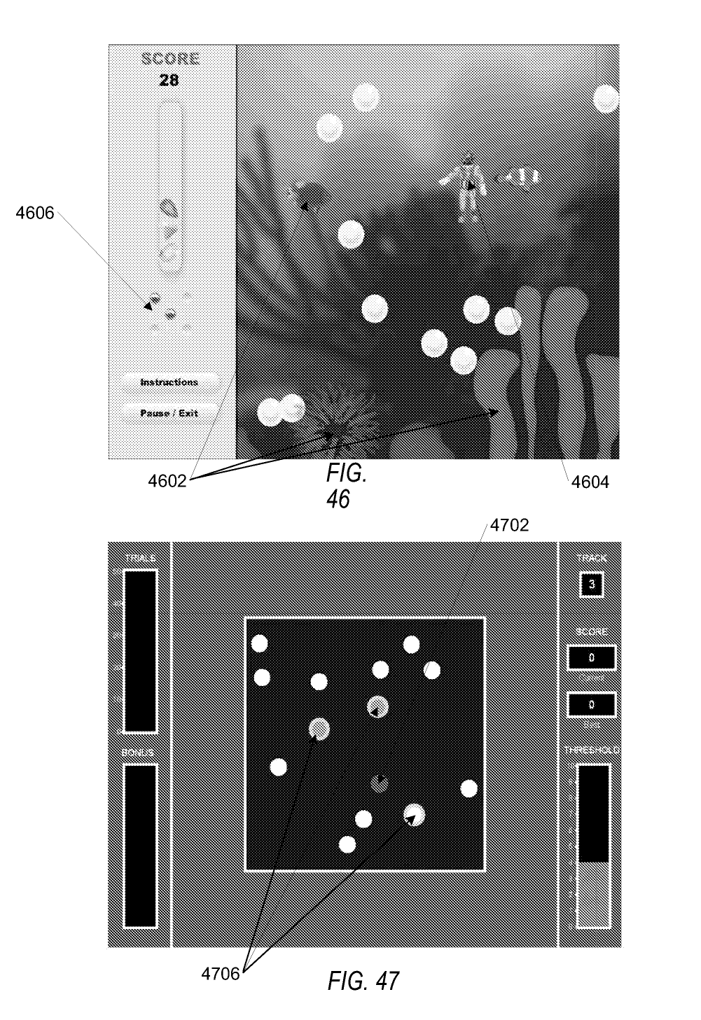

As may be seen, the GUI of FIG. 43 includes a score indicator, so labeled, as well as an indicator 4304 for the number of jewels won by the participant (by correctly selecting target images). Thus, as the target images are correctly selected by the participant, the respective jewels may be moved from the bubbles to the jewel indicator (see, e.g., FIG. 47, described below). Below the jewel indicator 4304 is a bonus counter or indicator 4306 that may count or indicate the number of trials in which all the target images were correctly selected, e.g., in which all the jewels for the trial were collected. For example, each time all the jewels have been collected (for a trial), a pearl may appear in one of the slots of the bonus counter 4306. In other words, if the user correctly selects all the target images in a trial, one of the dots or slots in the bonus indicator 4306 may be activated or filled and bonus points awarded. As shown, in this particular case, a maximum of nine such bonuses may be counted, at which point, additional bonus points may be awarded. In one embodiment, once all the bonus slots in the bonus counter are filled, the participant may progress to a next level in the exercise, as will be described in more detail below.

As FIG. 43 also shows, the GUI includes a control, e.g., a button, for invoking display of instructions, labeled “instructions”, as well as an exit button for exiting the task or exercise, labeled “exit”. It should be noted that these particular GUI elements are meant to be exemplary only, and are not intended to limit the GUIs contemplated to any particular form, function, or appearance.

In some embodiments, the moving 4106 may include setting initial speed and direction for each of the plurality of images. Similar to the initial positions, in some embodiments, setting the initial speed and direction for each of the plurality of images may include setting initial speed and direction for each of the plurality of images randomly, although other initialization schemes may be used as desired. In some embodiments, the moving 4106 may include changing the speed and/or direction of at least a subset of the plurality of images one or more times during the moving. In other words, in addition to bouncing off the boundaries of the visual field, the movement of the images may also include changing direction and/or speed, e.g., randomly, during the movement, thereby complicating the tracking task.

Thus, for example, in one embodiment, the range of possible speeds may be specified, e.g., by a tracking condition, e.g., 1-3 degrees/sec. The direction of each image may be chosen at random. Moreover, in one embodiment, on each frame of the movement, there may be a 5% chance that the speed will change at random within the speed range category, e.g., with a speed change range of between 0 and half the range maximum. Similarly, per movement frame, there may be a 5% chance that the direction will change, where the direction change may be chosen randomly from between 0 and 90 degrees. Note, however, that other probabilities and randomization schemes may be used as desired. These parameters may be specified by various conditions under which trials in the exercise may be performed, as discussed in more detail below. As noted above, the moving images may simply bounce off the walls of the visual field.

In preferred embodiments, visually presenting the plurality of image may include visually presenting the plurality of images at a specified stimulus intensity, which is an adjustable stimulus attribute or adaptive dimension that may be modified to make the tracking more or less difficult. For example, in a preferred embodiment, the stimulus intensity may be or include the number of target images of the visually presenting of 4104. In other words, the stimulus intensity may be the number of target images that the participant is expected to track. Thus, visually presenting the plurality of images may include visually presenting the plurality of images at a specified stimulus intensity, e.g., with a specified number of target images. As another example, the stimulus intensity may be the presentation time of the images, i.e., the amount of time the images are displayed. As yet another example, the stimulus intensity may be the speed at which the images or objects moveduring tracking. Of course, other stimulus intensities may be used as desired, e.g., size of the target images and the distracter images, eccentricity of initial locations of the target images, number of occluders in the visual field, size of the visual field, visual appearance of the images, e.g., visual emphasis, i.e., visual attributes that enhance distinction of the images against the background, e.g., color, luminance or color contrast, homogeneity, etc. of the images, among others. In other words, in various embodiments, the stimulus intensity may refer to any adjustable attribute of the stimulus and/or its presentation that may be modified to increase or decrease the difficulty of trials in the exercise.

A stimulus intensity threshold refers to the value of stimulus intensity at which the participant achieves a specified level of success, e.g., a 69% success rate. The stimulus intensity may be dynamically adjusted to optimize the participant's learning rate in the exercise, as will be described in detail below.

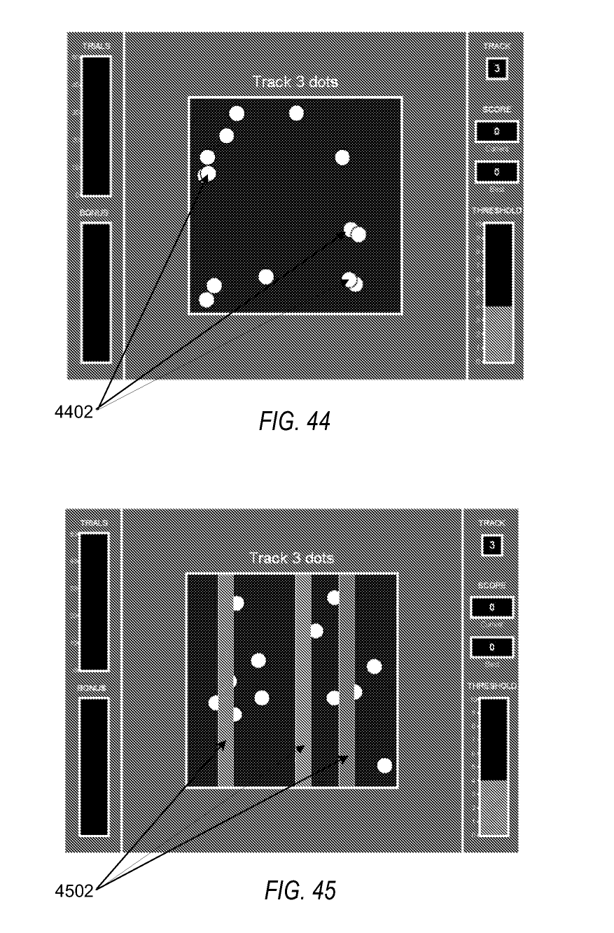

In various embodiments, and over the course of the exercise, the visually presenting of 4104 may be performed under a variety of specified conditions that may make tracking the target images more or less difficult. As one example, in some embodiments, the positions and movements of the images may be constrained. For example, in some cases, the images may or may not be allowed to overlap. FIG. 44 is a screen shot of a GUI similar to that of FIG. 42, where, as may be seen, overlap of images is allowed, as illustrated by the various image overlaps 4402 shown. Conversely, in other embodiments (or under different conditions), such overlaps may be forbidden. In these cases, the images may repel one another, e.g., by elastic collisions, repellant forces, etc., as desired. Another example of a tracking condition is the number of occluders in the visual field, where an occluder is a region or object behind which images may move and be hidden. FIG. 45 is a screen shot of a GUI where the tracking condition includes a specified number of occluders (in this particular case, three). The use of such occluders may make tracking of the moving images more difficult, i.e., the more occluders used, the more difficult the tracking task. Thus, under various different conditions, the number of occluders may range from 0 to some specified maximum of occluders. Other tracking conditions are described below. Note that in various embodiments, attributes that specify any conditions for the trials may be used as a stimulus intensity (or intensities), and may thus be adjusted dynamically, e.g., using a maximum likelihood procedure, or an N-up/M-down procedure, as described below in detail.

In some embodiments, constraints may be applied regarding initial and/or final positions of the images. For example, even under conditions or tasks allowing overlaps and/or occluders, overlaps and/or occlusion may be disallowed before movement begins, and at the end of movement, thus preventing target images from being hidden, and thus unselectable by the participant. This may be achieved in any of a number of ways, including, for example, by allowing motion to continue until no overlap or occlusion is in effect, or by constraining or enhancing motion or positions of the images to avoid these conditions (at the beginning and end of movement), among others. Thus, in some embodiments, when using occluders, the target images may not be positioned behind the occluders before motion begins. Moreover, the occluders may be removed before the participant's response is made. Similarly, when overlapping is allowed, the target images may not be allowed to overlap each other when the trial is over, and so to accommodate this, the trial may be extended until all targets are not overlapping with any other image.

In 4106, the participant may be required to select or indicate the target images from among the plurality of distracter images. Said another way, a period of time may be provided in which the participant is to select the target images. The participant may (attempt to) select the target image from among the plurality of images in any of a number of ways. For example, selection of an image may be performed by the participant placing a cursor over the image and clicking a mouse. In one embodiment, requiring the participant to select the target images may include allowing the participant to make a number of selections, where the number of selections is equal to the number of target images. Thus, in a trial where there are four target images, the participant may be allowed only four “clicks” or selections to indicate the target images. In other embodiments, one or more additional selections may be permitted, i.e., allowing one or more mistakes to be made while still being able to select all the target images. In some embodiments, the selections made by the participant may be recorded.

In 4108, a determination may be made as to whether the participant selected the target images correctly. In other words, the method may determine the number of target images correctly selected or indicated by the participant. In one embodiment, the method may include recording the participant's success at selecting the target images, e.g., the fraction of target images correctly selected by the participant.

In some embodiments, in indication may be provided as to whether the participant selected the target images correctly, where the indicating is performed audibly and/or graphically. In one embodiment, the indicating whether the participant selected the target images correctly may be performed for each selection. Thus, each time the participant correctly selects a target image, a visual and/or auditory indication may be provided. For example, a “ding” may be played upon correct incorrect selection of a target image, and/or a “thunk” may be played upon incorrect selection of a target image. Graphical indicators may also be used as desired. For example, in an embodiment corresponding to the GUI of FIG. 43, where each target object includes a jewel, upon selection of a target image/object, the jewel may appear and be moved to the jewel counter 4304, e.g., as an animation. This visual indication may be performed instead of, or in addition to, any auditory indication (e.g., a “ding”, etc.). In some embodiments, points may be awarded based on the number of target images correctly selected. FIG. 46 is a screenshot of an exemplary GUI that illustrates the above. As may be seen, in this embodiment, the participant has correctly selected three target images correctly, and so there are three jewels in the jewel counter 4304. In this embodiment, the participant has made these selections by moving the cursor, in this case, diver 4604, over the image (bubble) with a mouse, and clicking the mouse. This GUI also illustrates a variety of occluders 4602, specifically, two fish, a sea urchin, and, in the bottom right of the visual field, kelp. Similar to the GUI of FIG. 43, this GUI also includes a bonus counter 4606, this time with five slots. As with the GUI of FIG. 43, each time the participant correctly selects all the target images (collects all the jewels) in a trial, a pearl may appear in a slot of the bonus counter 4606, here shown with two pearls. In one embodiment, once the bonus counter is full, the participant may progress to the next level in the exercise. Of course, in other embodiments, other schemes for level promotion may be used as desired.

In one embodiment, the method may further include graphically indicating each of the plurality of target images after the determining. In other words, once the participant has completed the (attempted) selection of the target images, and the determination has been made as to the correctness of the selections, all the target images for the trial may be graphically indicated, e.g., via highlighting. FIG. 47 is a screenshot of an exemplary GUI, similar to those of FIGS. 42, 44, and 45, that illustrates both the graphical indication of correctness/incorrectness per selection, and the graphical indication of the target images after the selections have been completed. In the embodiment of FIG. 47, there are three target images 4706. Upon correct selection of a target image, the selected target image may change color, e.g., to green, to indicate the correctness of the selection, as illustrated by the two upper target images 4702, whereas upon incorrect selection of an image, the selected image may change color, e.g., to red, to indicate the incorrectness of the selection, as illustrated by image 4702. As FIG. 47 also shows, each of the target images 4706 are shown highlighted, so that whichever selections the participant has made, the actual target images 4706 are clearly indicated.

Note that the above visually presenting, requiring, and determining of 4104, 4106, and 4108 may compose performing a trial in the exercise.

In 4114, the visually presenting, requiring, and determining of 4104 (including 4106 and 4108), 4110, and 4112 may be repeated one or more times in an iterative manner, to improve the participant's cognition, e.g., to improve divided attention (attending to multiple events simultaneously), sustained attention (attending for a prolonged period), motion processing and visual memory, by training the participant's visual spatiotemporal tracking ability.

In other words, a plurality of trials may be performed in the exercise as described above. For example, the repetitions may be performed over a plurality of sessions, e.g., over days, weeks, or even months, e.g., for a specified number of times per day, and for a specified number of days. In some embodiments, at the end of each session, the participant's score and thresholds for the session may be shown and may be compared to the best performance for that participant.

Such repeating preferably includes performing a plurality of trials under each of a plurality of conditions (e.g., tracking conditions), where each condition specifies one or more attributes of the plurality of images or their presentation. Such conditions may include baseline conditions, used before, after, and at specified points during, the exercise to assess the participant's performance (described further below), and non-baseline or training conditions, used for the actual training during the exercise. Thus, blocks of stimuli may contain particular conditions affecting the difficulty of the multiple object tracking task.

The participant may progress through a plurality of levels of the exercise based on the participant's success rate at each level, where each level may be associated with respective subsets of the conditions. Thus, for example, initial levels may include trials performed under the easiest conditions, and successive, more difficult, levels may include trials performed under more difficult conditions. For example, in one embodiment using the GUI of FIG. 46 (or FIG. 43), where the images are bubbles in an underwater scene, and the target images include hidden jewels to be collected by the participant, each time the participant collects all the jewels in a trial, a pearl may be added to the bonus counter 4606, here shown with two pearls, and when the bonus counter is full, the participant may progress to the next level, where trials are performed under more difficult conditions.

In some embodiments, the exercise may include multiple levels, e.g., two levels, e.g., a first, easier, level, in which no occluders are used, and a second, more difficult, level, in which occluders are used. The user may choose which of these “levels” to use at the start, and if the easier one is chosen the user may advance to the harder one after some specified number, e.g., 5, of successful trials. In another embodiment, the two levels may be characterized by the number of images used, where, for example, the first level may use a smaller number of target images, e.g., 3, and the second level may use a greater number of target images, e.g., 7. Of course, in other embodiments, there may be more than two levels, and the levels may utilize any of various conditions.

In some embodiments, the conditions may specify one or more of: movement of the target images and the distracter images, sizes of the target images and the distracter images, presentation time of the target images and the distracter images, including the first time period and/or the second time period (see 4104 above), eccentricity of initial locations of the target images, number of occluders in the visual field, where each occluder is operable to occlude target images and distracter images that move behind the occluder, size of the visual field, and/or visual appearance of the images, e.g., visual emphasis, i.e., visual attributes that enhance distinction of the images against the background, e.g., color, luminance or color contrast, homogeneity, etc. of the images, among others. Specifying movement of the target images and the distracter images may include specifying one or more of: speed of the target images and the distracter images, and/or whether or not the target images and the distracter images can overlap. Specifying speed of the target images and the distracter images may include specifying a range of speed for the target images and the distracter images.

The following is one exemplary set of conditions that may be used over the course of the exercise, although other conditions may be used as desired. Note that a condition specifies a group of one or more attributes regarding the images and/or their presentation, including movement, and that the various values of the attributes may thus define a grid of conditions. The below attributes and values are meant to be exemplary only, and it should be noted that in various embodiments, the conditions may specify other attributes and values as desired.

Exemplary Conditions/Attributes

In one embodiment, a condition may specify whether or not the images may overlap, i.e., whether the images may overlap or repel one another, as well as whether or not occluders are included in the visual field. Thus, the possible (four) combinations of these two attributes may include: repel (no overlap) with no occluders, overlap with no occluders, repel with occluders, and overlap with occluders. In one embodiment, these four combinations may characterize four tasks in the exercise. In other words, the exercise may include four different multiple object tracking tasks respectively characterized by these four attribute combinations. Trials in each task may be performed under a variety of other conditions, such as the following:

A condition may specify display size, image size, number of images, and number of occluders. For example, the following are example data (sub)sets for these attributes, and may be referred to as “setups”:

Setup 1: number of images=12, size (i.e., side) of visual field (deg)=14, size of each image (deg)=1.25, number of occluders=2.

Setup 2: number of images=14, size of visual field (deg)=18, size of each image (deg)=1.33, number of occluders=3.

Setup 3: number of images=16, side of visual field (deg)=24, size of each image (deg)=1.5, number of occluders=4.

A condition may also specify various display times for the visual presentation of the images. For example, a condition may specify one of three trial display times: 4, 7, and 10 seconds. In a preferred embodiment, the display time may include only the second time period (of 4108), i.e., the movement portion of the visual presentation, although in other embodiments, the display time may include only the first time period, or both the first time period (of 4106) and the second time period.

A condition may also specify a speed range for movement of the images. For example, a condition may specify one of three speed ranges (e.g., in degrees/second): 2-4 deg/s, 3-6 deg/s, or 5-10 deg/s.

A condition may also specify the eccentricity of the initial positions of the target images with respect to the fixation point (center) of the visual field. For example, one of three eccentricity values may be specified: 5 deg, 10 deg, or 15 deg, although other values may be used as desired.

Note that when angular measures are used (e.g., deg, deg/s), a nominal viewing distance may be assumed, e.g., 57 cm, at which these angular values correspond to linear distances.

In one embodiment, the above conditions may be grouped into a plurality of categories. For example, the categories may respectively include: the four overlap/occluder tasks mentioned above; the above setups; the trial display times; and the speed ranges, although other categories may be used as desired.

Thus, each condition may specify values for each of the above attributes (or others), possibly in the categories or groupings presented, although it should be noted that other organizations of the data are also contemplated.

The following describes a trial in one exemplary embodiment of the Jewel Diver version of the exercise:

Trial Initiation:

The participant may initiate a trial by clicking a Start button presented in the GUI.

Stimulus Presentation:

14 non-overlapping circular bubbles may be displayed in a presentation region (i.e., visual field) of the screen, and 1-7 of the bubbles may be designated and indicated or highlighted as targets (containing illustrations of gems) for approximately two seconds, after which a 4-second period may follow when all 14 bubbles appear identical (no highlighting of targets) and are moving on the screen. The initial direction of motion may be random at first, and on each frame there may be a 5% chance that either the speed or the direction of motion of each stimulus will change at random. Stimuli may change direction when they contact either a border of the presentation region or another stimulus.

Participant Response:

The participant may click on bubbles to identify targets, where the number of available clicks equals the number of targets. After each correctly identified target, reward feedback may be given in the form of a “ding” sound, points, and an animation of the jewel moving to the jewel counter. After each incorrect response, a “thunk” sound may be played. After the participant has used all the available clicks, if all targets were correctly identified, an additional animation may play, otherwise if one or more targets were incorrectly identified, no additional animation may be played. Finally, the Start button may be displayed again, whereby the participant may invoke the next trial.

In one embodiment, the repeating may include modifying or adjusting the stimulus intensity of the presented stimuli based on the participant's response. For example, as noted above, in a preferred embodiment, the stimulus intensity may be the number of target images presented. Thus, in each trial, and in response to the participant's indicated selection of the target images, the stimulus intensity, i.e., the number of target images, may be adjusted for the next trial's visual presentation, i.e., based on whether the participant indicated all the target images correctly (or not). The adjustments may generally be made to increase the difficulty of the stimulus when the participant answers correctly a first specified number of times in a row, e.g., increasing the number of target images by one, and to decrease the difficulty of the stimulus when the participant answers incorrectly a second specified number of times in a row, e.g., decreasing the number of target images by one. Moreover, the adjustments may be made such that a specified level of performance, i.e., level of success, is approached and substantially maintained during performance of the exercise. For example, based on the participant's responses, the intensity of the multiple object tracking may be adjusted to substantially achieve and maintain a specified success rate, e.g., 85% or 90%, for the participant, although other success rates may be used as desired. In one embodiment, the exercise may begin with 3 target images, although in other embodiments, this initial value may be determined by a pre-exercise calibration or threshold determination, as described above in detail.

In preferred embodiments, the adjustments may be made using a maximum likelihood procedure, such as a QUEST or ZEST threshold procedure, described above. In some embodiments, these adjustments (e.g., using ZEST) may be determined on a per condition basis. In other words, for each condition, the multiple object tracking may be presented (and adjusted) in accordance with a maximum likelihood procedure (e.g., ZEST) applied to trials under that condition, e.g., a single-stair ZEST procedure. Moreover, as also described above, the repeating may also include performing threshold assessments in conjunction with, or as part of, the exercise, e.g., using a dual-stair ZEST procedure.

In some embodiments, the presenting, requiring, determining, and modifying may compose performing a trial, and certain information may be saved on a per trial basis. For example, in one embodiment, for each trial, the method may include saving one or more of: which track was used in the trial, the number of target images used in the trial, the number of distracter images presented to the participant in the trial, the participant's selection, the correctness or incorrectness of the participant's response, the mean of a posterior probability distribution function for the maximum likelihood procedure, and the standard deviation of the posterior probability distribution function for the maximum likelihood procedure, among others. Of course, any other data related to the trial may be saved as desired, e.g., the distinguishing attribute of the target image, eccentricity of the target image, and/or any other condition of the tracking (MOT) task.

Additionally, in some embodiments, various parameters for the maximum likelihood procedure besides the respective (initial) durations of the two tracks may be initialized, such as, for example, the standard deviation of a cumulative Gaussian psychometric function for the maximum likelihood procedure, and/or the standard deviation of a prior threshold distribution for the maximum likelihood procedure.

In one embodiment, the method may include determining the initial anticipated threshold. For example, the initial anticipated threshold may be determined based on one or more of: the age of the participant, calibration trials performed by the participant, and/or calibration trials performed by other participants, e.g., in a “pilot” program, although it should be noted that any other type of information may be used as desired to determine the initial anticipated threshold.

As described above, in some embodiments, other schemes may be employed to adjust the stimulus intensity and perform assessments. For example, in some embodiments, a single-stair N-up/M-down procedure may be used to adjust the stimulus intensity of the multiple object tracking exercise stimuli during training, and a 2-stair N-up/M-down procedure may be employed for the assessments. It should be noted that other features described above may also apply in these embodiments, e.g., adjusting the stimulus intensity to approach and substantially maintain a specified success rate for the participant, and so forth. In other words, the use of N-up/M-down procedures does not exclude other aspects of the methods disclosed herein that are not particularly dependent on the use of maximum likelihood procedures.

In one embodiment, one or more auxiliary trials, referred to as “Eureka trials”, may be performed periodically, e.g., every 20 trials in the exercise, in which the stimulus intensity, e.g., the number of target images, is deliberately set to be below the current value used in the exercise. For example, each such trial may be a non-ZEST trial that is easier than trials performed with the current threshold estimate, e.g. the stimulus intensity may be (temporarily) set at 75% of current the current threshold/intensity, although other values may be used as desired. These trials may help encourage the participant to continue with the exercise.

In some embodiments, the method may also include performing a plurality of practice trials, i.e., prior to performing the method elements described above. For example, in some embodiments, one or more practice sessions may be performed prior to the beginning of training to familiarize the participant with the nature and mechanisms of the task. In each practice session, a specified number of trials (e.g., 5) for each of one or more practice conditions may be performed. In some embodiments, the participant may be able to invoke such practice sessions at will during the exercise, e.g., to re-familiarize the participant with the task at hand.

Exemplary Exercise Flow

In light of the above description, the following presents an exemplary flow of the exercise, according to one embodiment, although it should be noted that this particular embodiment is not intended to limit the exercise to any particular flow, schedule, or scheme. In this embodiment, the exercise requires 10 hours of training. The exemplary flow is as follows:

First, a practice session may be performed, including 5 trials for each of the four task types, i.e., Repel/Overlap/Repel+occluders/Overlap+occluders. A first, pre-training, assessment may then be performed, after which training on all task types may be performed. A second assessment may be performed after 25% of training has been completed, after which training continues on all tasks. A third assessment may be made after 50% of training has been completed, then training continues on all tasks. A fourth assessment may be made after 75% of training has been completed, then training continues on all tasks. Finally, a fifth assessment may be performed after 100% of the training has been completed. Of course, in other embodiments, the assessments may be performed at other points in the exercise as desired.

Eye Movement Exercise

Below are described various embodiments of a cognitive training exercise that utilizes guided eye movement to renormalize and improve the ability of the visual nervous system of a participant to perform eye movements efficiently, and to improve cognition. More specifically, the exercise may operate to improve the efficiency of saccades and decrease the time it takes to extract accurate information from a scene.

In embodiments of this exercise, the participant is required to move his or her gaze rapidly to a series of targets presented on the monitor in a specific order, and obtain information from each target fixation. The participant then responds to this information, where the type of response required depends upon the particular version of the exercise. Note that the information contained in each stimulus should be small enough to require the participant to move their fixation to the target to process it.

It should be noted that various embodiments of the Eye Movement exercise described herein, and/or other eye movement tasks, may be used singly or in combination in the exercise. Moreover, as described below, in some embodiments, stimulus threshold assessments may also be performed in conjunction with, or as part of, the exercise, thus facilitating more effective training of the participant's cognitive systems, e.g., memory and visual processing systems.

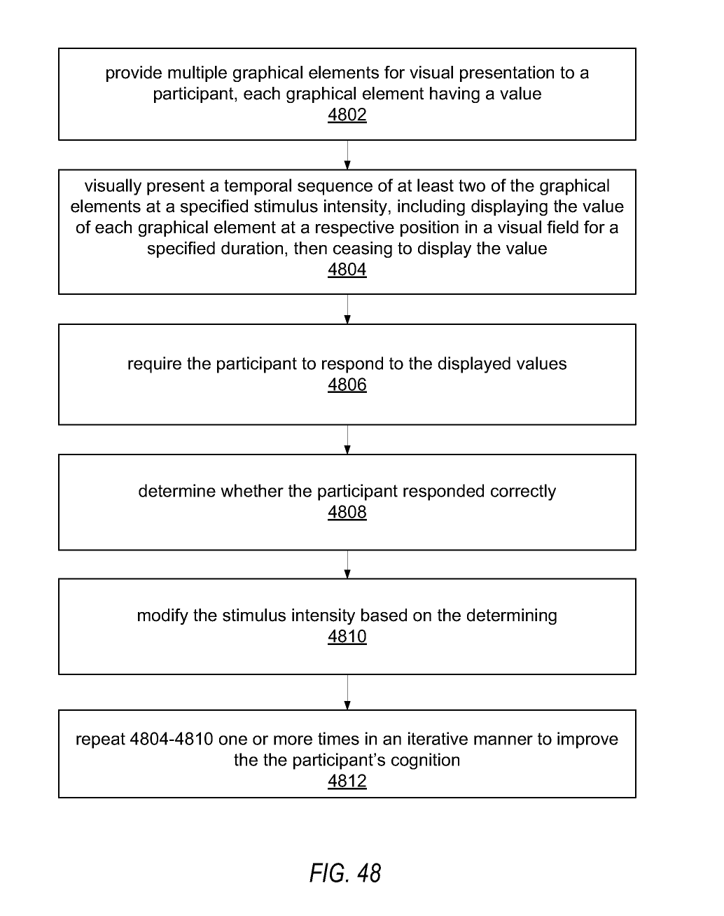

FIG. 48—Flowchart of a Method for Cognitive Training Using Eye Movement

FIG. 48 is a high-level flowchart of one embodiment of a method for cognitive training using eye movement. More specifically, the method utilizes a computing device to present a plurality of images, including a target image and a plurality of distracter images, from which the participant is to select the target image, and to record responses from the participant. It should be noted that in various embodiments, some of the method elements may be performed concurrently, in a different order than shown, or may be omitted. Additional method elements may also be performed as desired. As shown, the method may be performed as follows:

In 4802, multiple graphical elements may be provided, where each graphical element has a value, and where the multiple graphical elements are available for visual presentation to the participant. In other words, a set of images may be provided where each image has or is associated with a respective value. For example, as will be discussed below in detail, examples of such graphical elements include, but are not limited to, images of numbers, playing cards, and letter tiles, among others.

In 4804, a temporal sequence of at least two of the graphical elements may be visually presented at a specified stimulus intensity, including displaying the value of each of the at least two graphical elements at a respective position in a visual field for a specified duration, then ceasing to display the value. Said another way, a series of two or more graphical elements (from the multiple graphical elements of 4802) may be displayed in sequence at a specified stimulus intensity, where each of the graphical elements is displayed at a respective location in the visual field, e.g., in a display area of a graphical user interface (GUI). The value of each graphical element may be displayed (at its respective position) for a specified period of time, i.e., a duration, then the respective value is removed from view, e.g., hidden, not displayed, etc. Note that in various embodiments, the displayed values of the graphical elements may be any of a variety of values, such as, for example, numbers, letters, colors, and/or shapes, among others.

As used herein, the term stimulus intensity refers to any adjustable stimulus attribute or adaptive dimension that may be modified to increase or decrease the difficulty of a task. For example, in some embodiments, the stimulus intensity may be the presentation time or duration of each value, and/or the inter-stimulus interval. In some embodiments, the duration of the display of each value and the duration of the inter-stimulus interval (ISI) may together form the stimulus intensity, and may be referred to as the duration of the stimulus. In other words, in various embodiments, the duration may refer to the duration of the display of the values and/or the ISI. Thus, the stimulus intensity may be compound or complex.

It should be noted that while in preferred embodiments, the stimulus intensity may be or include the duration, in other embodiments, the stimulus intensity may include one or more of: the eccentricity of the respective positions of the least two graphical elements in the visual field, the number of graphical elements in the temporal sequence, and/or the appearance or visual emphasis of the graphical elements, e.g., the size, contrast, color, homogeneity, etc., of the graphical elements in the visual field, among others. In other words, the stimulus intensity may refer to any adjustable attribute of the stimulus and/or its presentation that may be modified to increase or decrease the difficulty of trials in the exercise.

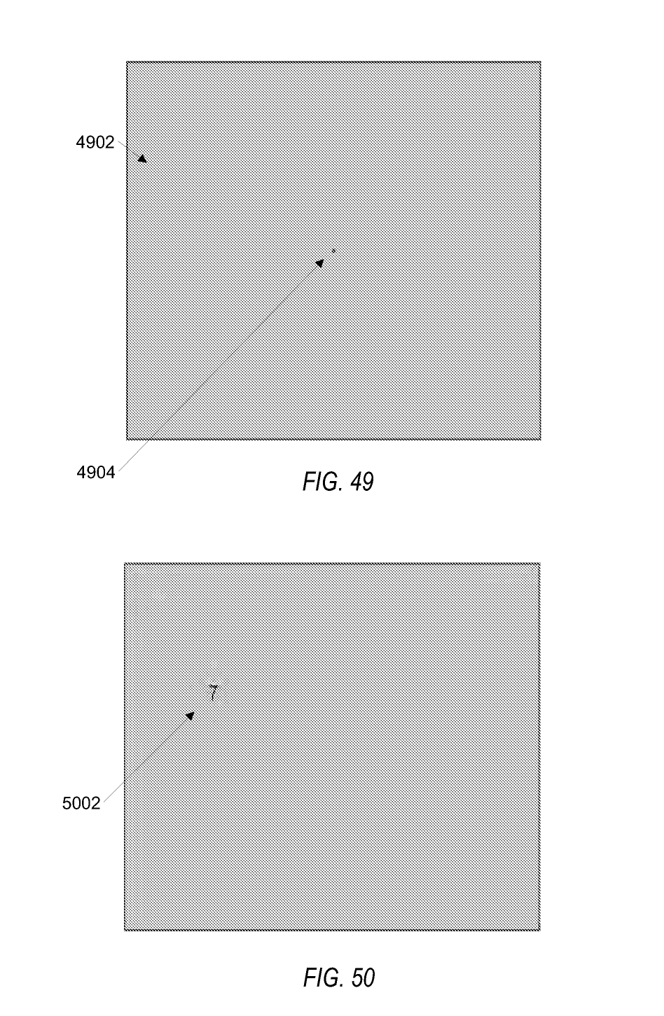

As indicated above, in preferred embodiments, the participant may perform the exercise via a graphical user interface (GUI). FIG. 49 is an exemplary screenshot of a simple GUI suitable for some embodiments of the exercise described herein. As FIG. 49 shows, the GUI may include a visual field or display area 4902, e.g., a stimulus presentation area where the sequences of graphical elements of may be presented to the participant. As FIG. 49 also shows, in some embodiments, the visual field may include a fixation point 4904, which in this case is displayed in the center of the visual field 4902. The fixation point may serve as a reference point in the visual field for positioning graphical elements, and/or as a neutral point for the participant's gaze, e.g., before the sequence is presented. Note that in some embodiments, the fixation point may not be displayed.

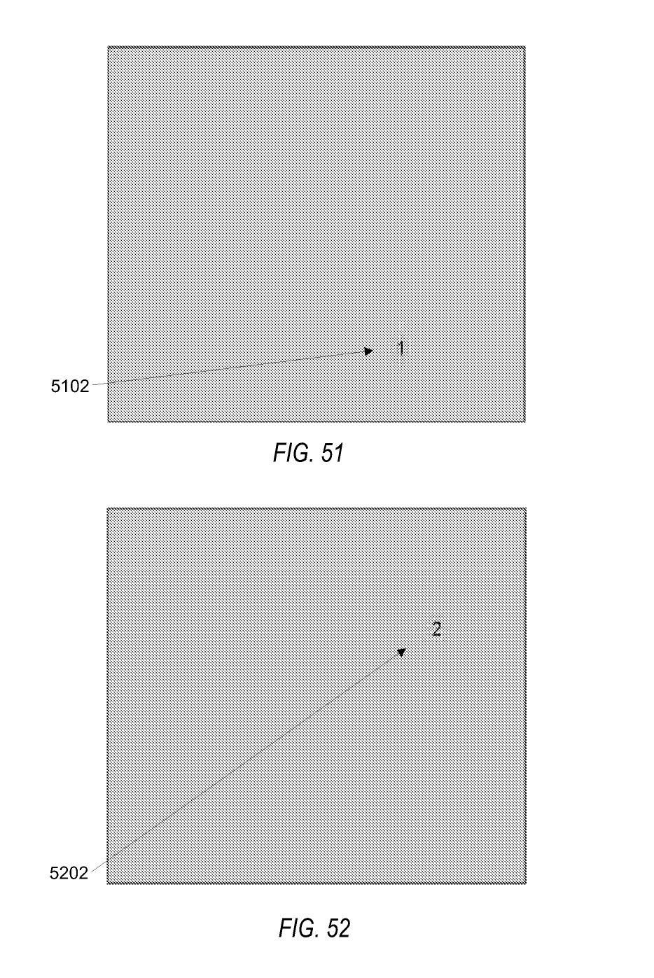

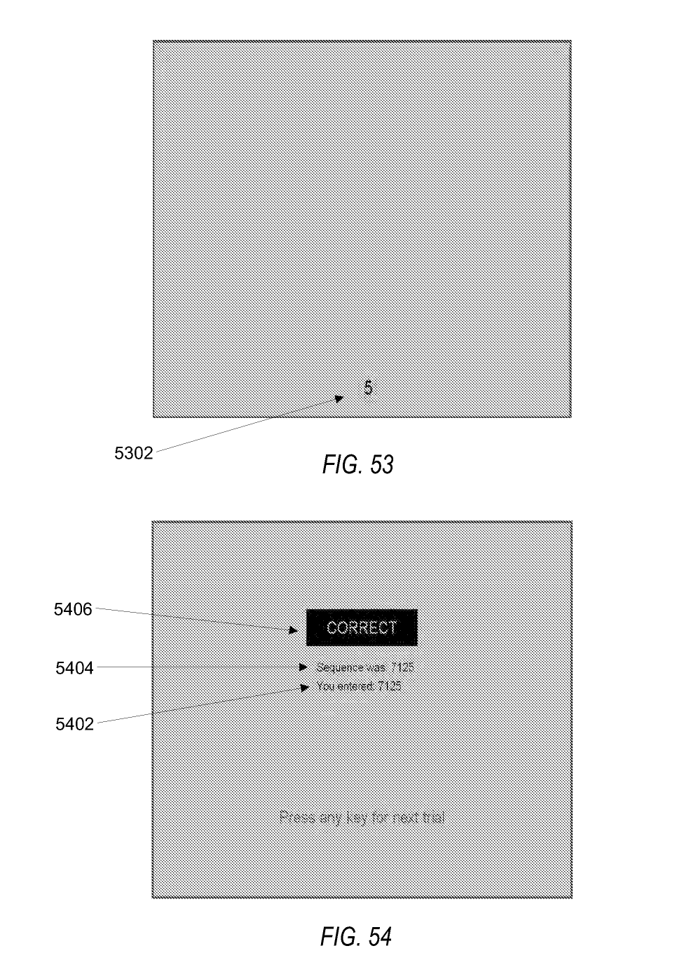

FIGS. 50-53 are exemplary successive screenshots of the GUI of FIG. 49, wherein a sequence of numbers are respectively displayed (at respective positions). More specifically, FIG. 50 illustrates the visual presentation of the number seven 5002, FIG. 51 illustrates the visual presentation of the number one 5102, FIG. 52 illustrates the visual presentation of the number two 5202, and FIG. 53 illustrates the visual presentation of the number five 5302. Note that each number is displayed in a respective position in the visual field such that to view or examine each graphical element (number) in the sequence, the participant must move his or eyes across the visual field. In other words, to perceive the values presented, the participant may be required to perform saccades, quickly moving the eyes to focus at each position.

In some embodiments, the respective positions of the at least two graphical elements may be determined randomly. For example, the first graphical element of the at least two graphical elements may have a first position (randomly determined) with a first azimuth, and each subsequent graphical element of the at least two graphical elements may have an azimuth differing from that of the previous graphical element by a respective angle. In other words, the position of the first graphical element in the presented sequence may be randomly chosen or selected, possibly subject to one or more constraints, e.g., range constraints, as will be discussed below. This first position has an azimuthal angle with respect to some reference vector, e.g., a vector from the center fixation point straight up to the center of the top edge of the visual field. For example, referring back to FIG. 50, the displayed “7” has an azimuth of approximately −70 degrees, e.g., ˜70 degrees counter-clockwise from “12 o'clock”. Each succeeding graphical element/value may be positioned by randomly determining a distance from the fixation point (again, possibly subject to one or more constraints), and randomly determining respective angle, i.e., an angular offset, from the azimuth of the first graphical element.

For example, in one embodiment, the respective angle is a randomly determined angle between approximately 90 and approximately 180 degrees, or between approximately −90 and approximately −180 degrees. Mathematically expressed, the angle may be ±(90+random(90)) degrees. A primary purpose of the different positions of the graphical elements is to force the participant to move his or her eyes substantially to focus on each graphical element. Of course, other schemes for distributing the graphical elements in the visual field may be used as desired. For example, in some embodiments, one or more low discrepancy sequences may be used to select or determine positions of the graphical elements in the visual field.

In one embodiment, the values of the sequenced graphical elements may be displayed in respective “patches” or local backgrounds, e.g., to aid or hinder the participant's perception of the values. For example, as illustrated in FIGS. 50-53, in one embodiment, each value may be displayed in a respective Gabor patch in the visual field, where, as used herein, a Gabor patch refers to a windowed sinewave modulated grating or pattern that varies in luminance (roughly equivalent to the phenomenal experience of lightness) as a sine function of space along a particular direction or orientation, e.g., windowed by a 2-dimensional Gaussian to remove sharp edges which otherwise introduce high spatial frequency intrusions. As FIGS. 50-53 show, each Gabor patch may have a respective orientation, where, after a first displayed value of the at least two graphical elements, each Gabor patch orientation may be rotated a specified amount with respect to an immediately previous Gabor patch. In other embodiments, other background patches may be used as desired.

Note that the embodiment illustrated in FIGS. 49-53 (and 54, described below) is but one example of the exercise, and that other, more complex, embodiments are contemplated, as described below in detail.

In 4806, the participant may be required to respond to the displayed values. For example, following the exemplary embodiment of FIGS. 49-53, where a series of numbers were presented in temporal sequence, the participant may be required to input or otherwise indicate the numeric sequence, e.g., via a keyboard coupled to the computing device, although any other means may be used as desired. In other words, requiring the participant to respond to the displayed values may include requiring the participant to indicate the sequence of the displayed values. As will be described in detail below, other embodiments of the exercise may use other types of graphical elements (besides simple numbers), and may require correspondingly different responses from the participant.

In 4808, a determination may be made as to whether the participant responded correctly. For example, following the embodiment of FIGS. 49-53, a determination may be made as to whether the participant correctly indicated the numeric sequence presented respectively in FIGS. 50-53. In preferred embodiments, the method may include audibly and/or graphically indicating whether the participant responded correctly. In embodiments where the participant's response includes a plurality of selections, indicating whether the participant responded correctly may include indicating whether the participant's selection is correct for each selection, e.g., for each selection, an indicative sound, such as a “ding” or “thunk” (and/or a graphical indication) may be played indicating whether that selection were correct or incorrect, respectively. In some embodiments, points may be awarded (in the case of a correct response and/or selection). Of course, any other type of indication may be used as desired. For example, in embodiment where a trial includes multiple selections, a first sound, e.g., a wind sound, may be played when the participant makes a correct selection, and a second sound, e.g., a chime sound, may be played when the participant has made all selections in the trial correctly.

Following the embodiment of FIGS. 49-53, FIG. 54 is an exemplary screenshot displaying the participant's response 5402, i.e., the numeric sequence entered by the participant, 7125, the presented sequence 5404, also 7125, and an indication of the correctness/incorrectness of the response 5406, in this case, an indication that the participant responded correctly-specifically, the word CORRECT. As FIG. 54 also shows, in this embodiment, instructions are provided for initiating the next trial in the exercise, e.g., the next visual presentation of a sequence.

In some embodiments, each response of the participant may be recorded. Similarly, in some embodiments, the method may include recording whether the participant responded correctly. For example, the responses and/or their correctness/incorrectness may be stored in a memory medium of the computing device, or coupled to the computing device.

In 4810, the stimulus intensity, e.g., duration, may then be modified based on the above determining. Of course, as mentioned above, the stimulus intensity may be any adjustable attribute of the graphical elements and/or their presentation, and so modifying the stimulus intensity may include modifying any of these adjustable attributes as desired. Modifying the stimulus intensity based on said determining preferably includes adjusting the stimulus intensity for the visually presenting based on whether the participant responded correctly, e.g., depending on whether the participant responded correctly (or incorrectly) a specified number of times in a row.

In one embodiment, the adjusting may be performed using a maximum likelihood procedure, such as, for example, a QUEST a ZEST threshold procedure, e.g., a single-stair maximum likelihood procedure, as described above in detail. In other embodiments, an N-up/M-down procedure may be used, as also described above.

In one embodiment, adjusting the stimulus intensity may include decreasing the duration if the participant responds correctly, and increasing the duration if the participant responds incorrectly. Thus, for example, in one embodiment, the duration may be set initially at 500 ms, and may adapt based on performance. In one modification scheme, after a correct response the duration may be multiplied by 0.8, and after an incorrect response, divided by 0.8. The inter-stimulus interval may be fixed at 200 ms for every trial. The results of this scheme are summarized thusly:

Initial trial: <500 ms>-<200 ms>-<500 ms>-<200 ms>-<500 ms>

After correct: <400 ms>-<200 ms>-<400 ms>-<200 ms>-<400 ms>

After incorrect: <625 ms>-<200 ms>-<625 ms>-<200 ms>-<625 ms>

In some embodiments, the duration may have minimum and maximum values, e.g., a minimum of 40 ms, and a maximum of 1000 ms. Of course, other modification schemes (and other ISI values) may be used as desired.

In 4812, the visually presenting, requiring, determining, and modifying may be repeated one or more times in an iterative manner to improve the participant's cognition. For example, the repetitions may be performed over a plurality of sessions, e.g., over days, weeks, or even months, e.g., for a specified number of times per day, and for a specified number of days.

The above described visually presenting, requiring, determining, and modifying may compose performing a trial in the exercise. In preferred embodiments, the repeating may include performing a plurality of trials under each of a plurality of conditions, where each condition specifies one or more attributes of the at least two graphical elements or their presentation.

In some embodiments, over the course of performing the plurality of trials, the stimulus intensity may be adjusted (i.e., the modifying of 4810) to approach and substantially maintain a specified success rate for the participant. For example, the stimulus intensity may be adjusted to approach and substantially maintain a specified success rate for the participant uses a single stair maximum likelihood procedure, or an N-up/M-down procedure. Moreover, in further embodiments, the adjusting the stimulus intensity to approach and substantially maintain a specified success rate for the participant may be performed for each of the plurality of conditions, as will be discussed in more detail below.

Further Exemplary Embodiments

The below describes exemplary embodiments of more complex versions of the Eye Movement exercise, although it should be noted that various aspects of the embodiments described herein may be utilized with respect to any other embodiments of the exercise as desired.

In one embodiment, visually presenting the temporal sequence of at least two of the graphical elements may include visually presenting a first plurality of the graphical elements in a spatial arrangement in the visual field, where each graphical element in the first plurality of graphical elements has a respective position, and where the at least two graphical elements are included in the first plurality of graphical elements. In other words, prior to displaying the sequence of (at least two) graphical elements, the set of graphical elements from which the sequence of graphical elements are taken may be presented in the visual field in a specified arrangement. The particular arrangements used may be specified by the conditions under which trials are performed.

For example, where the visual field has a fixation point in the center of the visual field (see, e.g., FIG. 49), each of the first plurality of the graphical elements may be displayed within a specified range of the fixation point. The distance of displayed graphical elements from the center of the visual field (fixation point) may be referred to as the “eccentricity” of the stimuli. In one embodiment, the specified range may include a first range, comprising a first minimum distance from the fixation point, and a first maximum distance from the fixation point, or a second range, comprising a second minimum distance from the fixation point, and a second maximum distance from the fixation point, where the second minimum distance is greater than the first minimum distance, and where the second maximum distance is greater than the second maximum distance. In some embodiments, the second minimum distance may be greater than or equal to the first maximum distance. Thus, the first plurality of graphical elements may be displayed in a rough annulus about the fixation point in the visual field, where the conditions under which the trials are performed may specify the inner and outer radii of the annulus, e.g., constraints on the eccentricity of the stimuli. Note that since the sequence of graphical elements in a trial are selected (e.g., randomly) from the first plurality of graphical elements, thus constraining their respective positions to those in the annulus, the larger the annulus, the more eye movement by the participant is required to view each graphical element in succession, and thus, the more difficult the trial. Thus, for example, in some embodiments, each of the plurality conditions may specify the range of distances from a fixation point in the visual field for the first plurality of graphical elements. These ranges may be specified as radii from the center, e.g., Rmin1: 3 cm, Rmax1: 5 cm, Rmin2: 5 cm, Rmax2: 7 cm; or via angular subtense, e.g., Rmin1: 10 degs, Rmax1: 15 degs, Rmin2: 15 degs, Rmax2: 20 degs.

Other aspects of the sequence of graphical elements or their presentation may include: the number of graphical elements in the first plurality of graphical elements, the number of graphical elements in the presented sequence of the at least two graphical elements, whether the durations of the visually presenting overlap, complexity of the graphical elements, and/or visual emphasis, i.e., distinguishability of the graphical elements from a background displayed in the visual field, among others.

Thus, over the course of the exercise, the conditions may range from easier to more difficult. For example, the conditions may include combinations of various categories of attributes of the graphical elements or their presentation. Examples of the categories include: gap/overlap categories, where in the gap category, the current stimulus disappears before the next one is presented, and in the overlap category, the current stimulus remains on for a short period of time (e.g. 0.25 s) after the next one is presented; stimulus complexity categories, where, in the easy categories, stimuli may be easy (e.g. data strings embedded in Gabor patch stimuli that rotate orthogonally on each presentation), while in more advanced stimulus categories, the stimuli may be objects (e.g. faces, pictures, cards); emphasis level categories, where at easier levels, the presented values may be easily distinguishable from the background, and at harder levels, the values may be less distinct from the background information; serial or sequence size categories, where a beginning level may start with an easier serial size (e.g. 2 items), and at higher levels, the size may expand to 3 and 4; and stimuli distance categories, where each level may have an associated annular distance (and possibly thickness) for display of the first plurality of graphical elements (which also applies to the presented sequences, since they are from this first plurality of graphical elements). However, these various conditions, categories, levels, and progressions are meant to be exemplary only, and are not intended to limit the exercise to any particular set of conditions, categories, levels, or progressions.

Note that displaying the first plurality of graphical elements does not include displaying their values, but rather, establishes spatial positions for any graphical elements selected for the visually presented sequences. Moreover, in some embodiments, when, or prior to, the visual presentation of the at least two graphical elements (and their values), the first plurality of graphical elements may be removed from view. In other words, the first plurality of graphical elements may disappear from the visual field before the particular sequence of graphical elements (and their values) are visually presented.

Card Match

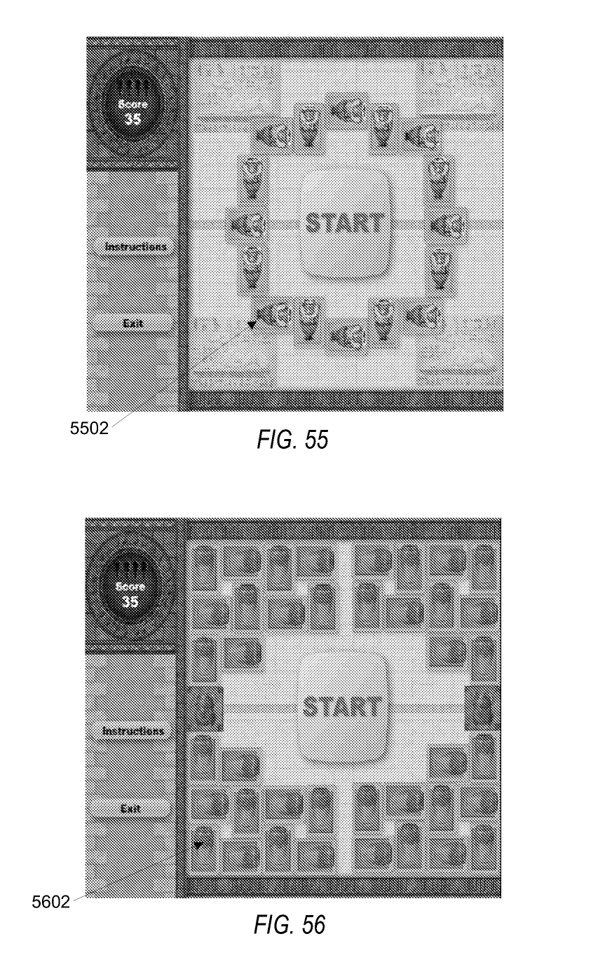

FIGS. 55-60 are directed to embodiments of the exercise where the multiple graphical elements are playing cards, e.g., where the value of each graphical element includes the playing card's suit and rank or value, e.g., a 10 of hearts, although any other types of cards may be used as desired. In this version of the exercise, referred to herein as Card Match, after a sequence of playing cards are presented, the participant is required to match each (remembered) card in the sequence to a respective card displayed elsewhere on the screen, as will be discussed in more detail below.

In this version of the exercise, visually presenting the first plurality of the graphical elements in a spatial arrangement in the visual field may include visually presenting a first plurality of the playing cards face down (meaning with their values not displayed) at respective positions in the visual field, i.e., the values of the graphical elements are not displayed. Similarly, the at least two graphical elements are at least two playing cards, and visually presenting the temporal sequence of at least two of the graphical elements includes revealing the respective values of the at least two playing cards in sequence, where for each of the at least two playing cards, the value is displayed for the duration, then the playing card is turned face down. In some embodiments, revealing the respective values of the at least two playing cards in sequence may include displaying the values of the at least two playing cards in sequence for respective durations, separated by a specified inter-stimulus interval (ISI). In various embodiments, the ISI may be held constant, e.g., at 200 ms, as mentioned above, or may be adjusted, e.g., as part of the duration, or as specified by the various conditions under which trials are performed. Note, for example, that negative values for the ISI result in overlap between the durations or presentation times of the values, where, for example, each succeeding value is presented before the previous value is removed from view.

In one embodiment, visually presenting the temporal sequence of at least two of the graphical elements may include highlighting the at least two cards, where after turning the at least two playing cards face down, the highlighting is maintained. This may reduce confusion in the participant regarding which of the first plurality of cards were sequenced. In some embodiments, prior to the revealing of values of the sequence of playing cards, the first plurality of playing cards may be removed from view. In other words, just before the sequence is visually presented, the first plurality of graphical elements, in this case, the first plurality of playing cards, may disappear.

As described above, in one embodiment, the respective positions of the visually presented graphical elements (in this case, playing cards) may be determined randomly, e.g., where the position of the first graphical element of the at least two graphical elements is randomly selected, and has a first azimuth, and where each subsequent graphical element of the at least two graphical elements is positioned at a random distance from the center of the visual field, and an azimuth differing from that of the previous graphical element by a respective randomly determined angle. The respective angle may be a randomly determined angle between approximately 90 and approximately 180 degrees, or between approximately −90 and approximately −180 degrees. Mathematically expressed, the angle may be ±(90+random(90)) degrees. As noted above, a primary purpose of the different positions of the graphical elements is to force the participant to move his or her eyes substantially to focus on each graphical element. However, other schemes for distributing the graphical elements in the visual field may be used as desired.

FIG. 55 is an exemplary screenshot of a GUI for such an embodiment using playing cards. As FIG. 55 shows, the first plurality of playing cards is displayed in a ring 1002 around the center or fixation point of the visual display. In this particular case, the distance range of the playing cards from the center of the visual display is fairly small, and the first plurality of playing cards includes a fairly small number of playing cards, e.g., 16, although other numbers may be used as desired.

As FIG. 55 indicates, in some embodiments, besides the visual field, additional GUI elements may be provided, e.g., for indicating various aspects of the participant's progress or status with respect to the exercise or task, invoking help, etc. For example, the GUI may include one or more of: a score indicator that indicates the participant's current score in the task or exercise, as shown in the upper left corner of FIG. 10, a Start button (or functional equivalent), whereby the participant may invoke the next trial in the exercise, an instruction button (or equivalent), whereby the participant may invoke instructions or other helpful information for the task, and an exit button for exiting the exercise, among others.

Note that any other GUI elements may be included as desired. For example, in some embodiments, the GUI may include one or more of: a time remaining indicator that provides an indication of how much time remains in the current task, session, or exercise, a threshold field that displays stimulus threshold information, such as the current threshold value and a best threshold value, where a threshold indicates or is the value of the adjustable stimulus intensity, that results in a specified performance level, i.e., success rate, for the participant, as will be explained below in more detail. However, it should be noted that these particular GUI elements are meant to be exemplary only, and are not intended to limit the GUIs contemplated to any particular form, function, or appearance.

FIG. 56 is another exemplary screenshot of the GUI for an embodiment using playing cards. As FIG. 56 shows, in this case, the first plurality of playing cards is displayed in a larger ring 5602 around the center or fixation point of the visual display, where the distance range of the playing cards from the center of the visual display is greater than that of FIG. 55, and where the first plurality of playing cards includes a greater number of playing cards, e.g., 40, although, of course, other numbers may be used as desired. Thus, the trial illustrated in FIG. 56 may be more difficult than the trial illustrated in FIG. 55. In some embodiments, in a first level of the exercise, trials may be performed using the smaller ring/plurality of playing cards, such as that shown in FIG. 55, and in a second level of the exercise, trials may be performed using the greater ring/plurality of playing cards, such as that shown in FIG. 56, although it should be noted that other levels, rings, and pluralities may be used as desired.

In some embodiments, a second plurality of playing cards may be displayed face up, where the second plurality of playing cards includes playing cards with the same values as the at least two playing cards, and one or more distracter cards with different values. As indicated above, in this embodiments, requiring the participant to respond to the displayed values includes requiring the participant to indicate matches between each of the at least two playing cards and respective ones of the second plurality of playing cards. In other words, once the values of the visually presented sequence of playing cards have been displayed or revealed (and then flipped, hidden, or otherwise removed from view), the second plurality of playing cards are displayed, and the participant may successively indicate matches between each playing card in the sequence and one of the second plurality of playing cards. For example, in one embodiment, requiring the participant to indicate matches between each of the at least two playing cards and respective ones of the second plurality of playing cards may include: for each playing card of the at least two playing cards: receiving input from the participant selecting one of the at least two playing cards, and receiving input from the participant selecting a playing card from the second plurality of playing cards as a match for the selected one of the at least two playing cards, e.g., by clicking on each card with a mouse.

In some embodiments, if a card is incorrectly matched, the incorrectness of the selection may be indicated, e.g., with a “thunk” sound, the (e.g., six) cards in the middle of the screen may disappear, the trial may be terminated, and the start button may appear. If all three cards are correctly matched, the correctness of the selection may be indicated, e.g., with a “chime” sound, bonus points may be awarded, the (e.g., six) cards in the middle of the screen may disappear, and the start button may appear.

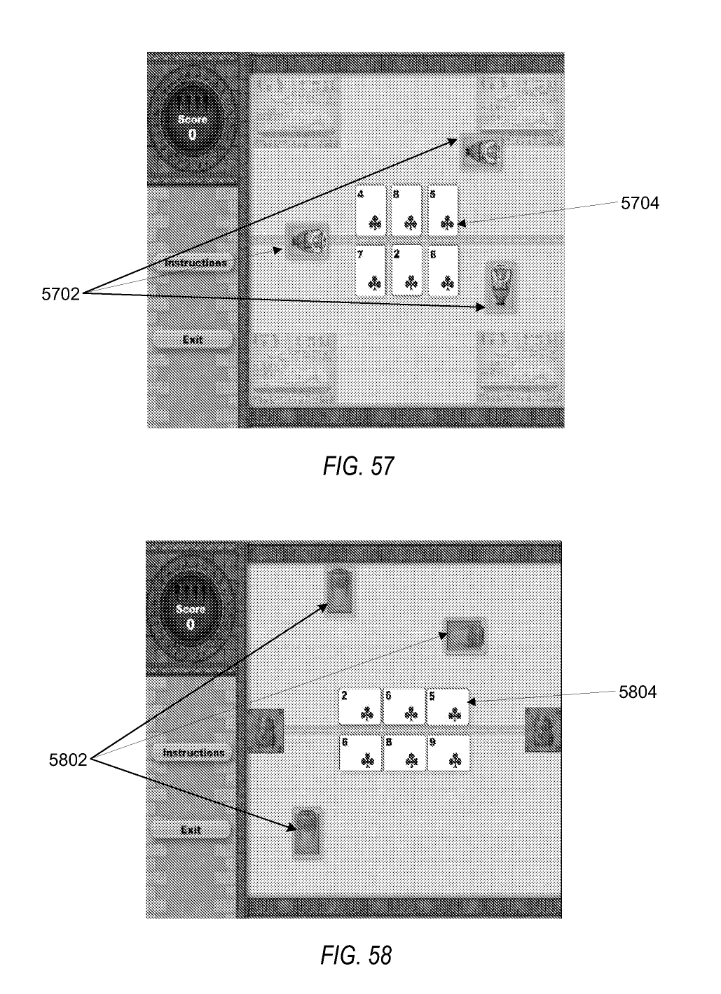

FIGS. 57 and 58 illustrate exemplary successor screenshots of the GUIs of FIGS. 55 and 56, respectively. As each of these figures illustrates, in these embodiments, the first plurality of playing cards has been removed from view, the values of the sequence of playing cards have been displayed, then flipped back face down (5702 of FIG. 57, and 5802 of FIG. 58), and the second plurality of playing cards, in both of these cases, 6 playing cards, have been displayed in the center of the visual field (5704 of FIG. 57, and 5804 of FIG. 58). Thus, in both cases, the second plurality of playing cards includes playing cards with the values of the sequenced cards, plus three additional distracter cards. As described above, the participant may then indicate matches between the cards by successively selecting one of the playing cards in the sequence (5702/5802), then selecting one of the playing cards (5704/5804) displayed in the middle of the visual field as a match, until all the sequenced cards have been matched. In preferred embodiments, the method may further include removing correctly matched playing cards from the visual field. Thus, as the participant successfully performs trials in the exercise, the first plurality of playing cards may be reduced in number until depleted. In various embodiments, at this point, the exercise may continue with a new first plurality of playing cards, e.g., at the same or a higher level, or the exercise may end, at least for the current session.

Note that in embodiments directed to playing cards, such as described above, the conditions under which trials are performed may specify further aspects of the graphical elements or their presentation. For example, in some embodiments, each of the plurality conditions may further specify whether the at least two playing cards are of the same suit, and/or whether the suit of the at least two playing cards can change for each trial.

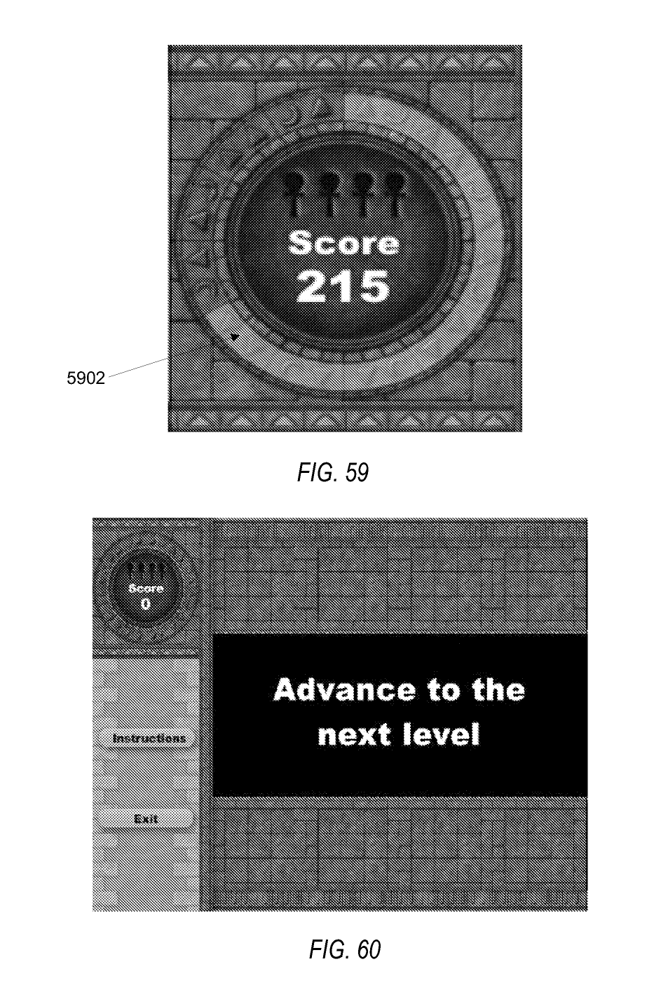

In some embodiments, bonus points may be awarded and indicated, e.g., for when the participant successfully performs a trial, e.g., matches all the sequenced cards correctly, or, as another example, when the participant successfully performs a specified number of trials consecutively, e.g., 5 times in a row. Thus, in some embodiments, the GUI may also include a bonus meter (or equivalent), which may indicate such bonus awards. Note that this may be in addition to the awarding of bonus points. One embodiment of such a bonus indicator is included in the score display of FIGS. 55-58, where, for example, each time the participant successfully performs a trial, the ring around the numeric score is incrementally filled in, e.g., a “gold piece” is added to the ring, as illustrated in FIG. 59. This may be performed in addition to awarding bonus points, which may be reflected in the score indicator. Of course, any other kind of bonus indicator may be used as desired, such as a bar meter, filled in bonus stars, etc. In some embodiments, bonuses may instead or also be indicated by flashing graphical elements, graphical animations, playing music, and so forth, as desired.

As noted above, the exercise may include performing trials in a plurality of levels. For example, in one exemplary embodiment of the Card Match version of the exercise, there may be two levels based on the relative closeness of the cards to the central fixation point and the number of suits. For example, in level 1, all cards in all trials may be of the same suit, and the cards may be distributed closer to a central fixation point (see, e.g., FIGS. 55 and 57); in level 2, all cards in given trials may be of the same suit, but the suit can change between trials, and the cards may be distributed further from a central fixation point (see, e.g., FIGS. 56 and 58).

In one embodiment, the participant may be able to choose to start Card Match at level 1, e.g., by choosing an “Easy” button, or at level 2, e.g., by choosing a “Hard” button, in an introductory screen. If Card Match is started at level 1, the participant may advance to level 2 after having filled in the gold circle around the score (e.g., 12 correct trials), as illustrated in FIG. 59. FIG. 60 is an exemplary screenshot instructing the participant to begin the next level. Note that in this embodiment, the score has been reset to zero for the next level.

It should be noted that the Card Match version of the exercise described herein is meant to be exemplary, and such matching versions of the exercise may be performed using any other types of graphical elements and values desired, e.g., tokens, coins, or other elements with values based on colors, shapes, pictures, etc.

Word Finder

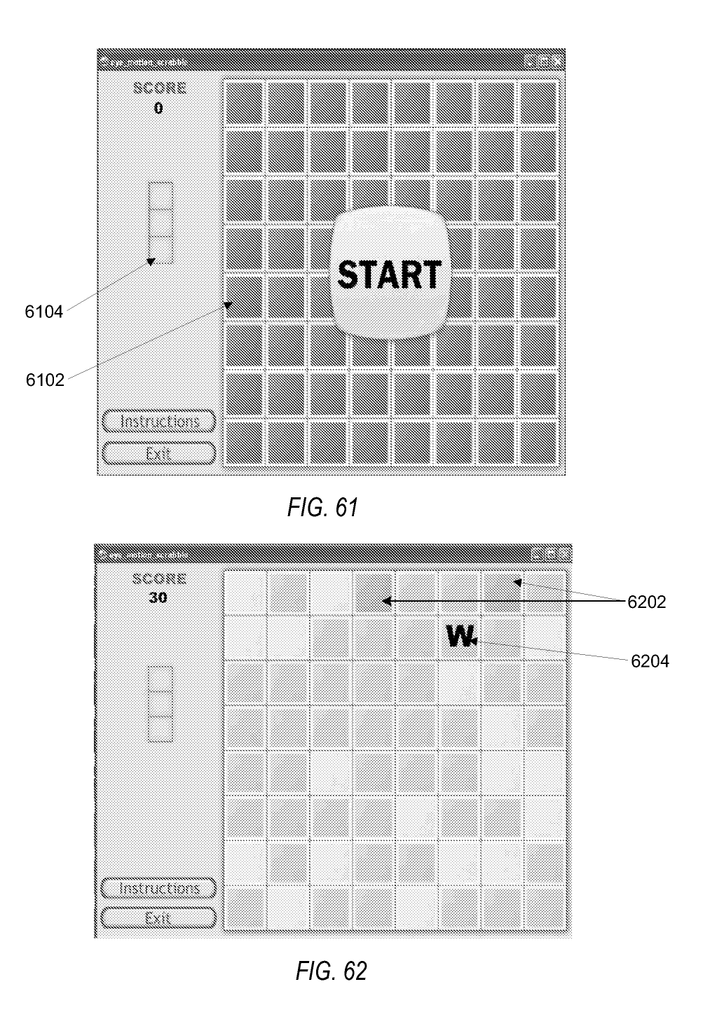

FIGS. 61-65 are directed to embodiments of the exercise where the multiple graphical elements are letter tiles, e.g., where the value of each graphical element is a letter. In this version of the exercise, referred to herein as Word Finder, a sequence of letters representing a scrambled word are presented, where, as with the Card Match version described above, the values of the tiles are shown for a respective specified duration. The participant then attempts to select the tiles in an order that correctly spells the scrambled word, and the stimulus intensity, e.g., the duration or presentation time, of the sequence is modified based on the participant's response, as will be discussed in more detail below.

In this version of the exercise, visually presenting the first plurality of the graphical elements in a spatial arrangement in the visual field may include visually presenting a first plurality of the tiles face down (meaning with their values not displayed) at respective positions in the visual field, i.e., the values of the graphical elements are not displayed. Similarly, the at least two graphical elements are at least two tiles, and visually presenting the temporal sequence of at least two of the graphical elements includes revealing the respective values of the at least two tiles in sequence, where for each of the at least two tiles, the value is displayed for the duration, then the tile is turned face down, i.e., the value ceases to be displayed. Note, however, that in this version of the exercise, the respective letters of the at least two tiles in sequence are a scrambled word. In other words, the sequence of letters (temporarily) presented form a scrambled word, which the participant is expected to unscramble.

As with the Card Match version, in some embodiments, revealing the respective letters of the at least two tiles in sequence may include displaying the letters of the at least two tiles in sequence for respective durations, separated by a specified inter-stimulus interval (ISI), which in various embodiments, may be held constant, e.g., at 200 ms, as mentioned above, or may be adjusted, e.g., as part of the duration, or as specified by the various conditions under which trials are performed.

In one embodiment, the values (e.g., letters) may be assigned to the visually presented graphical elements (e.g., tiles) dynamically. For example, first, the letters of the word may be scrambled, and then each letter (of the scrambled word) may be associated with and presented on the selected tiles, i.e., on the sequence of tiles being visually presented. In other words, in some embodiments, values may not be assigned to graphical elements until the graphical elements are visually presented in sequence.

Note that in some embodiments, the graphical elements of the visually presented sequence may already have respective positions, e.g., as part of the first plurality of graphical elements. In these embodiments, the graphical elements may be selected for inclusion in the sequence by randomly determining the positions, as described above, then selecting the graphical elements (from the first plurality of graphical elements) that are closest to these positions.

In preferred embodiments, visually presenting the temporal sequence of at least two of the graphical elements may include highlighting the at least two tiles, where after turning the at least two tiles face down, the highlighting is maintained, thereby indicating to the participant which of the first plurality of tiles were sequenced. In some embodiments, prior to the revealing of letters of the sequence of tiles, the first plurality of tiles may be removed from view, as described above (and shown in FIGS. 57 and 58) with respect to the Card Match version of the exercise.

FIG. 61 is an exemplary screenshot of a GUI for such an embodiment using tiles. As shown, in this embodiment the GUI includes a grid of tiles 6102 displayed in a visual field of the GUI, e.g., constituting the first plurality of graphical elements corresponding to the spatial arrangement of playing cards described above with respect to the Card Match version of the exercise. As FIG. 61 also shows, the GUI also includes a score indicator, instruction button, and exit button, so labeled, as well as a start button for initiating a trial. As may be seen, the GUI of FIG. 61 also includes a letter or word display 6104, for displaying letters of the tiles selected by the participant. Note that the letter or word display 6104 preferably has the same length as that of the visually presented sequence of letters.

FIG. 62 is an exemplary screenshot of a GUI after a number of trials in the Word Finder version of the exercise have been performed, as evidenced by the various tiles missing from the original grid (of FIG. 61). As FIG. 62 indicates, two tiles 6202 of a three-tile sequence have already been highlighted (here shown in a slightly different color than the other tiles), had their respective letters revealed, and then been turned face down (i.e., display of the letters ceased), and the letter of the third tile in the sequence 6204 is currently displayed, in this case, a “W”. As noted above, the sequence of letters shown or revealed form a scrambled word. In preferred embodiments, the first letter of the (unscrambled) word may always be presented as a capital letter, regardless of when or where in the presented sequence it appears. Thus, in the embodiment of FIG. 62, the participant knows (or should realize) that the unscrambled word begins with the letter w.

Once the sequence of FIG. 62 has been visually presented and display of the letters ceased, the sequenced tiles may remain highlighted, as mentioned above. Requiring the participant to respond to the displayed values may then include requiring the participant to indicate the at least two tiles in a sequence that correctly spells the scrambled word. In other words, the participant may then click on the (possibly highlighted) sequenced tiles in an order that correctly spells the originally scrambled word. Note that in this particular example, the unscrambled word is “Wax”.

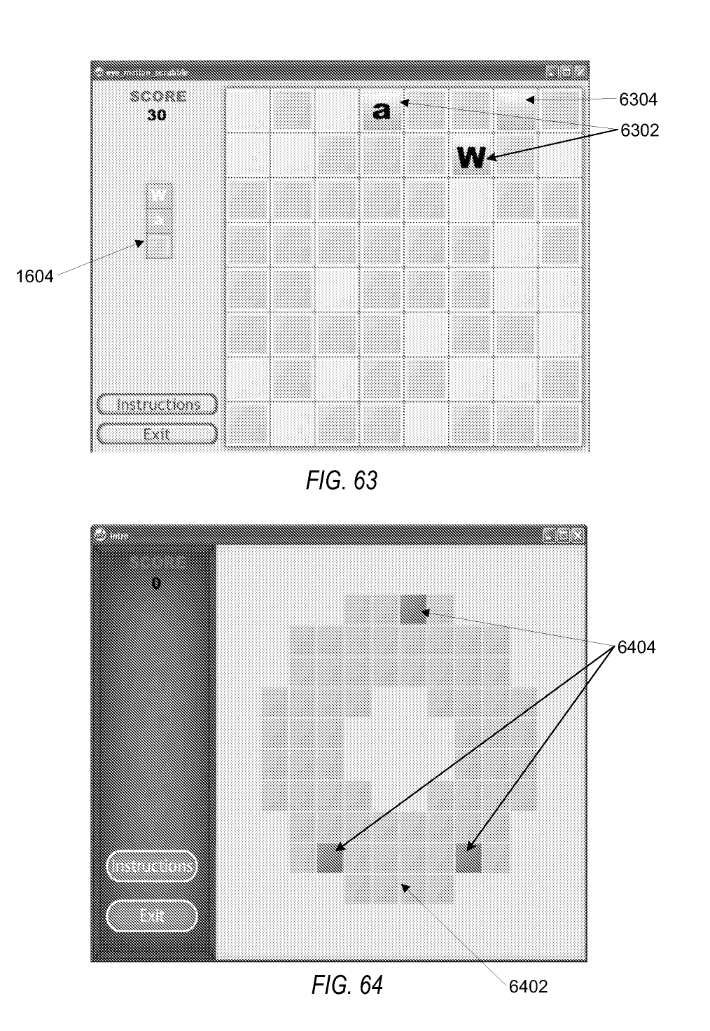

FIG. 63 is an exemplary screenshot illustrating the participant's selection of the tiles to spell the unscrambled word. As indicated, the participant has correctly selected the “W” and “a” tiles 6302 in succession, and so it only remains for the participant to select the third tile 6304 to correctly spell the word. Note that in preferred embodiments, the letters of the word may be displayed as the participant successfully indicates the at least two tiles in a sequence that correctly spells the scrambled word. Thus, as FIG. 63 shows, the letters “W” and “a” are displayed appropriately in the letter or word display 6104. Thus, once the participant selects the third tile (“x”), the completed unscrambled word will be displayed. Note that in the embodiment illustrated in FIG. 63, as the participant selects each tile in the sequence, the tile's letter may be displayed. In some embodiments, the method may include removing correctly matched tiles from the visual field, thus, depleting the first plurality of tiles as the participant successfully performs trials.

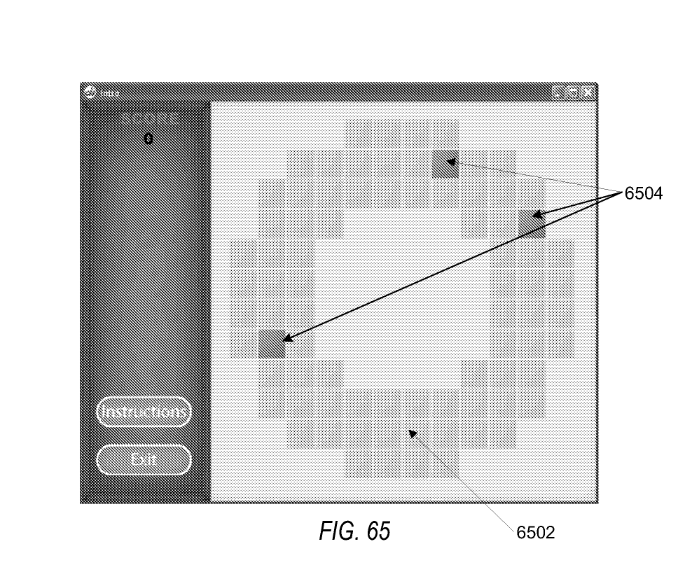

Similar to the Card Match version of the exercise, in some embodiments, rather than displaying the first plurality of tiles in a rectangular grid, as shown in FIGS. 61-63, the tiles may be displayed in annuli (i.e., circular grids) of various sizes, as specified by the various conditions under which trials are performed. FIGS. 64 and 65 illustrate this idea.

FIG. 64 is an exemplary screenshot of a GUI in which the first plurality of tiles is displayed in a ring or circular grid 6402 around the center or fixation point of the visual display. In this particular case, the distance range of the tiles from the center of the visual display is fairly small, and the first plurality of tiles includes a fairly small number of tiles, e.g., 68, although other numbers may be used as desired. Note that the sequenced tiles 6404 are shown highlighted.

FIG. 65 is an exemplary screenshot of a GUI in which the first plurality of tiles is displayed in a larger ring 6502 around the center or fixation point of the visual display as compared to that of FIG. 64, i.e., the distance range of the tiles from the center of the visual display is greater than that of FIG. 64, and where the first plurality of tiles includes a greater number of tiles, e.g., 80, although, of course, other numbers may be used as desired. Thus, the trial illustrated in FIG. 65 may be more difficult than the trial illustrated in FIG. 64. As with the Card Match version of the exercise, in some embodiments, in a first level of the exercise, trials may be performed using the smaller ring/plurality of tiles, such as that shown in FIG. 64, and in a second level of the exercise, trials may be performed using the greater ring/plurality of tiles, such as that shown in FIG. 65, although it should be noted that other levels, rings, and pluralities may be used as desired. In some embodiments, participants can choose to start at level 1 by selecting an “Easy” button, or at level 2 by selecting a “Hard” button. If the exercise is started at level 1, participants may advance to level 2 after they have cleared all the tiles in level 1.

Thus, in one specific exemplary embodiment, a trial may proceed as follows: a sequence of letters that form a three-letter word may be presented randomly one after the other on a circular grid of letter tiles, where each letter is presented briefly on a blank tile before that tile again becomes blank. The tile on which the letter appeared may be highlighted. Additionally, the presentation time for each letter may be the same but may change based on performance. The participant is expected to unscramble and identify the three-letter word. The participant may click on one of the highlighted tiles on which the letters appeared, the letter beneath that tile may be revealed and may be displayed under the score, e.g., in the letter or word display, and a “pop” sound may be played. This may be repeated until all three letters are revealed. If the word is correctly identified, a “ding” sound may play, points may be awarded, the word may be highlighted or displayed under the score, and the start button may appear. If the word is incorrectly identified, a “thunk” sound may play, the word may be removed from under the score, and the start button may appear.

As mentioned above, in preferred embodiments, the modification or adjustment of the stimulus intensity, e.g., the duration of each visual presentation of the value of each graphical element in the sequence, may be performed repeatedly over the course of the exercise based on the correctness or incorrectness of the participant's responses. The adjustments may generally be made to increase the difficulty of the stimulus when the participant answers correctly (e.g., shortening the duration or presentation time), and to decrease the difficulty of the stimulus when the participant answers incorrectly (e.g., increasing the duration or presentation time). Moreover, the adjustments may be made such that a specified level of performance, i.e., level of success, is approached and substantially maintained during performance of the exercise. For example, based on the participant's responses, the stimulus intensity may be adjusted to substantially achieve and maintain a specified success rate, e.g., 85% for the participant, although other rates may be used as desired.

As also mentioned above, in preferred embodiments, the adjustments may be made using a maximum likelihood procedure, such as a single-stair QUEST or a ZEST threshold procedure, described above. In some embodiments, these adjustments (e.g., using a single-stair ZEST procedure) may be determined on a per condition basis. In other words, for each condition (used in each task), the sequences may be presented (and adjusted) in accordance with a maximum likelihood procedure (e.g., ZEST) applied to trials under that condition.

Moreover, as described below, the repeating may also include performing threshold assessments in conjunction with, or as part of, the exercise. In other words, the method of FIG. 48 may include assessing the participant's performance a plurality of times during the repeating. Additionally, the assessing the participant's performance a plurality of times may be performed according to the maximum likelihood procedure, e.g., using a 2-stair maximum likelihood procedure. A description of such threshold determination/assessment is provided above.

As described above, in some embodiments, other schemes may be employed to adjust the stimulus intensity and perform assessments. For example, in some embodiments, a single-stair N-up/M-down procedure may be used to adjust the stimulus intensity of the eye movement exercise stimuli during training, and a 2-stair N-up/M-down procedure may be employed for the assessments. It should be noted that other features described above may also apply in these embodiments, e.g., adjusting the stimulus intensity to approach and substantially maintain a specified success rate for the participant, and so forth. In other words, the use of N-up/M-down procedures does not exclude other aspects of the methods disclosed herein that are not particularly dependent on the use of maximum likelihood procedures.

As noted above, many aspects of the Eye Movement assessment may generally be similar, or possible even identical, to the Eye Movement exercise task with respect to visual presentation. However, some aspects of the Eye Movement exercise may not be necessary in the Eye Movement assessment. For example, with regard to the GUI, in some embodiments, GUI elements such as score indicator, bonus indicator, etc., may not be necessary, and so may be omitted. Features or assets that may remain the same may include the “ding”, “thunk”, and “chime” sounds (or equivalents) that play after a participant responds correctly or incorrectly. The assessment stimulus presentation may also be identical to the training version.

In some embodiments, the method may also include performing a plurality of practice trials, i.e., prior to performing the method elements described above. For example, in some embodiments, one or more practice sessions may be performed prior to the beginning of training to familiarize the participant with the nature and mechanisms of the exercise. For example, in one embodiment, before training begins, the participant may perform at least one practice session comprising a specified number of trials (e.g., 5) for each of one or more practice conditions. In some embodiments, the participant may be able to invoke such practice sessions at will during the exercise, e.g., to re-familiarize the participant with the task at hand.

In some embodiments, additional trials, referred to as “eureka” trials, may be performed periodically, e.g., every 20 trials or so, comprising non-ZEST (or non-N-up/M-down) trials that are easier than the current threshold estimate—e.g. using durations that are twice the threshold. These easier trials may serve to encourage the participant to continue the exercise, and improve or maintain the participant's morale.

Thus, embodiments of the Eye Movement exercise described herein may operate to improve a participant's cognition, including, for example, frequency of saccade, minimal fixation duration (or other stimulus intensity) required to extract information from the visual scene, overall speed and accuracy of visual processing, attention, and/or memory, among others.

Face-Name Association Exercise

Below are described embodiments of a cognitive training exercise that utilizes face-name association (e.g., matching) to improve a participant's cognition, e.g., renormalizing and improving the ability of the visual nervous system of a participant to associate faces with names.

A primary goal of the face-name matching exercise described herein is to improve the ability of the brain to accurately associate or bind faces with their appropriate proper name. An additional goal is to exercise the face processing areas of the brain, for example the fusiform face area, the brain system thought to be responsible for making expert-level visual distinctions. The task may engage the participant in encoding a series of face images, along with their designated names, and then associating the unlabeled face with its appropriate identifier (i.e., name). In some embodiments, the face stimuli may be repeatedly flashed on the screen rather than presented statically, as the visual system is strongly engaged by patterns that alternate at intermediate temporal frequency modulations. Thus, flashing the face rather than presenting it at 0 Hz (i.e., a static image) may more strongly engage the neural systems that support learning. Additionally, the onset of visual presentations of the faces may coincide with a synchronous-onset presentation of the spoken proper name. This synchronous presentation may effectively and repeatedly engage the to-be-associated visual and auditory representations, i.e., the face and name.

Making these face-name associations made under conditions of intense synchronous visual and auditory system activation and high levels of attention and reward may drive changes in the mechanisms responsible for recognizing distinguishable human facial characteristics, remembering proper names, and associating these individual units of information into a cohesive unit for identification. The face-name associations formed in this way may be very robust, allowing individuals to easily and reliably recognize and recall the names of individuals around them based on sight, thus greatly facilitating interaction in a wide array of social situations.

In some embodiments, the presentation time of the stimuli, i.e., the length of time the face is shown, referred to as duration, may adapt to track the participant's performance. For example, as the participant improves in ability to associate faces with names, the presentation time or duration may be decreased, thereby making the association task more difficult. Similarly, if the participant does not improve, the presentation time or duration may be increased. Thus, in some embodiments, an adaptive rule or procedure may be used with respect to the stimulus presentation.

A range of conditions may be used in the training, including faces with different views (e.g., profile, front), genders, ages, expressions, and so forth, as will be discussed in more detail below.

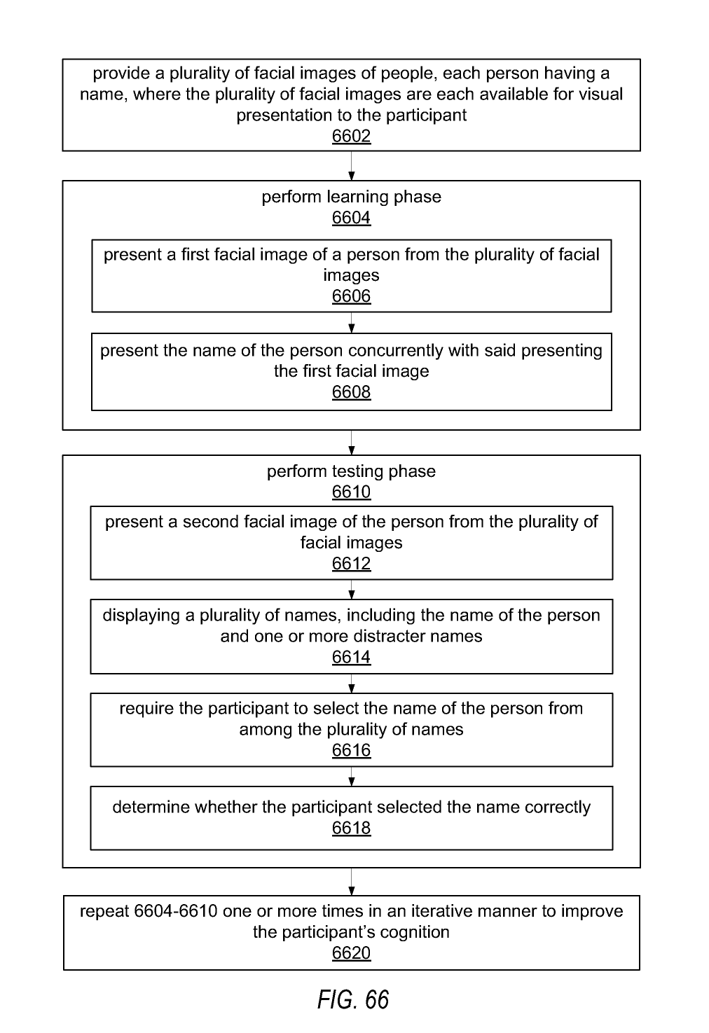

FIG. 66—Flowchart of a Method for Cognitive Training Using Face-Name Association

FIG. 66 is a high-level flowchart of one embodiment of a method for cognitive training using face-name association. It should be noted that in various embodiments, some of the method elements may be performed concurrently, in a different order than shown, or may be omitted. Additional method elements may also be performed as desired. In preferred embodiments, the method may be performed in the context of a visual stimulus exercise, e.g., a face-name association exercise, possibly in combination with one or more other visual stimulus exercises. As shown, the method may be performed as follows:

In 6602, a plurality of facial images of people may be provided, where each person has a name. The plurality of facial images may each be available for visual presentation to the participant. The plurality of facial images provided may depend on the context in which the exercise is performed. For example, in some embodiments, the exercise may be directed to improving name-face association of a participant with respect to people that are (or should be) familiar to the participant. As one example, the participant may be a resident of a facility, such as a nursing home, where the plurality of facial images may include those of co-residents and/or staff of the nursing home. As another example, the participant may be an employee of a company or institution, and the plurality of facial images may include those of the employees of the company or institution. Of course, these are but two examples of contexts with familiar faces, and any other such contexts are also contemplated, e.g., school, communities, etc. In these (familiar) contexts, in addition to improving cognition, e.g., improving face-name association skills in the participant, the exercise may further serve to familiarize the participant with the people with whom the participant interacts in the facility, company, or institution, thereby providing immediate and direct practical benefits, as well as improving the cognition of the participant.

In other embodiments, the plurality of facial images may not be familiar to the participant. For example, a large number (e.g., 300) of pictures of different faces (e.g., male and female between 18 and 90 years of age) may be used that include various different expressions, facial orientations, etc. In one embodiment, the pictures may be selected from a face database. In these (unfamiliar) contexts, the exercise may improve the cognitive skills of the participant (including, for example, memory skills), as well as improving the participant's particular skills of face-name association, which is of general benefit in social domains.

Note that in both kinds of context (familiar and unfamiliar faces), stimuli, i.e., facial images, with unusual features (e.g., hats) are preferably not used. The images may be standardized with respect to frame, size, luminosity and contrast. In higher stages of the exercise, morphing may be used to create ever-increasing difficulty in making face identifications.

In 6604, a learning phase of the method or exercise may be performed, including method elements 6606 and 6608, described below. In the learning phase, the participant is given a chance to learn a face/name association, and then, in a subsequent testing phase, described below, the participant is tested with respect to this association, and possibly others. In one embodiment, this learning and testing with respect to a face/name pair may compose a trial in the exercise, although in other embodiments, a trial may comprise such learning and testing with respect to all faces and names in a trial group (e.g., five faces/names). The learning phase is now described.

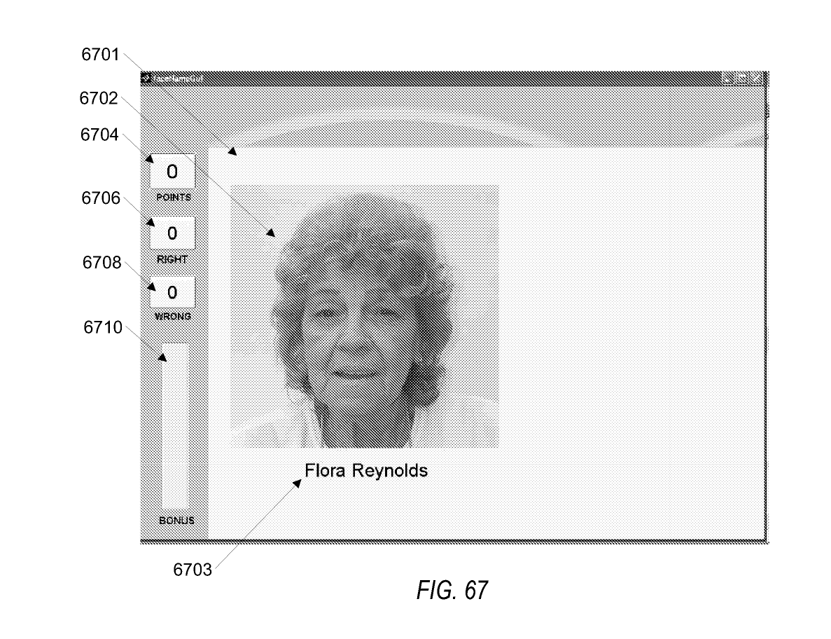

In 6606, a first facial image of a person from the plurality of facial images may be presented. For example, the first facial image may be displayed in a display area of a graphical user interface (GUI), as illustrated in FIG. 67 and described below.

In 6608, the name of the person may be presented concurrently with the presenting of the first facial image (of 6606). In other words, a first facial image of a person and the name of the person may be presented to the participant at the same time. Note that the name may be presented graphically and/or audibly (verbally). In other words, presenting the name may include textually presenting the name and/or auditorily presenting the name. Moreover, auditorily presenting the name may include a synchronous-onset presentation of the name with said presenting the facial image. In other words, the name may be played when the facial image is first displayed.

In some embodiments, presenting the first facial image may include flashing the facial image at a specified rate, e.g., between 1 and 4 Hz, although any other rate may be used as desired. Similarly, presenting the name of the person may include repeating the name at a specified rate (graphically and/or audibly), preferably the same rate at which the facial image is flashed. In one embodiment, the name may be presented graphically and verbally, where the graphical name is static, and the verbal presentation of the name is repeated with the facial image.

The human visual system is strongly engaged by patterns that alternate at intermediate temporal frequency modulations. Thus, flashing the face rather than presenting it at 0 Hz (i.e., as a static image) may more strongly engage the neural systems that support learning. Additionally, the onset of visual presentation of the face may be associated with a synchronous-onset presentation of the (displayed and/or spoken) proper name, which may effectively and repeatedly engage the to-be-associated visual and auditory representations.

In preferred embodiments, the participant may perform the exercise described herein via a graphical user interface (GUI). FIG. 67 illustrates an exemplary screenshot of a graphical user interface (GUI) for the face-name association exercise, according to one embodiment, specifically, for the learning phase of the face-name association exercise. As may be seen, the GUI preferably includes a visual field 6701, in which may be displayed a facial image of a person 6702, e.g., the first facial image of 6606. As also shown, in this embodiment, the name of the person 6703 is also displayed, e.g., the name of the person of 6608. As noted above, in some embodiments, the name may also (or instead) be verbally or audibly presented. As also noted above, the face and verbal name may be repeated at a specified rate, e.g., for a specified time.

As FIG. 67 also shows, in this embodiment, the GUI may include one or more of: a score indicator 6704, an indicator of how many correct associations the participant has made 6706, and indicator of how many incorrect association the participant has made 6708, and a bonus meter 6710 that indicates how close the participant is to getting bonus points in each trial group. Of course, the GUI of FIG. 67 is meant to be exemplary only, and is not intended to limit the GUI to any particular form, functionality, or appearance.

In various embodiments, and over the course of the exercise, the presenting of 6604 may be performed under a variety of specified conditions that may make performing the task more or less difficult. For example, the presentation time for the facial image and the name may be shortened to increase the difficulty of the task, or lengthened to make the task easier. Other conditions may also be used, such as, for example, the orientation or expression of the facial images, as will be described below in detail.

In 6610, a testing phase of the exercise may be performed, including method elements 6612, 6614, 6616, and 6618, described below. As indicated above, in the testing phase, the participant is tested with respect to the face/name presented in the learning phase, and may also be tested on previously presented face/name pairs, as will be discussed below. The testing phase is now described.

In 6612, a second facial image of the person from the plurality of facial images may be presented. In some embodiments, the second facial image is the same image as the first facial image. However, in other embodiments, the second facial image and the first facial image may differ. For example, the first and second facial images of the person may differ in view and/or expression, where the view of a facial image refers to the orientation of the face, e.g., front view, profile, and so forth. In some embodiments, one or more of the first and second facial images may be morphed, i.e., stretched, compressed, or otherwise distorted, to increase the difficulty of the task.

In 6614, a plurality of names, including the name of the person and one or more distracter names, may be presented. In other words, a list of names may be presented, e.g., next to the second facial image, that includes the name of the person (of the first and second facial images) and one or more other names. These distracter names may include names of previously presented facial images and/or names not associated with any facial images. In preferred embodiments, the number of names presented may vary from trial to trial, as will be discuss below in more detail.

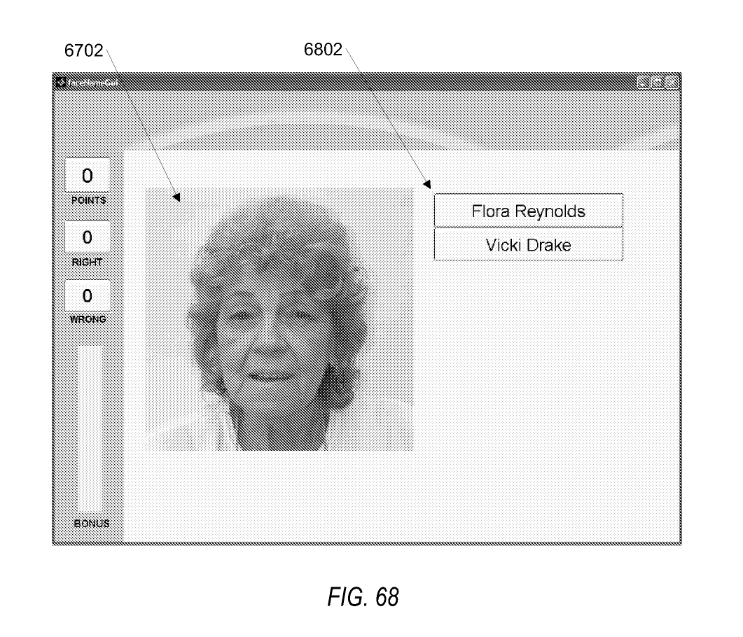

FIG. 68 illustrates an exemplary screenshot of a GUI for the testing phase of the face-name association exercise. As shown, in this embodiment, the second facial image 6702 is the same as that presented in the learning phase, illustrates in FIG. 67. As also shown, FIG. 68 displays a list of selectable names 6802, including the name of the person, in this case, Flora Reynolds, and one distracter name-Vicki Drake.

In 6616, the participant may be required to select the name of the person from the plurality of names. For example, input from the participant selecting the name may be received, and the selection made by the participant may be recorded. In one embodiment, the name may be selected by the participant placing a cursor over the name to be selected and clicking a mouse, although other selection means may be used as desired, e.g., using arrow keys to navigate through the list, and pressing the enter key, using a menu, etc.

In 6618, a determination may be made as to whether the participant selected the name correctly. The correctness or incorrectness of the selection is preferably recorded. In other words, the participant's success at selecting the name may be recorded.

In some embodiments, an indication of the correctness or incorrectness of the selection may be provided, e.g., graphically and/or audibly. For example, in some embodiments, a sound, such as a “ding” or “thunk”, may be played to indicate the correctness or incorrectness, respectively, of the selection. It should be noted, however, that any other kind of indication may be used as desired, e.g., a reward animation, etc.

In one embodiment, points may be awarded based on the correctness of the selection, which may be reflected by the score indicator 6704 of the GUI. Similarly, in some embodiments, based on the correctness/incorrectness of the selection, the indicator of how many correct associations the participant has made 6706 or the indicator of how many incorrect associations the participant has made 6708 may be updated accordingly.

In one exemplary reward scheme, the participants may receive immediate auditory feedback depending on if the right or wrong associations is made, and rewarded points depending on the right or wrong associations, e.g., every right association may be rewarded with 10 points. The number of right and wrong associations may always be displayed (via indicators 6706 and 6708). Bonus points may be awarded for every five consecutive correct associations made in the first trial group, and for every seven right associations made in consecutive trial groups. The bonus meter 6710 may indicate how close the participant is to getting bonus points in each trial group.

Finally, as indicated in 6620, the above learning phase and testing phase may be performed one or more times in an iterative manner to improve the participant's cognition, e.g., face-name association skills.

In other words, a plurality of trials may be performed in the exercise as described above. For example, the repetitions may be performed over a plurality of sessions, e.g., over days, weeks, or even months, e.g., for a specified number of times per day, and for a specified number of days. In some embodiments, at the end of each session, the participant's score for the session may be shown and may be compared to the best prior performance for that participant.

Such repeating preferably includes performing a plurality of trials under each of a plurality of conditions, where each condition specifies one or more attributes of the plurality of images or their presentation. Thus, groups of stimuli, referred to as trial groups, may contain or embody particular conditions affecting the difficulty of the face-name association task. A typical trial group may include 5 faces/names, although other numbers may be used as desired. Thus, the plurality of facial images may include a plurality of groups of facial images, where the repeating may include: for each group, performing the learning phase and the testing phase for each facial image in the group.

For example, the plurality of facial images may include one or more stimulus categories, each stimulus category specifying a relationship between the first and second facial images in the stimulus category. In some embodiments, the one or more stimulus categories include one or more of: a single view category, where the first and second facial images have the same view, a multiple view category, where the first and second facial images have different views, and a multiple expression category, where the first and second facial images have different expressions. Thus, even though each facial image pair (i.e., the first and second facial images of the learning and testing phases) illustrates the same person, the images may (or may not) differ from each other. Thus, the repeating may include progressing through groups of facial images in each of the one or more stimulus categories.

In some embodiments, each category may have a respective plurality of subcategories further specifying the relationship between first and second facial images in the category. For example, the subcategories may include two or more of: an age and gender independent subcategory, where the person of the first and second facial images is unconstrained with respect to age and gender, a gender specific subcategory, where the person of the first and second facial images is constrained with respect to gender, and an age specific subcategory, where the person of the first and second facial images is constrained with respect to age. In these embodiments, progressing through groups of facial images in each of the one or more stimulus categories may include: for each stimulus category, progressing through groups of facial images in each subcategory of the stimulus category.

The following summarizes an exemplary matrix of conditions suitable for use in some embodiments of the exercise:

| | Single view | Multiple views | Multiple expressions. |
|---|---|---|---|
| | (Front view Vs | (Front view Vs | (Neutral expression Vs |
| | Front view) | Profile view) | Happy expression) |
| Age and | Category 1a | Category2a | Category3a |
| gender | | | |
| independent | | | |
| Gender | Category1b | Category2b | Category3b |
| specific | | | |
| Age and | Category1c | Category2c | Category3c |
| gender | | | |
| specific | | | |

The participant may progress through a plurality of trial groups of the exercise based on the participant's success rate at each trial group, where each trial group may be associated with respective subsets of the conditions (e.g., one condition per trial group). Thus, for example, initial trial groups may include trials performed under the easiest conditions, and successive, more difficult, trial groups may include trials performed under more difficult conditions. An example of an easier trial group is one in which the names/faces in the group are all of the same gender, and in which the first and second facial images (of the learning phase and the testing phase, respectively) are the same. An example of a more difficult trial group is one in which the trial group includes faces/names of both genders, and where the first and second facial images differ in orientation (e.g., front view vs. profile) and facial expression (solemn vs. smiling). The trial groups may continue until the participant has mastered all the faces and names in all categories.

In some embodiments, the conditions of the stimuli (i.e., faces/names) used may depend upon the context of the exercise. For example, in some embodiments using familiar faces/names, the facial images may have various orientations and expressions (expressing various emotions, e.g., neutral/happy/sad/annoyed, etc.), mixed genders within a trial group, and so forth, whereas in some embodiments using unfamiliar faces/names, the facial images may all have the same orientation (e.g., front view) and expression (e.g., neutral), gender specific trial groups, etc. However, it should be noted that any conditions may be used as desired in both the familiar and unfamiliar contexts.

In some embodiments, the progression through each trial group may be progressive, where, for each face/name pair from the trial group presented to the participant, the participant is tested on that face/name pair, plus all face/name pairs previously presented from the trial group. Moreover, in some embodiments, one or more, e.g., two, additional face/name pairs from a previous trial group, e.g., the immediately previous trial group, may also be included in the testing. The following describes an exemplary embodiment of such a progression.

In some embodiments, performing the testing phase for each facial image in the group may include: for each facial image in the group, referred to as the first group, and for each facial image in a second group including the facial image (or another facial image of the same person), previously presented facial images from the first group, and zero or more previously presented facial images from an immediately previous group, a) presenting a randomly selected facial image of a person from the second group, b) displaying a second plurality of names, including the name for each facial image in the second group, and one or more distracter names, c) requiring the participant to select the name of the person for the randomly selected facial image from the plurality of names; and d) determining whether the participant correctly selected the name of the person for the randomly selected facial image.

In other words, after each face/name from the trial group, i.e., the first group, is presented in the learning phase, the participant is tested on all the faces/names in a second group, comprising the most recent face/name, all previously presented faces/names from the first (trial) group, plus one or more distracter names, plus zero or more faces/names from the previous trial group. Thus, each time a new face/name from the trial group is presented in the learning phase, the list of selectable names presented in the testing phase may increase by one. Said another way, as the participant progresses through the trial group, the number of names/faces tested on increases, as all previous faces/names are included in the testing. In various embodiments, the number of additional faces/names from the previous trial group used in the testing phase may be zero, one, two, or any other number, as desired. It should be noted that in various embodiments, the distracter name may be constant for a trial group, or may change, e.g., in response to the participant's selection(s), or even per selection task.

Moreover, in some embodiments, the repeating may further include: if the participant incorrectly selected the name of the person for the randomly selected facial image, performing the learning phase again for the randomly selected facial image, and performing a)-d) for each facial image in the second group. In other words, each time the participant selects a wrong name, the learning phase for the current face/name may be performed, then the above progressive learning phase. This repetition may serve to reinforce previously “learned” face/name pairs, and to accelerate the improvement of the participant's face/name association skills. Note also that as the participant makes correct associations, the task gets progressively harder as the participant has to remember all face-name pairs learned to that point (for that trial group).

As noted above, participants may move through all subcategories within a category before moving to the next category. Within each subcategory, participants move through trial groups or stages (i.e., with increasing numbers of response buttons) and then advance through categories or levels (age and gender specific) based on performance. Note that progression in the exercise is designed to allow participants with poor face-name association ability to advance through tasks without getting stuck by retraining them on the face-name pairs for which wrong associations are made.

Note that in some embodiments, the initial trial group may be handled differently from subsequent trial groups (see, e.g., FIG. 68). For example, no additional faces/names from previous trial groups may be included, since there are no previous trials groups initially. Thus, for example, with respect to the initial trial group (of FIG. 68), the possible selections for the first face/name association are limited to two names-the name of the person whose face is displayed, and one distracter name. In contrast, with respect to a subsequent (non-initial) trial group, at the start of the learning phase of the trial group the user is trained on a new face. However, during the test phase, unlike the first trial group, the user is tested on the new face and two randomly chosen faces from the previous trial group. As a result, beginning from the second trial group, all consecutive trials may end with being tested on seven face-name pairs (plus one distracter name), as discussed below with reference to FIG. 8.

Additionally, as indicated above, in some embodiments, for the first trial group, bonus points may be awarded for five consecutive correct associations (since only five faces/names are learned and tested on), whereas in subsequent trial groups, seven consecutive correct associations may be required for bonus points (since the participant is tested on the five faces/names of the current trial group, plus two previously learned faces/names).

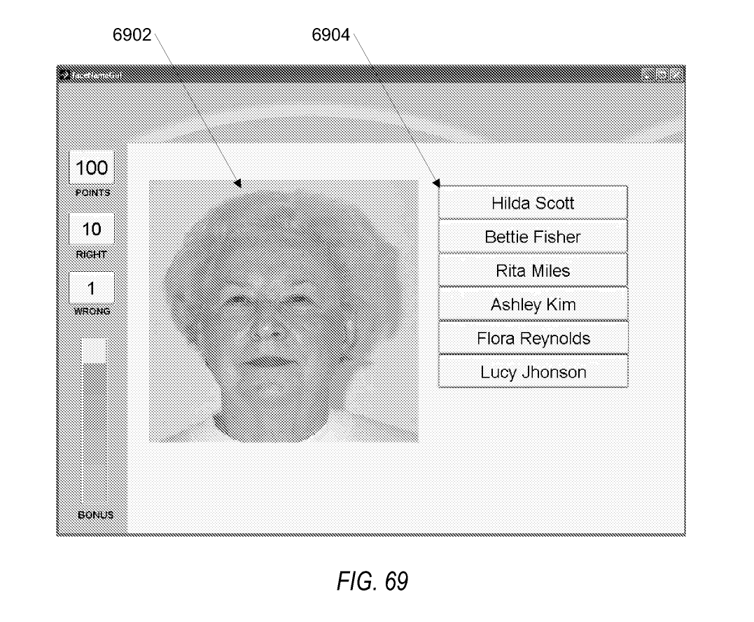

FIG. 69 illustrates an exemplary screenshot of the GUI where six names 6904 are displayed for selection (for possible association with displayed facial image 6902), and so may correspond to the final portion of the initial trial group introduced with reference to FIG. 68, described above, where the listed names are those of the initial trial group plus one distracter name. Note that the bonus meter indicates that the participant has responded correctly four times consecutively, and thus is one correct response away from receiving bonus points (assuming this is the initial trial group).

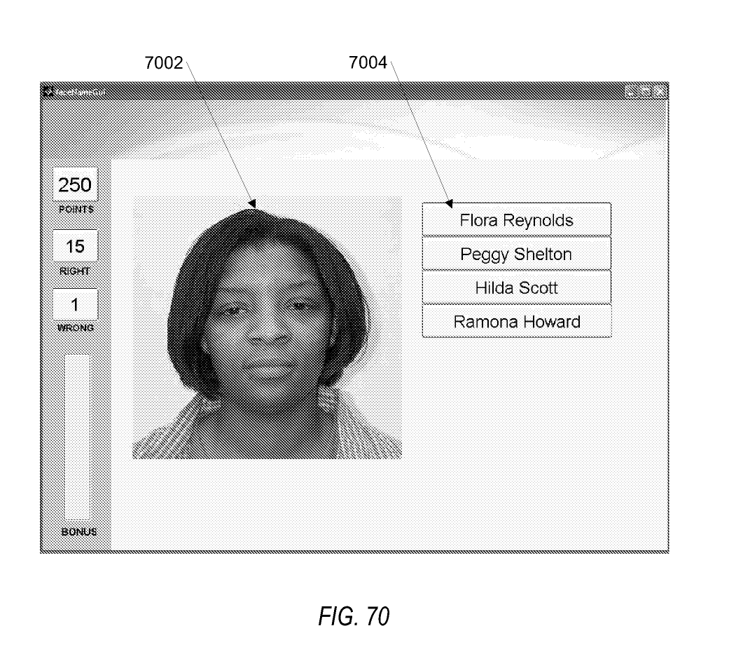

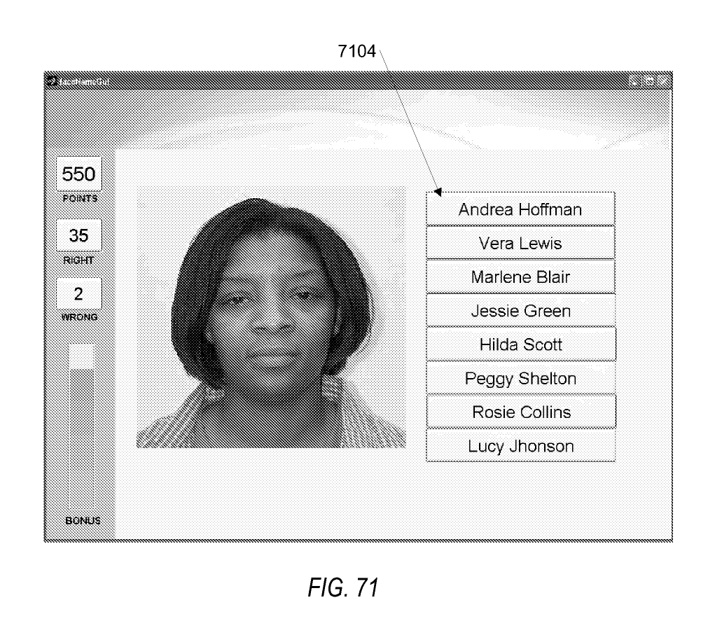

In contrast, FIGS. 70 and 71 illustrate exemplary screenshots of the GUI corresponding to a subsequent trial group, where the participant must select from progressively larger lists of names. As may be seen, FIG. 70 illustrates an exemplary screenshot of the GUI where four names 7004 are displayed for selection (for possible association with displayed facial image 7002), and so corresponds to an intermediary point of a subsequent or non-initial trial group, where the listed names include three selected (e.g., randomly) from the group comprising the trial group and two names from a previous trial group, plus a distracter name.

FIG. 71 illustrates an exemplary screenshot of the GUI where eight names 804 are displayed for selection, and so may correspond to the latter portion of the trial group of FIG. 70, where the listed names are those of the (non-initial) trial group, plus two names from a previous trial group, plus a distracter name. As may be seen, the particular selection tasks corresponding to FIGS. 70 and 71 are progressively more difficult, due to the increasing numbers of names from which to select.

In some embodiments, one or more assessments of the participant's face/name association skills may be made, e.g., before, during, and/or after the exercise. The stimuli (i.e., faces/names) used in the assessment may depend upon the context of the exercise. For example, in embodiments using familiar faces/names, the participant's knowledge (i.e., ability to associate) of all faces may be tested at the beginning and end of the exercise. In embodiments using unfamiliar faces/names, the participant may be tested or assessed at the end of the exercise using different faces/names from those used in the exercise, i.e., different from those the participant was trained with.

In some embodiments, certain information may be maintained and recorded over the course of the exercise. For example, in one exemplary embodiment, the following information may be recorded: the name of the participant; the age of the participant; the gender of the participant; the number of trial groups completed; all scores achieved during the exercise; the conditions in force for each trial group; time/date for each session; and time spent on each trial group, among others. Of course, this information is meant to be exemplary only, and other information may be recorded as desired.

In some embodiments, the method may also include performing a plurality of practice trials, i.e., prior to performing the method elements described above. For example, in some embodiments, one or more practice sessions may be performed prior to the beginning of training to familiarize the participant with the nature and mechanisms of the exercise, i.e., the learning and testing phases of the exercise. In each practice session, a specified number of trial groups (e.g., 1) for each of one or more practice conditions may be performed. In some embodiments, the participant may be able to invoke such practice sessions at will during the exercise, e.g., to re-familiarize the participant with the task at hand.

Thus, various embodiments of the visual stimuli-based cognitive training exercises described herein may be used singly or in combination to improve the participant's cognitive skills.

It should also be noted that the particular exercises disclosed herein are meant to be exemplary, and that other repetition-based cognitive training exercises using visual stimuli with multiple stimulus sets may be used as desired, possibly in combination. In other words, the visual sweeps exercises described herein are but specific examples of cognitive training exercises using a computing system to present visual stimuli to a participant, record the participant's responses, and modify some aspect of the visual stimuli based on these responses, where these method elements are repeated in an iterative manner using multiple sets of stimuli to improve the participant's cognition, e.g., the ability of the participant to process visual information. Note particularly that such cognitive training using a variety of such visual stimulus-based exercises, possibly in a coordinated manner, is contemplated.

Those skilled in the art should appreciate that they can readily use the disclosed conception and specific embodiments as a basis for designing or modifying other structures for carrying out the same purposes of the present invention without departing from the spirit and scope of the invention as defined by the appended claims. For example, various embodiments of the methods disclosed herein may be implemented by program instructions stored on a memory medium, or a plurality of memory media.

We claim:

1. A computer-implemented method for enhancing cognition in a participant, utilizing a computing device to present visual stimuli and to receive responses from the participant, the method comprising:
providing a set of visual stimuli for presentation to the participant, the set comprising a plurality of visual stimuli of varying difficulty;
presenting a visual stimulus from the set of visual stimuli to the participant;
requiring the participant to respond to the visual stimulus;
determining if the participant responded correctly to the visual stimulus;
selecting another visual stimulus for future presentation from the set based on said determining;
repeating said presenting, said requiring, said determining, and said selecting in an iterative manner to improve the cognition of the participant.

2. The method of claim 1, further comprising:
indicating whether the participant responded correctly, wherein said indicating is performed audibly and/or graphically.

3. The method of claim 1, further comprising:
recording the participant's response; and/or
recording whether the participant responded correctly.

4. The method of claim 1, wherein said repeating occurs a number of times each day, for a number of days.

5. The method of claim 1, wherein said presenting, said requiring, said determining, and said selecting composes performing a trial, and wherein said repeating comprises performing a plurality of trials using a plurality of visual stimuli from the set.

6. The method of claim 5, further comprising:
performing trials in one or more practice sessions.

7. The method of claim 5, wherein said selecting comprises:
selecting a visual stimulus of greater difficulty if the participant achieves a specified level of success; and/or
selecting a visual stimulus of lesser difficulty if the participant does not achieve the specified level of success;

8. The method of claim 7, wherein said selecting comprises:
selecting a more difficult visual stimulus if the participant responded correctly a first specified number of times in a row; and/or
selecting a less difficult visual stimulus if the participant responded incorrectly a second specified number of times in a row.

9. The method of claim 7,
wherein said achieving a specified level of success comprises responding correctly in a specified percentage of trials.

10. The method of claim 7, wherein said presenting the visual stimulus comprises presenting the visual stimulus at a specified stimulus intensity, wherein increased stimulus intensity corresponds to decreased difficulty of the visual stimulus, and wherein decreased stimulus intensity corresponds to increased difficulty of the visual stimulus.

11. The method of claim 10, wherein the stimulus intensity comprises one or more attributes of the visual stimulus, comprising one or more of:
one or more attributes of said presenting the visual stimulus; and/or one or more graphical attributes of the visual stimulus.

12. The method of claim 11,
wherein the one or more attributes of said presenting the visual stimulus comprise one or more of:
duration of said presenting, comprising a presentation time of the visual stimulus;
position of the visual stimulus;
motion of the visual stimulus; and/or
flashing of the visual stimulus; and
wherein the one or more graphical attributes of the visual stimulus comprise one or more of:
size;
orientation;
color;
color contrast;
luminance;
luminance contrast;
spatial frequency;
texture;
object type shown in the visual stimulus;
complexity; and/or
visual distinction between foreground and background of the visual stmulus.

13. The method of claim 10, wherein said selecting comprises:
adjusting the stimulus intensity for said presenting the visual stimulus;
wherein said adjusting is performed using an N-up/M-down procedure, comprising:
increasing stimulus intensity if the participant incorrectly performs N trials consecutively; and
decreasing stimulus intensity if the participant correctly performs M trials consecutively.

14. The method of claim 13, wherein the N-up/M-down procedure comprises a 1-up/3-down procedure.

15. The method of claim 13, wherein said adjusting the stimulus intensity comprises one or more of:
selecting a visual stimulus with a specified value of stimulus intensity from the set of visual stimuli; and/or
modifying the stimulus intensity of a selected visual stimulus from the set of visual stimuli.

16. The method of claim 14, wherein said adjusting the stimulus intensity comprises:
adjusting the stimulus intensity to approach and substantially maintain a specified success rate for the participant.

17. The method of claim 16, wherein said adjusting the stimulus intensity to approach and substantially maintain a specified success rate for the participant is performed for each of a plurality conditions.

18. The method of claim 16, wherein said adjusting the stimulus intensity to approach and substantially maintain a specified success rate for the participant is performed using a single stair N-up/M-down procedure.

19. The method of claim 13, wherein said repeating comprises:
performing a plurality of trials under each of a plurality of conditions, wherein each condition specifies one or more attributes of the visual stimulus.

20. The method of claim 19, wherein said repeating comprises:
assessing the participant's performance a plurality of times during said repeating.

21. The method of claim 20, wherein said assessing the participant's performance a plurality of times is performed according to the N-up/M-down procedure.

22. The method of claim 21, wherein said assessing the participant's performance a plurality of times is performed using a 2-stair N-up/M-down procedure.
Renumber

23. The method of claim 10, wherein said selecting comprises:
adjusting the stimulus intensity for said presenting the visual stimulus;
wherein said adjusting is performed using a maximum likelihood procedure.

24. The method of claim 23, wherein said adjusting the stimulus intensity comprises one or more of:
selecting a visual stimulus with a specified value of stimulus intensity from the set of visual stimuli; and/or
modifying the stimulus intensity of a selected visual stimulus from the set of visual stimuli.

25. The method as recited in claim 23, wherein the maximum likelihood procedure comprises one or more of:
a QUEST (quick estimation by sequential testing) threshold procedure; or
a ZEST (zippy estimation by sequential testing) threshold procedure.

26. The method of claim 25, wherein said adjusting the stimulus intensity comprises:
adjusting the stimulus intensity to approach and substantially maintain a specified success rate for the participant.

27. The method of claim 26, wherein said adjusting the stimulus intensity to approach and substantially maintain a specified success rate for the participant is performed for each of a plurality conditions.

28. The method of claim 26, wherein said adjusting the stimulus intensity to approach and substantially maintain a specified success rate for the participant uses a single stair maximum likelihood procedure.

29. The method of claim 23, wherein said repeating comprises:
performing a plurality of trials under each of a plurality of conditions, wherein each condition specifies one or more attributes of the visual stimulus.

30. The method of claim 29, wherein said repeating comprises:
assessing the participant's performance a plurality of times during said repeating.

31. The method of claim 30, wherein said assessing the participant's performance a plurality of times is performed according to the maximum likelihood procedure.

32. The method of claim 31, wherein said assessing the participant's performance a plurality of times is performed using a 2-stair maximum likelihood procedure.
Visual Emphasia

33. The method of claim 1,
wherein said providing a set of visual stimuli comprises providing one or more scenes, each having a background and at least one foreground object, wherein the one or more scenes are available for visual presentation to the participant; and
wherein said visually presenting a visual stimulus comprises visually presenting a scene from the one or more scenes to the participant, wherein said visually presenting comprises visually presenting the at least one foreground object and/or the background with a specified visual emphasis that visually distinguishes the at least one foreground object with respect to the background.

34. The method of claim 33, wherein said visually presenting the at least one foreground object and/or the background with a specified visual emphasis comprises one or more of:
modifying the visual emphasis of the at least one foreground object and/or the background to achieve the specified visual emphasis; or
selecting the at least one foreground object and/or the background in accordance with the specified visual emphasis.

35. The method of claim 33, wherein the specified visual emphasis specifies one or more of:
luminance contrast of the at least one foreground object and/or the background;
chromatic contrast of the at least one foreground object and/or the background;
spatial frequency of the at least one foreground object and/or the background;
size of the at least one foreground object and/or features in the background;
flashing the at least one foreground object;
moving the at least one foreground object with respect to the background;
texture of the at least one foreground object and/or the background;
opacity of the at least one foreground object and/or the background;
distance of the at least one foreground object from one or more other foreground objects and/or one or more features of the background; and/or
distracting effects of one or more features in the background.

36. The method of claim 35,
wherein increasing the visual emphasis comprises:
increasing one or more others of the luminance contrast the color contrast, the spatial frequency, the size, the flashing, the involving, the texture, the opacity, the distance, or the distracting effects of one or more features in the background; and
wherein decreasing the visual emphasis comprises:
decreasing or ceasing to modify at least one of said one or more of the luminance contrast, the color contrast, the spatial frequency, the size, the flashing, the moving, the texture, the opacity, the distance, or the distracting effects of one or more features in the background.

37. The method of claim 33, further comprising:
modifying the specified visual emphasis based on said determining.

38. The method of claim 37, wherein said modifying the specified visual emphasis comprises one or more of:
modifying the visual emphasis of the at least one foreground object and/or the background to modify the visual emphasis; or
selecting a different at least one foreground object and/or a different background for the scene to modify the visual emphasis.

39. The method of claim 37, wherein said modifying the specified visual emphasis comprises adjusting the degree of visual emphasis according to one or more visual emphasis techniques.

40. The method of claim 39, wherein each of the one or more visual emphasis techniques specifies a corresponding attribute, wherein said adjusting the degree of visual emphasis comprises increasing the visual emphasis of the scene, and wherein said increasing the visual emphasis of the scene comprises one or more of:
increasing the attribute for the at least one foreground object according to a first visual emphasis technique;
decreasing the attribute for the background according to the first visual emphasis technique;
increasing the attribute for the at least one foreground object according to the first visual emphasis technique, and decreasing the attribute for the background according to the first visual emphasis technique; and/or
increasing the attribute for the at least one foreground object according to the first visual emphasis technique, and decreasing the attribute for the background according to a second visual emphasis technique.

41. The method of claim 40, wherein each of the one or more visual emphasis techniques specifies a corresponding attribute, wherein said adjusting the degree of visual emphasis comprises decreasing the visual emphasis of the scene, and wherein said decreasing the visual emphasis of the scene comprises one or more of:
decreasing the attribute for the at least one foreground object according to a first visual emphasis technique;
increasing the attribute for the background according to the first visual emphasis technique;
decreasing the attribute for the at least one foreground object according to the first visual emphasis technique, and increasing the attribute for the background according to the first visual emphasis technique; and/or
decreasing the attribute for the at least one foreground object according to the first visual emphasis technique, and increasing the attribute for the background according to a second visual emphasis technique.

42. The method of claim 33, wherein said repeating comprises beginning with scenes of higher visual emphasis, wherein said modifying the specified visual emphasis comprises:
decreasing the visual emphasis if the participant responds correctly a specified number of times.

43. The method of claim 33, wherein said repeating comprises:
progressing through a plurality of levels, with each successive level specifying lower visual emphasis.
Multiple Congnitve Training Exercises with Visual Stimuli

44. The method of claim 1, wherein the set of visual stimuli comprises two or more sets of visual stimuli for respective use in two or more cognitive training exercises using visual stimuli, wherein said repeating comprises:
performing trials in each of the two or more cognitive training exercises using visual stimuli.

45. The method of claim 44, wherein said performing trials in each of the two or more cognitive training exercises using visual stimuli comprises one or more of:
performing trials in the two or more cognitive training exercises in serial fashion; and/or
performing trials in the two or more cognitive training exercises in interleaved fashion.
Visual Sweeps

46. The method of claim 44, wherein, for at least one of the two or more cognitive training exercises using visual stimuli:
said providing a set of visual stimuli comprises providing first and second visual sweeps, wherein the first and second visual sweeps are available for visual presentation to the participant;
said visually presenting a visual stimulus comprises visually presenting at least two visual sweeps to the participant utilizing either the first visual sweep, the second visual sweep, or a combination of the first and second visual sweeps;
said requiring the participant to respond to the visual stimulus comprises requiring the participant to indicate an order in which the at least two visual sweeps were presented; and
said determining whether the participant responded correctly comprises determining whether the participant indicated the order of the at least two visual sweeps correctly.

47. The method of claim 46, wherein the at least one of the two or more cognitive training exercises comprises:
associating the first visual sweep with a first icon; and
associating the second visual sweep with a second icon;
wherein said requiring the participant to indicate the order in which the at least two visual sweeps were presented comprises requiring the participant to select one or more of the icons one or more times to indicate the order of the at least two visual sweeps.

48. The method of claim 46, wherein the first and second frequency sweeps are each of a specified duration, and wherein said visually presenting separates the at least two frequency sweeps by a specified inter-stimulus-interval (ISI);

49. The method of claim 48, wherein said visually presenting at least two visual sweeps comprises visually presenting at least two visual sweeps at a specified stimulus intensity, the method further comprising:
adjusting the stimulus intensity based on said determining, wherein said adjusting is performed in accordance with one or more of:
a maximum likelihood procedure; or
an N-up/M-down procedure.

50. The method of claim 49,
wherein the stimulus intensity comprises a presentation time for each visual sweep, comprising the duration and/or the ISI;
wherein said adjusting the stimulus intensity comprises:
if the participant correctly indicates the order in which the at least two frequency sweeps were presented a first specified number of times in a row, shortening the duration and/or the ISI; and
if the participant incorrectly indicates the order in which the at least two frequency sweeps were presented a second specified number of times in a row, lengthening the duration and/or the ISI.
Renumber

51. The method of claim 46, wherein said visually presenting, said requiring, and said determining composes performing a trial, and wherein said repeating comprises performing a plurality of trials under each of a plurality of visual sweep conditions, including performing a plurality of trials for each of one or more visual sweep tasks, wherein the one or more visual sweep tasks comprise one or more of:
a spatial frequency sweep task; or
an orientation sweep task.

52. The method of claim 51, wherein, in the spatial frequency sweep task, the first visual sweep comprises a first spatial frequency sweep in which the spatial frequency of a sweep pattern increases in frequency over time, and wherein the second visual sweep comprises a second spatial frequency sweep in which the spatial frequency of the sweep pattern decreases in frequency over time.

53. The method of claim 51, wherein, in the spatial frequency sweep task, both the first visual sweep and the second visual sweep comprise:
a spatial frequency sweep in which the spatial frequency of a sweep pattern increases in frequency over time; or
a spatial frequency sweep in which the spatial frequency of the sweep pattern decreases in frequency over time.
Renumber

54. The method of claim 51, wherein, in the orientation sweep task, the first visual sweep comprises a first orientation sweep which rotates counter-clockwise over time, and wherein the second visual sweep comprises a second orientation sweep which rotates clockwise over time.

55. The method of claim 51, wherein, in the orientation sweep task, both the first visual sweep and the second visual sweep comprise:
an orientation sweep which rotates counter-clockwise over time; or
an orientation sweep which rotates clockwise over time.
Renumber

56. The method of claim 46, wherein the first and second visual sweeps use a Gabor sweep pattern.
Visual Search

57. The method of claim 44, wherein, for at least one of the two or more cognitive training exercises using visual stimuli:
said providing a set of visual stimuli comprises providing a target image and one or more distracter images, wherein the target image and the one or more distracter images differ in appearance, and wherein the target image and the one or more distracter images are available for visual presentation to the participant;
said visually presenting a visual stimulus comprises visually presenting a plurality of images at respective locations in a visual field to the participant for a specified presentation time, including the target image and a plurality of distracter images based on the one or more distracter images, wherein at the end of the specified presentation time said visually presenting is ceased;
said requiring the participant to respond to the visual stimulus comprises requiring the participant to select the location of the target image from among a plurality of locations in the visual field; and
said determining whether the participant responded correctly comprises determining whether the participant selected the location of the target.

58. The method of claim 57, further comprising:
prior to said visually presenting the plurality of images, presenting the target image, then removing the target image.

59. The method of claim 57, wherein said visually presenting the plurality of image comprises visually presenting the plurality of images at a specified stimulus intensity, the method further comprising:
adjusting the stimulus intensity based on said determining, wherein said adjusting is performed in accordance with one or more of:
a maximum likelihood procedure; or
an N-up/M-down procedure.

60. The method of claim 59, wherein the stimulus intensity comprises the presentation time for said visually presenting, wherein said adjusting the stimulus intensity comprises:
if the participant correctly selected the location of the target image a first specified number of times in a row, shortening the presentation time; and
if the participant incorrectly selected the location of the target image a second specified number of times in a row, lengthening the presentation time.

61. The method of claim 57, wherein said visually presenting, said requiring, and said determining composes performing a trial, and wherein said repeating comprises:
performing a plurality of trials under each of a plurality of visual search conditions, wherein each visual search condition specifies one or more attributes of the plurality of images.

62. The method of claim 61, wherein the target image differs from the one or more distracter images in one or more of:
color;
texture;
shape;
size;
orientation; or
object type shown by the image.

63. The method of claim 62, wherein each of the visual search conditions specifies one or more of:
colors of the target image and the distracter images;
textures of the target image and the distracter images;
shapes of the target image and the distracter images;
sizes of the target image and the distracter images;
orientations of objects shown respectively by the target image and the distracter images;
object types shown respectively by the target image and the distracter images;
number of distracter images;
location of the target image;
background; and/or
visual emphasis of the target image, distracter images, and/or the background.

64. The method of claim 61, wherein the visual field is partitioned into a plurality of graphically indicated regions, wherein the location of the target image comprises a specified region of the plurality of regions in the visual field, and wherein selection of a location of an image is performed by the participant placing a cursor over a region containing the image and clicking a mouse.

65. The method of claim 61, wherein said performing a plurality of trials under each of a plurality of visual search conditions comprises performing a plurality of trials for each of one or more visual search tasks, wherein the one or more visual search tasks comprise one or more of:
a single attention visual search task; or
a dual attention visual search task.

66. The method of claim 65,
wherein said performing a plurality of trials under each of a plurality of visual search conditions comprises performing a plurality of trials for the dual attention visual search task;
wherein said providing a target image comprises providing at least two potential target images, wherein the at least two potential target images differ by a specified attribute, and wherein one of the at least two potential target images is the target image;
wherein said visually presenting the plurality of images in the visual field to the participant comprises:
visually presenting the plurality of distracter images;
visually presenting the at least two potential target images; and
visually presenting an indication of the specified attribute corresponding to a first potential target image of the at least two potential target images, wherein the first potential target image is the target image; and
wherein said requiring the participant to select a location of the target image from among a plurality of locations in the visual field further comprises;
requiring the participant to select a location of the first potential target image from among the locations of the at least two potential target images based on the visually presented indication.

67. The method of claim 66, wherein said visually presenting an indication of the specified attribute corresponding to a first potential target image comprises:
visually presenting the indication substantially at the center of the visual field.

68. The method of claim 66, wherein the specified attribute comprises a direction of tilt of an object shown in the target image.

69. The method of claim 65, wherein said performing a plurality of trials for each of one or more visual search tasks comprises performing a plurality of trials for each of the single attention search task and the dual attention search task.
MOT

70. The method of claim 44, wherein, for at least one of the two or more cognitive training exercises using visual stimuli:
said providing a set of visual stimuli comprises providing one or more images, wherein the one or more images are available for visual presentation to the participant;
said visually presenting a visual stimulus comprises visually presenting a plurality of images based on the one or more images in a visual field to the participant, wherein the plurality of images comprises a plurality of target images and a plurality of distracter images, and wherein said visually presenting the plurality of images comprises:
graphically indicating each of the plurality of target images for a first time period;
moving each of the plurality of images in the visual field for a second time period, wherein during the second time period said graphically indicating is not performed;
said requiring the participant to respond to the visual stimulus comprises requiring the participant to select the target images from the plurality of images; and
said determining whether the participant responded correctly comprises determining whether the participant selected the target images correctly.

71. The method of claim 70, wherein said requiring the participant to select the target images comprises:
allowing the participant to make a number of selections, wherein the number of selections is equal to the number of target images.

72. The method of claim 70, wherein said visually presenting the plurality of images comprises visually presenting the plurality of images at a specified stimulus intensity, the method further comprising:
adjusting the stimulus intensity based on said determining, wherein said adjusting is performed in accordance with one or more of:
a maximum likelihood procedure; or
an N-up/M-down procedure.

73. The method of claim 72, wherein the stimulus intensity comprises the number of target images visually presented.

74. The method of claim 73, wherein said adjusting the stimulus intensity comprises:
if the participant correctly selects the target images a first specified number of times in a row, increasing the number of target images; and
if the participant incorrectly selects the target images a second specified number of times in a row, decreasing the number of target images.

75. The method of claim 72, wherein the stimulus intensity comprises the presentation time of the visually presented images, wherein said adjusting the stimulus intensity comprises:
if the participant correctly selects the target images a first specified number of times in a row, decreasing the presentation time of the images; and
if the participant incorrectly selects the target images a second specified number of times in a row, increasing the presentation time of the images.

76. The method of claim 72, wherein the stimulus intensity comprises the speed of the images during said moving, wherein said adjusting the stimulus intensity comprises:
if the participant correctly selects the target images a first specified number of times in a row, increasing the speed of the images during said moving; and
if the participant incorrectly selects the target images a second specified number of times in a row, decreasing the speed of the images during said moving.

77. The method of claim 72, wherein the stimulus intensity comprises one or more of:
speed of the target images and the distracter images;
size of the target images and the distracter images;
presentation time of the target images and the distracter images, wherein said presentation time comprises the first time period and/or the second time period;
eccentricity of initial locations of the target images;
number of occluders in the visual field, wherein each occluder is operable to occlude target images and distracter images that move behind the occluder;
size of the visual field; or
visual appearance of the images.

78. The method of claim 72, wherein said visually presenting, said requiring, and said determining composes performing a trial.

79. The method of claim 78, wherein said repeating comprises:
performing a plurality of trials under each of a plurality of conditions, wherein each condition specifies one or more attributes of the plurality of images or their presentation.

80. The method of claim 79, wherein each of the plurality of conditions specifies one or more of:
movement of the target images and the distracter images;
size of the target images and the distracter images;
presentation time of the target images and the distracter images, wherein said presentation time comprises the first time period and/or the second time period;
eccentricity of initial locations of the target images;
number of occluders in the visual field, wherein each occluder is operable to occlude target images and distracter images that move behind the occluder;
size of the visual field; or
visual appearance of the images.

81. The method of claim 79, wherein said specifying movement of the target images and the distracter images comprises specifying one or more of:
speed of the target images and the distracter images; or
whether or not the target images and the distracter images can overlap.
Eye Movement

82. The method of claim 44, wherein, for at least one of the two or more cognitive training exercises using visual stimuli:
said providing a set of visual stimuli comprises providing multiple graphical elements, wherein each graphical element has a value, and wherein the multiple graphical elements are available for visual presentation to the participant;
said visually presenting a visual stimulus comprises visually presenting a temporal sequence of at least two of the graphical elements at a specified stimulus intensity, including displaying the value of each of the at least two graphical elements at a respective position in a visual field for a specified duration, then ceasing to display the value;
said requiring the participant to respond to the visual stimulus comprises requiring the participant to respond to the displayed values;
the method further comprising:
modifying the stimulus intensity based on said determining.

83. The method of claim 82, wherein said visually presenting, said requiring, and said determining compose performing a trial, and wherein said repeating comprises performing a plurality of trials under each of a plurality of conditions, wherein each condition specifies one or more attributes of the at least two graphical elements or their presentation.

84. The method of claim 83, wherein the respective positions of the at least two graphical elements are determined randomly, wherein a first graphical element of the at least two graphical elements has a first position with a first azimuth, and wherein each subsequent graphical element of the at least two graphical elements has an azimuth differing from that of the previous graphical element by a respective angle.

85. The method of claim 83, wherein said requiring the participant to respond to the displayed values comprises:
requiring the participant to indicate the sequence of the displayed values.

86. The method of claim 83, wherein the displayed values comprise one or more of:
objects;
numbers;
letters;
colors; and/or
shapes.

87. The method of claim 83, wherein said visually presenting the temporal sequence of at least two of the graphical elements comprises:
visually presenting a first plurality of the graphical elements in a spatial arrangement in the visual field, wherein each graphical element in the first plurality of graphical elements has a respective position;
wherein the at least two graphical elements are comprised in the first plurality of graphical elements.

88. The method of claim 87, wherein the visual field has a fixation point in the center of the visual field, and wherein said visually presenting a first plurality of the graphical elements in a spatial arrangement in the visual field comprises:
displaying each of the first plurality of the graphical elements within a specified range of the fixation point.

89. The method of claim 88, wherein the specified range comprises one of:
a first range, comprising a first minimum distance from the fixation point, and a first maximum distance from the fixation point; and
a second range, comprising a second minimum distance from the fixation point, and a second maximum distance from the fixation point;
wherein the second minimum distance is greater than the first minimum distance; and
wherein the second maximum distance is greater than the second maximum distance.

90. The method of claim 83, wherein each of the plurality conditions specifies one or more of:
range of distances from a fixation point in the visual field for the first plurality of graphical elements;
number of graphical elements in the first plurality of graphical elements;
number of graphical elements in the presented sequence of the at least two graphical elements;
whether the durations of the visually presenting overlap;
complexity of the graphical elements; and
distinguishability of the graphical elements from a background displayed in the visual field.

91. The method of claim 83, wherein said modifying comprises:
adjusting the stimulus intensity based on said determining, wherein said adjusting is performed in accordance with one or more of:
a maximum likelihood procedure; or
an N-up/M-down procedure.

92. The method of claim 91, wherein the stimulus intensity comprises the duration of the stimulus, wherein said adjusting the stimulus intensity comprises:
if the participant responds correctly a first specified number of times in a row, decreasing the duration; and/or
if the participant responds incorrectly a second specified number of times in a row, increasing the duration.

93. The method of claim 91, wherein the stimulus intensity comprises one or more of:
eccentricity of the respective positions of the least two graphical elements in the visual field;
number of graphical elements in the temporal sequence;
appearance of the graphical elements; and/or
visual emphasis of the graphical elements.
Face/Name

94. The method of claim 44, wherein, for at least one of the two or more cognitive training exercises using visual stimuli:
said providing a set of visual stimuli comprises providing a plurality of facial images of people, each person having a name, wherein the plurality of facial images are each available for visual presentation to the participant;
wherein the at least one of the two or more cognitive training exercises comprises:
performing a learning phase, comprising:
presenting a first facial image of a person from the plurality of facial images; and
presenting the name of the person concurrently with said presenting the first facial image; and
performing a testing phase, wherein the testing phase comprises said visually presenting, said requiring, and said determining, wherein:
said visually presenting a visual stimulus comprises:
presenting a second facial image of the person from the plurality of facial images; and
displaying a plurality of names, including the name of the person and one or more distracter names;
said requiring the participant to respond to the visual stimulus comprises requiring the participant to select the name of the person from the plurality of names; and
said determining whether the participant responded correctly comprises determining whether the participant selected the name correctly; and
wherein said repeating comprises repeating said performing the learning phase and said performing the testing phase one or more times in an iterative manner to improve the participant's cognition.

95. The method of claim 94, wherein the plurality of facial images comprises a plurality of groups of facial images, wherein said repeating comprises:
for each group, performing the learning phase and performing the testing phase for each facial image in the group.

96. The method of claim 95, wherein said performing the testing phase for each facial image in the group comprises:
for each facial image in the group, wherein the group comprises a first group,
for each facial image in a second group comprising the facial image, previously presented facial images from the first group, and zero or more previously presented facial images from an immediately previous group,
a) presenting a randomly selected facial image of a person from the second group;
b) displaying a second plurality of names, including the name for each facial image in the second group, and one or more distracter names;
c) requiring the participant to select the name of the person for the randomly selected facial image from the plurality of names; and
d) determining whether the participant correctly selected the name of the person for the randomly selected facial image.

97. The method of claim 96, wherein the second group comprises the facial image, previously presented facial images from the first group, and zero previously re-presented facial images from the immediately previous group.

98. The method of claim 96, wherein the second group comprises the facial image, previously presented facial images from the first group, and one or more previously presented facial image from the immediately previous group.

99. The method of claim 96, wherein the second group comprises the facial image, previously presented facial images from the first group, and two or more previously presented facial image from the immediately previous group.

100. The method of claim 96, wherein said repeating further comprises:
if the participant incorrectly selected the name of the person for the randomly selected facial image,
performing the learning phase again for the randomly selected facial image; and
performing a)-d) for each facial image in the second group.

101. The method of claim 95, wherein the second facial image is the same image as the first facial image.

102. The method of claim 95, wherein the second facial image and the first facial image differ in one or more of:
view; or
expression.

103. The method of claim 95, wherein the plurality of facial images comprises one or more stimulus categories, each stimulus category specifying a relationship between the first and second facial images in the stimulus category, and wherein said repeating comprises progressing through groups of facial images in each of the one or more stimulus categories.

104. The method of claim 103, where the one or more stimulus categories comprise one or more of:
a single view category, wherein the first and second facial images have the same view;
a multiple view category, wherein the first and second facial images have different views; and
a multiple expression category, wherein the first and second facial images have different expressions.

105. The method of claim 103, wherein each category has a respective plurality of subcategories further specifying the relationship between first and second facial images in the category.

106. The method of claim 105, where the subcategories comprise two or more of:
an age and gender independent subcategory, wherein the person of the first and second facial images is unconstrained with respect to age and gender;
a gender specific subcategory, wherein the person of the first and second facial images is constrained with respect to gender; and
an age specific subcategory, wherein the person of the first and second facial images is constrained with respect to age.

107. The method of claim 95, wherein the plurality of facial images of people comprises facial images of people that are familiar to the participant.

108. The method of claim 107, further comprising:
assessing the participant's face-name associations before and/or after said repeating, using the facial images of people that are familiar to the participant.

109. The method of claim 95, wherein the plurality of facial images of people comprises facial images of people that are unfamiliar to the participant.

110. The method of claim 109, further comprising:
assessing the participant's face-name associations before and/or after said repeating, using facial images of people that are unfamiliar to the participant, and that are not included in the plurality of facial images.

111. The method of claim 94, wherein each of the plurality of facial images is standardized with respect to one or more of:
aspect ratio;
frame;
size;
luminosity; and
contrast.

112. The method of claim 94, wherein said presenting the name comprises one or more of:
textually presenting the name; and/or
auditorily presenting the name.

113. The method of claim 112, wherein said auditorily presenting the name comprises:
a synchronous-onset presentation of the name with said presenting the facial image.

114. The method of claim 94, wherein said presenting the facial image comprises:
flashing the facial image at a specified rate.

115. The method of claim 94, wherein said presenting the name of the person comprises:
repeating the name at a specified rate.

116. A computer accessible memory medium comprising program instructions for enhancing cognition in a participant, utilizing a computing device to present visual stimuli and to receive responses from the participant, wherein the program instructions are executable by a processor to perform:
providing a set of visual stimuli for presentation to the participant, the set comprising a plurality of visual stimuli of varying difficulty;
presenting a visual stimulus from the set of visual stimuli to the participant;
requiring the participant to respond to the visual stimulus;
determining if the participant responded correctly to the visual stimulus;
selecting another visual stimulus for future presentation from the set based on said determining;
repeating said presenting, said requiring, said determining, and said selecting in an iterative manner to improve the cognition of the participant.
